(19) United States
(12) Patent Application Publication
(10) Pub. No.: US 2026/0243883 A1
(43) Pub. Date: Aug. 20, 2026

(54) ACTIVATION CONDITIONS FOR SENSING PROCEDURES

(71) Applicant: QUALCOMM Incorporated, San Diego, CA (US)

(72) Inventors: Marwen ZORGUI, San Diego, CA (US); Mohammed Ali Mohammed HIRZALLAH, San Diego, CA (US); Sony AKKARAKARAN, Poway, CA (US)

(21) Appl. No.: 19/054,551

(22) Filed: Feb. 14, 2025

(51) Int. Cl. G01S 13/75; G01S 13/00; H04W 4/38; H04W 24/10

(52) U.S. Cl. CPC G01S 13/751; G01S 13/003; H04W 4/38; H04W 24/10

(57) ABSTRACT

Some wireless communications systems may perform sensing of one or more target objects. For instance, one or more wireless devices (e.g., user equipments (UEs) or transmission-reception points (TRPs), among other examples) may transmit or receive a signal that is reflected by a target object. The reflected signal may provide an indication of one or more attributes of the target object. Some examples of the techniques described herein may improve sensing procedures. For instance, UEs may be selected for a bistatic sensing session based on one or more conditions that may increase a sensing gain contribution. Selection of UEs in bistatic sensing sessions may significantly improve sensing performance. Some examples of the techniques described herein may provide configurations for dynamic selection of sensing nodes in sensing sessions, which may provide improved energy usage or network efficiency.

### FIELD OF TECHNOLOGY

The following relates to wireless communications, including activation conditions for sensing procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a wireless device is described. The method may include obtaining, from a network entity, an indication of an activation condition to participate in a sensing procedure for a target object, where the activation condition is based on a location of a transmission node or a reception node for the sensing procedure, or is based on a signal characteristic for the sensing procedure, receiving, based on a satisfaction of the activation condition, a signal reflected from the target object, and transmitting, to the network entity, measurement information indicative of one or more measurements of the signal reflected from the target object.

A wireless device is described. The wireless device may include one or more transceivers, one or more memories storing processor executable code, and one or more processors coupled with the one or more transceivers and the one or more memories. The one or more processors may individually or collectively be configured to obtain, from a network entity, an indication of an activation condition to participate in a sensing procedure for a target object, where the activation condition is based on a location of a transmission node or a reception node for the sensing procedure, or is based on a signal characteristic for the sensing procedure, receive, based on a satisfaction of the activation condition, a signal reflected from the target object, and transmit, to the network entity, measurement information indicative of one or more measurements of the signal reflected from the target object.

Another wireless device is described. The wireless device may include means for obtaining, from a network entity, an indication of an activation condition to participate in a sensing procedure for a target object, where the activation condition is based on a location of a transmission node or a reception node for the sensing procedure, or is based on a signal characteristic for the sensing procedure, means for receiving, based on a satisfaction of the activation condition, a signal reflected from the target object, and means for transmitting, to the network entity, measurement information indicative of one or more measurements of the signal reflected from the target object.

A non-transitory computer-readable medium storing code is described. The code may include instructions executable by one or more processors to obtain, from a network entity, an indication of an activation condition to participate in a sensing procedure for a target object, where the activation condition is based on a location of a transmission node or a reception node for the sensing procedure, or is based on a signal characteristic for the sensing procedure, receive, based on a satisfaction of the activation condition, a signal reflected from the target object, and transmit, to the network entity, measurement information indicative of one or more measurements of the signal reflected from the target object.

Some examples of the method, wireless devices, and non-transitory computer-readable medium described herein may further include operations, features, means, or instructions for obtaining, from the network entity, configuration information that may be indicative of a resource for communication of the signal, that may be indicative of a type of the one or more measurements, or a combination thereof.

In some examples of the method, wireless devices, and non-transitory computer-readable medium described herein, the configuration information may be obtained previous to the satisfaction of the activation condition, or may be obtained in response to a transmission indicative of the satisfaction of the activation condition to the network entity.

In some examples of the method, wireless devices, and non-transitory computer-readable medium described herein, the activation condition may be based on whether a relative distance between the transmission node and the reception node satisfies a threshold.

In some examples of the method, wireless devices, and non-transitory computer-readable medium described herein, the sensing procedure includes bistatic sensing, the bistatic sensing limited to a tracking operation for the target object.

In some examples of the method, wireless devices, and non-transitory computer-readable medium described herein, the activation condition may be based on whether a relative distance between the transmission node and the reception node satisfies a threshold and the threshold may be based on a first distance between the transmission node and the target object, or a second distance between the reception node and the target object.

Some examples of the method, wireless devices, and non-transitory computer-readable medium described herein may further include operations, features, means, or instructions for obtaining, from the network entity, an indication of the location of the transmission node, an indication of a location of the target object, or a combination thereof.

In some examples of the method, wireless devices, and non-transitory computer-readable medium described herein, the activation condition may be based on whether a relative distance satisfies a threshold and the relative distance may be between the transmission node and the target object, or may be between the reception node and the target object.

In some examples of the method, wireless devices, and non-transitory computer-readable medium described herein, the activation condition may be based on whether an angle satisfies a threshold and the angle may be between a first ray that may be between the transmission node and the target object, and a second ray that may be between the reception node and the target object.

In some examples of the method, wireless devices, and non-transitory computer-readable medium described herein, the activation condition may be based on whether an elevation satisfies a threshold and the elevation may be a relative elevation between the transmission node and the reception node, or may be an absolute elevation of the transmission node or of the reception node.

In some examples of the method, wireless devices, and non-transitory computer-readable medium described herein, the activation condition may be based on whether a threshold may be satisfied by a power or a strength of signaling via a background channel between the transmission node and the reception node.

In some examples of the method, wireless devices, and non-transitory computer-readable medium described herein, the activation condition may be based on whether a projected power of the signal reflected from the target object satisfies a condition, the projected power being based on a radar cross section of the target object.

In some examples of the method, wireless devices, and non-transitory computer-readable medium described herein, the activation condition includes a set of conditions and the activation condition may be based on whether at least a subset of the set of conditions may be satisfied.

Some examples of the method, wireless devices, and non-transitory computer-readable medium described herein may further include operations, features, means, or instructions for transmitting, to the network entity, an indication of a reason for which the wireless device does not participate in a sensing session.

Some examples of the method, wireless devices, and non-transitory computer-readable medium described herein may further include operations, features, means, or instructions for transmitting, to the network entity, capability information indicating a capability of the wireless device to utilize the activation condition, where the indication of the activation condition may be obtained based on the capability information.

In some examples of the method, wireless devices, and non-transitory computer-readable medium described herein, the indication of the activation condition may be signaled via a sensing request message, via assistance data, via unicast signaling, or via broadcast signaling.

Some examples of the method, wireless devices, and non-transitory computer-readable medium described herein may further include operations, features, means, or instructions for transmitting, to the network entity, an indicator of the satisfaction of the activation condition and obtaining, from the network entity, activation information indicative of an activation of the sensing procedure based on the satisfaction of the activation condition.

A method by a network entity is described. The method may include transmitting, to a wireless device, an indication of an activation condition to participate in a sensing procedure for a target object, where the activation condition is based on a location of a transmission node or a reception node for the sensing procedure, or is based on a signal characteristic for the sensing procedure and obtaining, from the wireless device, measurement information indicative of one or more measurements of a signal reflected from the target object.

A network entity is described. The network entity may include one or more transceivers, one or more memories storing processor executable code, and one or more processors coupled with the one or more transceivers and the one or more memories. The one or more processors may individually or collectively be configured to transmit, to a wireless device, an indication of an activation condition to participate in a sensing procedure for a target object, where the activation condition is based on a location of a transmission node or a reception node for the sensing procedure, or is based on a signal characteristic for the sensing procedure and obtain, from the wireless device, measurement information indicative of one or more measurements of a signal reflected from the target object.

Another network entity is described. The network entity may include means for transmitting, to a wireless device, an indication of an activation condition to participate in a sensing procedure for a target object, where the activation condition is based on a location of a transmission node or a reception node for the sensing procedure, or is based on a signal characteristic for the sensing procedure and means for obtaining, from the wireless device, measurement information indicative of one or more measurements of a signal reflected from the target object.

A non-transitory computer-readable medium storing code is described. The code may include instructions executable by one or more processors to transmit, to a wireless device, an indication of an activation condition to participate in a sensing procedure for a target object, where the activation condition is based on a location of a transmission node or a reception node for the sensing procedure, or is based on a signal characteristic for the sensing procedure and obtain, from the wireless device, measurement information indicative of one or more measurements of a signal reflected from the target object.

Some examples of the method, network entities, and non-transitory computer-readable medium described herein may further include operations, features, means, or instructions for transmitting, to the wireless device, configuration information that may be indicative of a resource for communication of the signal, that may be indicative of a type of the one or more measurements, or a combination thereof.

In some examples of the method, network entities, and non-transitory computer-readable medium described herein, the configuration information may be transmitted previous to a satisfaction of the activation condition, or may be transmitted in response to a transmission indicative of a satisfaction of the activation condition from the wireless device.

In some examples of the method, network entities, and non-transitory computer-readable medium described herein, the activation condition may be based on whether a relative distance between the transmission node and the reception node satisfies a threshold.

In some examples of the method, network entities, and non-transitory computer-readable medium described herein, the sensing procedure includes bistatic sensing, the bistatic sensing limited to a tracking operation for the target object.

In some examples of the method, network entities, and non-transitory computer-readable medium described herein, the activation condition may be based on whether a relative distance between the transmission node and the reception node satisfies a threshold and the threshold may be based on a first distance between the transmission node and the target object, or a second distance between the reception node and the target object.

Some examples of the method, network entities, and non-transitory computer-readable medium described herein may further include operations, features, means, or instructions for transmitting, to the wireless device, an indication of the location of the transmission node, an indication of a location of the target object, or a combination thereof.

In some examples of the method, network entities, and non-transitory computer-readable medium described herein, the activation condition may be based on whether a relative distance satisfies a threshold and the relative distance may be between the transmission node and the target object, or may be between the reception node and the target object.

In some examples of the method, network entities, and non-transitory computer-readable medium described herein, the activation condition may be based on whether an angle satisfies a threshold and the angle may be between a first ray that may be between the transmission node and the target object, and a second ray that may be between the reception node and the target object.

In some examples of the method, network entities, and non-transitory computer-readable medium described herein, the activation condition may be based on whether an elevation satisfies a threshold and the elevation may be a relative elevation between the transmission node and the reception node, or may be an absolute elevation of the transmission node or of the reception node.

In some examples of the method, network entities, and non-transitory computer-readable medium described herein, the activation condition may be based on whether a threshold may be satisfied by a power or a strength of signaling via a background channel between the transmission node and the reception node.

In some examples of the method, network entities, and non-transitory computer-readable medium described herein, the activation condition may be based on whether a projected power of the signal reflected from the target object satisfies a condition, the projected power being based on a radar cross section of the target object.

In some examples of the method, network entities, and non-transitory computer-readable medium described herein, the activation condition includes a set of conditions and the activation condition may be based on whether at least a subset of the set of conditions may be satisfied.

Some examples of the method, network entities, and non-transitory computer-readable medium described herein may further include operations, features, means, or instructions for obtaining, from the wireless device, an indication of a reason for which the wireless device does not participate in a sensing session.

Some examples of the method, network entities, and non-transitory computer-readable medium described herein may further include operations, features, means, or instructions for obtaining, from the wireless device, capability information indicating a capability of the wireless device to utilize the activation condition, where the indication of the activation condition may be transmitted based on the capability information.

In some examples of the method, network entities, and non-transitory computer-readable medium described herein, the indication of the activation condition may be signaled via a sensing request message, via assistance data, via unicast signaling, or via broadcast signaling.

Some examples of the method, network entities, and non-transitory computer-readable medium described herein may further include operations, features, means, or instructions for obtaining, from the wireless device, an indicator of a satisfaction of the activation condition and transmitting, to the wireless device, activation information indicative of an activation of the sensing procedure based on the satisfaction of the activation condition.

A method by a network entity is described. The method may include determining whether an activation condition is satisfied for a wireless device to participate in a sensing procedure for a target object, where the activation condition is based on a location of a transmission node or a reception node for the sensing procedure, or is based on a signal characteristic for the sensing procedure and transmitting, to the wireless device, an indication that the wireless device is selected to participate in the sensing procedure based on a satisfaction of the activation condition for the wireless device.

A network entity is described. The network entity may include one or more transceivers, one or more memories storing processor executable code, and one or more processors coupled with the one or more transceivers and the one or more memories. The one or more processors may individually or collectively be configured to determine whether an activation condition is satisfied for a wireless device to participate in a sensing procedure for a target object, where the activation condition is based on a location of a transmission node or a reception node for the sensing procedure, or is based on a signal characteristic for the sensing procedure and transmit, to the wireless device, an indication that the wireless device is selected to participate in the sensing procedure based on a satisfaction of the activation condition for the wireless device.

Another network entity is described. The network entity may include means for determining whether an activation condition is satisfied for a wireless device to participate in a sensing procedure for a target object, where the activation condition is based on a location of a transmission node or a reception node for the sensing procedure, or is based on a signal characteristic for the sensing procedure and means for transmitting, to the wireless device, an indication that the wireless device is selected to participate in the sensing procedure based on a satisfaction of the activation condition for the wireless device.

A non-transitory computer-readable medium storing code is described. The code may include instructions executable by one or more processors to determine whether an activation condition is satisfied for a wireless device to participate in a sensing procedure for a target object, where the activation condition is based on a location of a transmission node or a reception node for the sensing procedure, or is based on a signal characteristic for the sensing procedure and transmit, to the wireless device, an indication that the wireless device is selected to participate in the sensing procedure based on a satisfaction of the activation condition for the wireless device.

Some examples of the method, network entities, and non-transitory computer-readable medium described herein may further include operations, features, means, or instructions for transmitting, to the wireless device, configuration information that may be indicative of a resource for communication of a signal reflected from the target object to the reception node, that may be indicative of a type of one or more measurements for the sensing procedure, or a combination thereof.

In some examples of the method, network entities, and non-transitory computer-readable medium described herein, the activation condition may be based on whether a relative distance between the transmission node and the reception node satisfies a threshold.

In some examples of the method, network entities, and non-transitory computer-readable medium described herein, the activation condition may be based on whether a relative distance between the transmission node and the reception node satisfies a threshold and the threshold may be based on a first distance between the transmission node and the target object, or a second distance between the reception node and the target object.

In some examples of the method, network entities, and non-transitory computer-readable medium described herein, the activation condition may be based on whether a relative distance satisfies a threshold and the relative distance may be between the transmission node and the target object, or may be between the reception node and the target object.

In some examples of the method, network entities, and non-transitory computer-readable medium described herein, the activation condition may be based on whether an angle satisfies a threshold and the angle may be between a first ray that may be between the transmission node and the target object, and a second ray that may be between the reception node and the target object.

In some examples of the method, network entities, and non-transitory computer-readable medium described herein, the activation condition may be based on whether an elevation satisfies a threshold and the elevation may be a relative elevation between the transmission node and the reception node, or may be an absolute elevation of the transmission node or of the reception node.

In some examples of the method, network entities, and non-transitory computer-readable medium described herein, the activation condition may be based on whether a threshold may be satisfied by a power or a strength of signaling via a background channel between the transmission node and the reception node.

In some examples of the method, network entities, and non-transitory computer-readable medium described herein, the activation condition may be based on whether a projected power of a signal reflected from the target object satisfies a condition, the projected power being based on a radar cross section of the target object.

In some examples of the method, network entities, and non-transitory computer-readable medium described herein, the activation condition includes a set of conditions and the activation condition may be based on whether at least a subset of the set of conditions may be satisfied.

Some examples of the method, network entities, and non-transitory computer-readable medium described herein may further include operations, features, means, or instructions for obtaining, from the wireless device, an indication of a reason for which the wireless device does not participate in a sensing session.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports activation conditions for sensing procedures in accordance with one or more aspects of the present disclosure.

FIG. 2 shows an example of a network structure that supports activation conditions for sensing procedures in accordance with one or more aspects of the present disclosure.

FIG. 3 shows an example of a network architecture that supports activation conditions for sensing procedures in accordance with one or more aspects of the present disclosure.

FIG. 4 shows an example of a wireless communications system that supports activation conditions for sensing procedures in accordance with one or more aspects of the present disclosure.

FIG. 5 shows examples of wireless communications systems that support activation conditions for sensing procedures in accordance with one or more aspects of the present disclosure.

FIG. 6 shows examples of wireless communications systems that support activation conditions for sensing procedures in accordance with one or more aspects of the present disclosure.

FIG. 7 shows an example of a process flow that supports activation conditions for sensing procedures in accordance with one or more aspects of the present disclosure.

FIG. 8 shows an example of a process flow that supports activation conditions for sensing procedures in accordance with one or more aspects of the present disclosure.

FIGS. 9 and 10 show block diagrams of devices that support activation conditions for sensing procedures in accordance with one or more aspects of the present disclosure.

FIG. 11 shows a block diagram of a communications manager that supports activation conditions for sensing procedures in accordance with one or more aspects of the present disclosure.

FIG. 12 shows a diagram of a system including a device that supports activation conditions for sensing procedures in accordance with one or more aspects of the present disclosure.

FIGS. 13 and 14 show block diagrams of devices that support activation conditions for sensing procedures in accordance with one or more aspects of the present disclosure.

FIG. 15 shows a block diagram of a communications manager that supports activation conditions for sensing procedures in accordance with one or more aspects of the present disclosure.

FIG. 16 shows a diagram of a system including a device that supports activation conditions for sensing procedures in accordance with one or more aspects of the present disclosure.

FIGS. 17 through 22 show flowcharts illustrating methods that support activation conditions for sensing procedures in accordance with one or more aspects of the present disclosure.

FIG. 23 shows examples of sensing modes that support activation conditions for sensing procedures in accordance with one or more aspects of the present disclosure.

FIG. 24 shows an example of a block diagram of a user equipment (UE) that supports activation conditions for sensing procedures in accordance with one or more aspects of the present disclosure.

FIG. 25 shows an example of a block diagram of a base station that supports activation conditions for sensing procedures in accordance with one or more aspects of the present disclosure.

FIG. 26 shows an example of a block diagram of a location or sensing server that supports activation conditions for sensing procedures in accordance with one or more aspects of the present disclosure.

### DETAILED DESCRIPTION

Some wireless communications systems may perform sensing (e.g., radio-frequency (RF)-based sensing) of one or more target objects. For instance, one or more wireless devices (e.g., user equipments (UEs) or transmission-reception points (TRPs), among other examples) may transmit or receive a signal that is reflected by a target object, where the signal may provide an indication of one or more attributes of the target object, such as position, speed, velocity, object type, or other information. A variety of sensing modes may be implemented, where details and deployment scenarios may vary for each sensing mode to enable different use cases.

In monostatic sensing, a wireless device may transmit and receive the signal that is reflected by the target object. In some approaches to monostotic operations (e.g., TRP monostatic or UE monostatic operations), self-interference (e.g., transmission (Tx) to reception (Rx) interference) may be managed by isolation of the transmitting antennas/panels and the receiving antennas/panels, in addition to, or alternatively from, implementation-based self-interference cancellation techniques.

In bistatic sensing, a first wireless device may transmit a signal, which may be reflected by the target object and received by a second wireless device. In some examples, UE-UE bistatic sensing (among other sensing modes, for instance) may be utilized for RF sensing. Engaging UEs in a bistatic RF-based sensing session may improve sensing coverage, enhance detection, or enhance tracking of target objects. As used herein, the term “background channel” may refer to one or more channels between a transmission node (e.g., sensing transmitter) and a reception node (e.g., sensing receiver), which may not be impacted by one or more target objects (e.g., target(s) of interest) or that may be independent from (or separate from) one or more channels that are impacted by (e.g., reflected via) one or more target objects. For instance, a background channel may be a collection of one or more line-of-sight (LOS) or non-line-of-sight (NLOS) rays that emanate from the transmission node (e.g., sensing transmitter) and arrive at the reception node (e.g., sensing receiver) without reflecting from (e.g., bouncing off) any of the target object(s) (e.g., target(s) of interest).

For bistatic operations, the Tx-to-Rx background channel may dominate the signals of interest (e.g., signals reflecting from the sensing target objects), which may reduce the utility of the bistatic link for sensing. For UE-UE bistatic operations, for example, depending on the inter-UE distance and the target location, the UE-UE background channel may be relatively (e.g., much) stronger than the signal(s) for sensing (e.g., a signal(s) reflecting via the target object), which may reduce the utility of the bistatic link for sensing procedures. In some cases, sensing session durations may be relatively lengthy for velocity estimation purposes. A UE participating in a sensing session may help to derive useful measurements for sensing purposes if a background channel contribution is relatively low. Otherwise, a UE may have monitored a long sensing window to produce measurements that are dominated by background channel signals with less useful extracted information related to target objects.

Some examples of the techniques described herein may improve sensing procedures. For instance, UEs may be selected for a bistatic sensing session based on one or more conditions that may increase a sensing gain contribution, where selection of UEs in bistatic sensing sessions may significantly improve sensing performance. Some examples of the techniques described herein may provide configurations for dynamic selection of sensing nodes in sensing sessions. Some examples of the techniques described herein may provide improved energy usage or network efficiency. For instance, UEs that are not selected for sensing may save energy or avoid transmitting sensing reports that are less useful.

Aspects of the disclosure are described in the context of wireless communications systems. Aspects of the disclosure are also described in the context of a wireless network structure. Aspects of the disclosure are further described in the context of a network architecture. Aspects of the disclosure are additionally described in the context of process flows. Aspects of the disclosure are further illustrated by and described with reference to apparatus diagrams, system diagrams, flowcharts, a node diagram, and block diagrams that relate to activation conditions for sensing procedures.

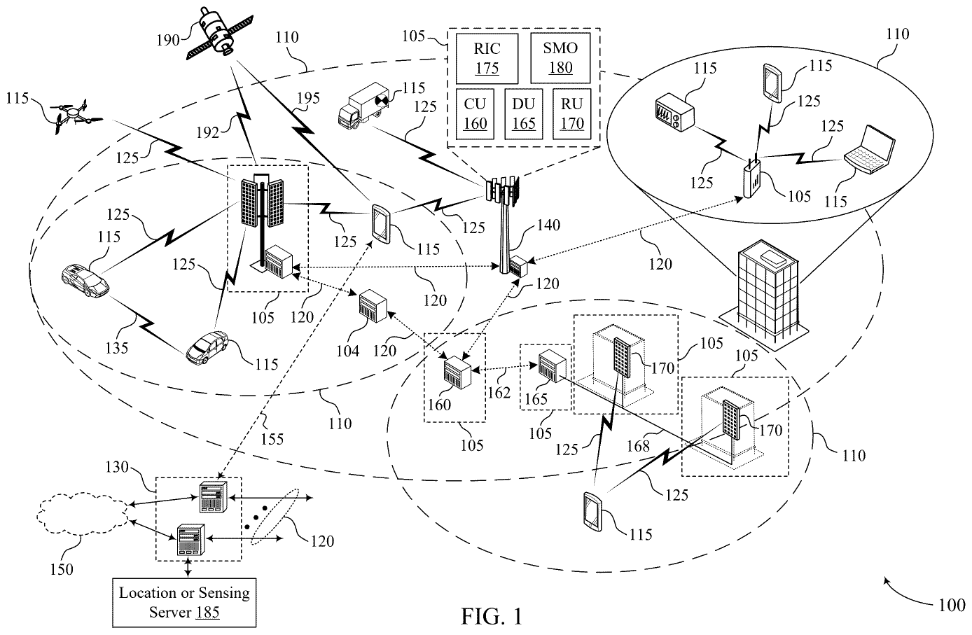

FIG. 1 shows an example of a wireless communications system 100 that supports activation conditions for sensing procedures in accordance with one or more aspects of the present disclosure. The wireless communications system 100 may include one or more devices, such as one or more network devices (e.g., network nodes 105), one or more UEs 115, and a core network 130. In some examples, the wireless communications system 100 may be an LTE network, an LTE-Advanced (LTE-A) network, an LTE-A Pro network, a New Radio (NR) network, or a network operating in accordance with other systems and radio technologies, including future systems and radio technologies not explicitly mentioned herein.

The network nodes 105 may be dispersed throughout a geographic area to form the wireless communications system 100 and may include devices in different forms or having different capabilities. In various examples, a network node 105 may be referred to as a network element, a network entity, a mobility element, a radio access network (RAN) node, or network equipment, among other nomenclature. In some examples, network nodes 105 and UEs 115 may wirelessly communicate via communication link(s) 125 (e.g., a radio frequency (RF) access link). For example, a network node 105 may support a coverage area 110 (e.g., a geographic coverage area) over which the UEs 115 and the network node 105 may establish the communication link(s) 125. The coverage area 110 may be an example of a geographic area over which a network node 105 and a UE 115 may support the communication of signals according to one or more RATs.

The UEs 115 may be dispersed throughout a coverage area 110 of the wireless communications system 100, and each UE 115 may be stationary, or mobile, or both at different times. The UEs 115 may be devices in different forms or have different capabilities. Some example UEs 115 are illustrated in FIG. 1. The UEs 115 described herein may be capable of supporting communications with various types of devices in the wireless communications system 100 (e.g., other wireless communication devices, including UEs 115 or network nodes 105), as shown in FIG. 1.

As described herein, a node of the wireless communications system 100, which may be referred to as a network entity or a wireless node, may be a network node 105 (e.g., any network node described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network node 105. As another example, a first node may be configured to communicate with a second node or a third node. In one aspect of this example, the first node may be a UE 115, the second node may be a network node 105, and the third node may be another UE 115. In another aspect of this example, the first node may be a UE 115, the second node may be a network node 105, and the third node may be another network node 105. In yet other aspects of this example, the first, second, and third nodes may be different relative to these examples. Similarly, reference to a UE 115, network node 105, apparatus, device, computing system, or the like may include disclosure of the UE 115, network node 105, apparatus, device, computing system, or the like being a node. For example, disclosure that a UE 115 is configured to receive information from a network node 105 also discloses that a first node is configured to receive information from a second node.

In some examples, network nodes 105 may communicate with a core network 130, or with one another, or both. For example, network nodes 105 may communicate with the core network 130 via wired or wireless backhaul communication link(s) 120 (e.g., in accordance with an S1, N2, N3, or other interface protocol). In some examples, network nodes 105 may communicate with one another via backhaul communication link(s) 120 (e.g., in accordance with an X2, Xn, or other interface protocol) either directly (e.g., directly between network nodes 105) or indirectly (e.g., via the core network 130). In some examples, network nodes 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network nodes 105 or network equipment described herein may include or may be referred to as a base station 140 (e.g., a base transceiver station, a radio base station, an NR base station, an access point (AP), a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network node 105 (e.g., a base station 140) may be implemented in an aggregated (e.g., monolithic, standalone) base station architecture, which may be configured to utilize a protocol stack that is physically or logically integrated within one network node (e.g., a network node 105 or a single RAN node, such as a base station 140).

In some examples, a network node 105 may be implemented in a disaggregated architecture (e.g., a disaggregated base station architecture, a disaggregated RAN architecture), which may be configured to utilize a protocol stack that is physically or logically distributed among multiple network entities (e.g., network nodes 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network node 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission-reception point (TRP). One or more components of the network nodes 105 in a disaggregated RAN architecture may be co-located, or one or more components of the network nodes 105 may be located in distributed locations (e.g., separate physical locations). In some examples, one or more of the network nodes 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1 interface, F1-c interface, or F1-u, among other examples), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network nodes 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network nodes 105 (e.g., network nodes 105 or IAB node(s) 104) may be partially controlled by each other. The IAB node(s) 104 may be referred to as a donor entity or an IAB donor. A DU 165 or an RU 170 may be partially controlled by a CU 160 associated with a network node 105 or base station 140 (such as a donor network node or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support testing as described herein. For example, some operations described as being performed by a UE 115 or a network node 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network nodes 105 and the network equipment including macro eNBs or gNBs, small cell eNBs or gNBs, or relay base stations, among other examples, as shown in FIG. 1.

The UEs 115 and the network nodes 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network node 105 and other devices may refer to communication between the devices and any portion (e.g., entity, sub-entity) of a network node 105. For example, the terms “transmitting,” “receiving,” or “communicating,” when referring to a network node 105, may refer to any portion of a network node 105 (e.g., a base station 140, a CU 160, a DU 165, a RU 170) of a RAN communicating with another device (e.g., directly or via one or more other network entities, such as one or more of the network nodes 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network node 105 to a UE 115, uplink transmissions (e.g., return link transmissions) from a UE 115 to a network node 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network nodes 105, the UEs 115, or both) may have hardware configurations that support communications using a particular carrier bandwidth or may be configurable to support communications using one of a set of carrier bandwidths. In some examples, the wireless communications system 100 may include network nodes 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network nodes 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network node 105 may provide communication coverage via one or more cells, for example a macro cell, a small cell, a hot spot, or other types of cells, or any combination thereof. The term “cell” may refer to a logical communication entity used for communication with a network node 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network node 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network node 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network node 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network node 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network node (e.g., a network node 105). In some other examples, overlapping coverage areas, such as a coverage area 110, associated with different technologies may be supported by different network entities (e.g., the network nodes 105). The wireless communications system 100 may include, for example, a heterogeneous network in which different types of the network nodes 105 support communications for coverage areas 110 (e.g., different coverage areas) using the same or different RATs.

The wireless communications system 100 may support synchronous or asynchronous operation. For synchronous operation, network nodes 105 (e.g., base stations 140) may have similar frame timings, and transmissions from different network entities (e.g., different ones of the network nodes 105) may be approximately aligned in time. For asynchronous operation, network nodes 105 may have different frame timings, and transmissions from different network entities (e.g., different ones of network nodes 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network node 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network node 105 (e.g., a base station 140, an RU 170), which may support aspects of such D2D communications being configured by (e.g., scheduled by) the network node 105. In some examples, one or more UEs 115 of such a group may be outside the coverage area 110 of a network node 105 or may be otherwise unable to or not configured to receive transmissions from a network node 105. In some examples, groups of the UEs 115 communicating via D2D communications may support a one-to-many (1:M) system in which each UE 115 transmits to one or more of the UEs 115 in the group. In some examples, a network node 105 may facilitate the scheduling of resources for D2D communications. In some other examples, D2D communications may be carried out between the UEs 115 without an involvement of a network node 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network entities (e.g., network nodes 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network nodes 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may include a location or sensing server 185 (e.g., LMF, sensing management function (SnMF), another network entity, or a combination thereof). The location or sensing server 185 may provide positioning, location, sensing, or tracking functions. For instance, the location or sensing server 185 may participate in one or more positioning or sensing procedures to determine a location of (e.g., coordinates of, relative distance(s) to, or an address of) one or more of the UEs 115 or to sense one or more attributes of an object. Examples of positioning procedures may include one or more operations of assisted global navigation satellite system (A-GNSS), observed time difference of arrival (OTDOA), enhanced cell identifier (E-CID), sensor-based positioning, wireless local area network (WLAN)-based positioning, Bluetooth-based positioning, terrestrial beacon systems (TBS) positioning, downlink time difference of arrival (DL-TDOA), downlink angle of departure (DL-AOD), multi-round-trip time (Multi-RTT), New Radio enhanced cell identifier (NR E-CID), uplink time difference of arrival (UL-TDOA), and uplink angle of arrival (UL-AOA), among other examples. Examples of sensing procedures may include a bistatic sensing procedure or a monostatic sensing procedure. Some examples of the positioning or sensing procedures may be managed by, assisted by, or performed with the location or sensing server 185. For instance, measurements associated with reference signaling may be provided to the location or sensing server 185, which may estimate a location of, or one or more attributes of, an object (e.g., UE 115) based on the measurements. In some aspects, the location or sensing server 185 may track or store location information or sensing information corresponding to one or more UEs 115 or one or more other objects. Some examples of the positioning or sensing procedures may be performed without the location or sensing server 185.

The location or sensing server 185 may be included in the core network 130 or may be separate from the core network 130. In some examples, a location or sensing server 185 may be a standalone device or may be included in (e.g., integrated with) a network node 105, a base station 140, a UE 115, a satellite 190, a server, or another device. For instance, the location or sensing server 185 may be (or may be included in) a secure user plane location (SUPL) location platform (SLP) device, a third-party server, or another device. The location or sensing server 185 may generally refer to a positioning device, a location device, a sensing device, a computing device, or a server, among other examples.

A UE 115 may communicate with the location or sensing server 185 directly or indirectly. For example, a UE 115 may communicate with the location or sensing server 185 via a network node 105 that is serving the UE 115 and via the core network 130. Additionally, or alternatively, a UE 115 may communicate with the location or sensing server 185 through another path (e.g., via an application server (not shown)) or via another network (e.g., via a WLAN AP), among other examples. Communication between a UE 115 and the location or sensing server 185 may be represented via an indirect connection (e.g., through a communication link 125, a network node 105, a communication link 155, a backhaul communication link 120, or the core network 130) or as a direct connection, with one or more intervening nodes (if any) omitted for concision or convenience.

A satellite 190 may be an aerial or space vehicle with signaling capability. In some examples, the wireless communications system 100 may include or communicate with one or more satellites 190. The satellite(s) 190 may be included in one or more satellite positioning systems (e.g., GNSS(s)). A satellite positioning system may include any combination of one or more global or regional navigation satellites associated with one or more satellite positioning systems (e.g., global positioning system (GPS), global navigation satellite system (GLONASS), BeiDou navigation satellite system (BDS), or Galileo, among other examples). A satellite positioning system may include satellites 190 or other transmitters positioned to enable receivers (e.g., UEs 115) to determine a location on or above the Earth based on signals (e.g., the signals 195) received from the satellites 190. For instance, each satellite 190 may transmit a signal 195 marked with a repeating pseudo-random noise (PN) code of a set quantity of chips. In some cases, one or more transmitters located on ground-based control stations, network nodes 105, or UEs 115 may transmit signals for enabling a UE 115 to determine a location.

A UE 115 may include one or more receivers designed to receive the signal(s) 195 from the satellite(s) 190 for determining location information (e.g., a geographic location of the UE 115). For instance, the UE 115 may receive one or more signals 195 from the satellite(s) 190, which may be utilized to determine a location of the UE 115.

In a satellite positioning system, the use of signals 195 may be augmented with one or more satellite-based augmentation systems (SBAS) that may be associated with or enabled for use with one or more global or regional navigation satellite systems. An SBAS may provide integrity information, differential corrections, or other information for use in conjunction with a satellite positioning system. An SBAS may include one or more augmentation systems, such as the Wide Area Augmentation System (WAAS), the European Geostationary Navigation Overlay Service (EGNOS), the Multi-functional Satellite Augmentation System (MSAS), or the GPS Aided Geo Augmented Navigation (GAGAN) system, among other examples.

In some aspects, the satellite(s) 190 may be included in one or more non-terrestrial networks (NTNs). In an NTN, a satellite 190 may communicate with one or more devices (e.g., network entities, ground stations, NTN gateways, or gateways) located on or above the Earth. For example, the satellite 190 may send or receive one or more communications 192 with a network node 105. In some aspects, the communication(s) 192 may include one or more signals relayed to or from a UE 115. Additionally, or alternatively, the satellite 190 may communicate with another terrestrial device that is connected to one or more elements of the wireless communications system 100. For instance, the satellite 190 may communicate with a ground station or NTN gateway, which may provide access to the wireless communications system 100 or one or more other entities (e.g., Internet web servers or one or more other user devices) external to the wireless communications system 100. In some examples, a UE 115 may receive communication signals 195 from the satellite 190 instead of, or in addition to, communication signals from a terrestrial network entity.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network nodes 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize licensed or unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network nodes 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network node 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network node 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network node 105 may be located at diverse geographic locations. A network node 105 may include an antenna array with a set of rows and columns of antenna ports that the network node 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network nodes 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network node 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network node 105 or a UE 115 may use beam sweeping techniques as part of beamforming operations. For example, a network node 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network node 105 multiple times along different directions. For example, the network node 105 may transmit a signal according to different beamforming weight sets associated with different directions of transmission. Transmissions along different beam directions may be used to identify (e.g., by a transmitting device, such as a network node 105, or by a receiving device, such as a UE 115) a beam direction for later transmission or reception by the network node 105.

Some signals, such as data signals associated with a particular receiving device, may be transmitted by a transmitting device (e.g., a network node 105 or a UE 115) along a single beam direction (e.g., a direction associated with the receiving device, such as another network node 105 or UE 115). In some examples, the beam direction associated with transmissions along a single beam direction may be determined based on a signal that was transmitted along one or more beam directions. For example, a UE 115 may receive one or more of the signals transmitted by the network node 105 along different directions and may report to the network node 105 an indication of the signal that the UE 115 received with a highest signal quality or an otherwise acceptable signal quality.

In some examples, transmissions by a device (e.g., by a network node 105 or a UE 115) may be performed using multiple beam directions, and the device may use a combination of digital precoding or beamforming to generate a combined beam for transmission (e.g., from a network node 105 to a UE 115). The UE 115 may report feedback that indicates precoding weights for one or more beam directions, and the feedback may correspond to a configured set of beams across a system bandwidth or one or more sub-bands. The network node 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network node 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network node 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network node 105 or a core network 130 supporting radio bearers for user plane data. A PHY layer may map transport channels to physical channels.

The UEs 115 and the network nodes 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems may perform sensing (e.g., RF-based sensing) of one or more target objects. For instance, one or more wireless devices (e.g., UEs 115 or TRPs, among other examples) may transmit or receive a signal that is reflected by a target object, where the signal may provide an indication of one or more attributes of the target object, such as position, speed, velocity, object type, or other information. A variety of sensing modes may be implemented, where details and deployment scenarios may vary for each sensing mode to enable different use cases.

In monostatic sensing, a wireless device (e.g., UE 115 or network node 105) may transmit and receive the signal that is reflected by the target object. In some approaches to monostotic operations (e.g., TRP monostatic or UE monostatic operations), self-interference (e.g., Tx-to-Rx interference) may be managed by isolation of the transmitting antennas/panels and the receiving antennas/panels, in addition to, or alternatively from, implementation-based self-interference cancellation techniques.

In bistatic sensing, a first wireless device may transmit a signal, which may be reflected by the target object and received by a second wireless device. In some examples, UE-UE bistatic sensing (among other sensing modes, for instance) may be utilized for RF sensing. Engaging UEs in a bistatic RF-based sensing session may improve sensing coverage, enhance detection, or enhance tracking of target objects. As used herein, the term “background channel” may refer to one or more channels between a transmission node (e.g., sensing transmitter) and a reception node (e.g., sensing receiver), which may not be impacted by one or more target objects (e.g., target(s) of interest) or that may be independent from (or separate from) one or more channels that are impacted by (e.g., reflected via) one or more target objects. For instance, a background channel may be a collection of one or more LOS or NLOS rays that emanate from the transmission node (e.g., sensing transmitter) and arrive at the reception node (e.g., sensing receiver) without reflecting from (e.g., bouncing off) any of the target object(s) (e.g., target(s) of interest). For instance, a background channel signal may not reflect via a target object.

For bistatic operations, the Tx-to-Rx background channel may dominate the signals of interest (e.g., signals reflecting from the sensing target objects), which may reduce the utility of the bistatic link for sensing. For UE-UE bistatic operations, for example, depending on the inter-UE distance and the target location, the UE-UE background channel may be relatively (e.g., much) stronger than the signal(s) for sensing (e.g., a signal(s) reflecting via the target object), which may reduce the utility of the bistatic link for sensing procedures. In some cases, sensing session durations may be relatively lengthy for velocity estimation purposes.

For example, velocity estimation accuracy may be one use case for RF sensing. One challenge with accurate velocity estimation is the demand for a relatively long integration time window. For OFDM-based RF sensing, for example, the velocity resolution may be roughly given by

$$Δ v = \frac{λ}{2 {T}_{frm}} ,$$

where T_{frm} is an observation (e.g., integration) time window, and λ is the operating frequency. To achieve 2 meters/second (m/s) (=7.2 km/hour) velocity resolution in frequency range 2 (FR2) with 28 gigahertz (GHz),

$${T}_{frm} = \frac{λ}{2 Δ v} = \frac{0.0107}{2 * 2} = 2.675$$

milliseconds (ms). Assuming a 120 kHz subcarrier spacing (SCS) and a slot duration=0.125 ms, T_{frm}/slot duration=21.40 slots. In another example, assuming a 30 kilohertz (kHz) SCS and a slot duration=0.5 ms, to achieve a 0.5 m/s velocity resolution in frequency range 1 (FR1) with 6 GHz,

$${T}_{frm} = \frac{λ}{2 Δ v} = \frac{0.05}{2 * 0.5} = 50 ms ,$$

and T_{frm}/slot duration=100 slots.

A UE participating in a sensing session may help to derive useful measurements for sensing purposes if a background channel contribution is relatively low. Otherwise, a UE may have monitored a long sensing window to produce measurements that are dominated by background channel signals with less useful extracted information related to target objects.

Some examples of the techniques described herein may improve sensing procedures. For instance, UEs 115 may be selected for a bistatic sensing session based on one or more conditions that may increase a sensing gain contribution, where selection of UEs 115 in bistatic sensing sessions may significantly improve sensing performance. Some examples of the techniques described herein may provide configurations for dynamic selection of sensing nodes in sensing sessions. Some examples of the techniques described herein may provide improved energy usage or network efficiency. For instance, UEs that are not selected for sensing may save energy or avoid transmitting sensing reports that are less useful.

Some examples of the techniques described herein may be utilized in UE-UE bistatic operations, TRP-UE bistatic operations, TRP-TRP bistatic operations, or in other contexts. For TRP-UE bistatic operations, when the distance between the TRP and UE is similar to the distance between the TRP and target object or the distance between the target object and the UE, the signal for sensing (e.g., a signal reflecting from the target object) may be in the same order of magnitude as the TRP-UE background channel, which may increase the utility of the signal for sensing procedures. For TRP-TRP bistatic sensing, the orientation of the TRP antennas/panels and the height of the TRP(s) may increase the ease of implementation for the TRP-TRP bistatic mode due to reduced TRP-to-TRP background channel impact.

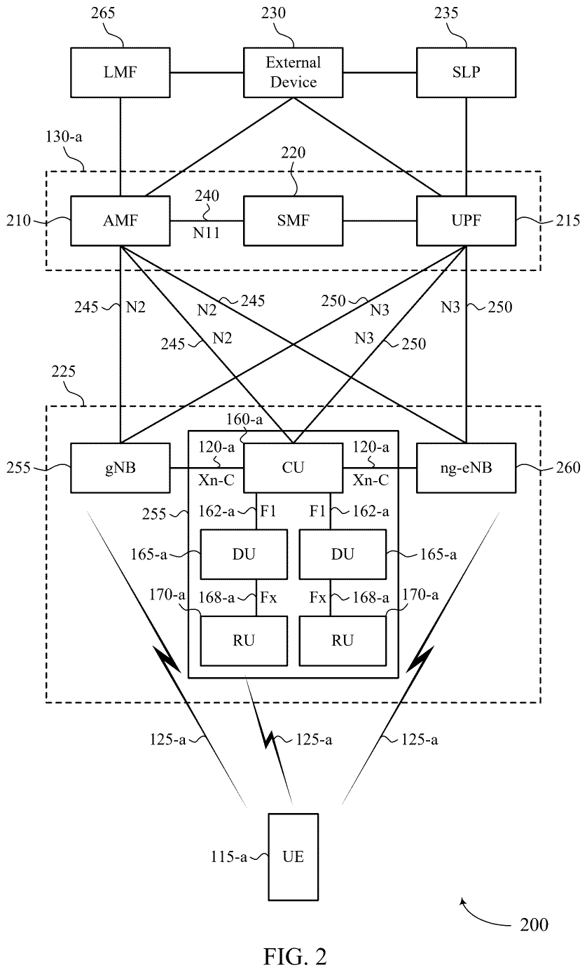

FIG. 2 shows an example of a network structure 200 that supports activation conditions for sensing procedures in accordance with one or more aspects of the present disclosure. The wireless network structure 200 may include a core network 130-a, a RAN 225, a UE 115-a, an LMF 265, an external device 230 (e.g., third-party device or server), or an SLP 235. In some examples, the wireless network structure 200 may be included in the wireless communications system 100 described with reference to FIG. 1. The core network 130-a may be an example of the core network 130, the UE 115-a may be an example of the UEs 115, or the LMF 265 may be an example of the location or sensing server 185, as described with reference to FIG. 1. In some examples, an SnMF may be included in the network structure 200 instead of, or in addition to, the LMF 265.

The core network 130-a may provide one or more control plane (C-plane) functions (e.g., UE registration, authentication, network access, or gateway selection, among other examples) or one or more user plane (U-plane) functions (e.g., UE gateway function, data network access, or IP routing, among other examples). One or more of the functions of the core network 130-a may be implemented in one or more devices (e.g., one or more electronic devices, computing devices, servers, among other examples) in hardware (e.g., circuitry) or a combination of hardware and instructions (e.g., a processor with instructions). The core network 130-a may be an EPC, 5GC, or a Next Generation Core (NGC), among other examples.

The core network 130-a may provide an AMF 210, a session management function (SMF) 220, or a user plane function (UPF) 215. The AMF 210 may provide one or more C-plane functions, such as registration management, connection management, reachability management, mobility management, lawful interception, transport for session management (SM) messages between one or more UEs 115-a and the SMF 220, transparent proxy services for routing SM messages, access authentication and access authorization, transport for short message service (SMS) messages between the UE 115-a and the short message service function (SMSF) (not shown in FIG. 2), or security anchor functionality (SEAF) (not shown in FIG. 2), among other examples. In some aspects, the AMF 210 may interact with an authentication server function (AUSF) (not shown in FIG. 2) and the UE 115-a, and may receive an intermediate key established as a result of a UE 115-a authentication process. In a case of authentication based on a universal mobile telecommunications system (UMTS) subscriber identity module (USIM), the AMF 210 may retrieve security information from the AUSF. In some examples, the AMF 210 may provide a security context management (SCM) function. The SCM function may receive a key from the SEAF that may be utilized to derive access-network specific keys. The AMF 210 may provide location services management for regulatory services, transport for location services messages between the UE 115-a and an LMF 265, transport for location services messages between the RAN 225 and the LMF 265, evolved packet system (EPS) bearer identifier allocation for interworking with the EPS, or UE 115-a mobility event notification. In some approaches, the AMF 210 may support one or more functionalities for Third Generation Partnership Project (3GPP) access networks or non-3GPP access networks.

The UPF 215 may provide one or more U-plane functions, such as acting as an anchor point for intra/inter-RAT mobility, acting as an external protocol data unit (PDU) session point of interconnection to a data network (not shown in FIG. 2), providing packet routing and forwarding, packet inspection, user plane policy rule enforcement (e.g., gating, redirection, or traffic steering), user plane collection (e.g., interception), traffic usage reporting, quality of service (QoS) handling for the U-plane (e.g., uplink or downlink rate enforcement, reflective QoS marking in the downlink), uplink traffic verification (e.g., service data flow (SDF) to QoS flow mapping), transport level packet marking in the uplink or downlink, downlink packet buffering, downlink data notification triggering, or sending or forwarding one or more indications of an end of a transmission (e.g., “end markers”) to a source RAN node, among other examples. In some examples, the UPF 215 may support the transfer of location services messages over a U-plane between the UE 115-a and another device (e.g., the SLP 235 or the external device 230.

The SMF 220 may provide one or more functions, such as session management, UE IP address allocation and management, selection and control of user plane functions, configuration of traffic steering at the UPF 215 to route traffic to a destination, control (e.g., partial control) of policy enforcement or QoS, or downlink data notification. In some aspects, the SMF 220 may communicate with the AMF 210 over an N11 interface 240.

The RAN 225 may include one or more gNBs 255 or one or more ng-eNBs 260. The gNB(s) 255 or the ng-eNB(s) 260 may be examples of the network nodes 105 described with reference to FIG. 1. For instance, a next generation RAN (NG-RAN) may include one or more gNBs 255, or other examples of the RAN 225 may include one or more ng-eNBs 260 or gNBs 255.

The core network 130-a may communicate with the RAN 225 via a C-plane interface 245 (e.g., NG-C or N2 interface) or a U-plane interface 250 (e.g., NG-U or N3 interface). The C-plane interface 245 or the U-plane interface 250 may connect the gNB 255 or the ng-eNB 260 to the core network 130-a (e.g., to one or more control plane functions or one or more user plane functions). For instance, the C-plane interface 245 may connect the AMF 210 to one or more gNBs 255 or ng-eNBs 260 in the RAN 225, or the U-plane interface 250 may connect the UPF 215 to one or more gNBs 255 or ng-eNBs 260 in the RAN 225. The gNB(s) 255 or ng-eNB(s) 260 of the RAN 225 may communicate with each other via one or more backhaul communication links 120-a (e.g., Xn-C interface). The backhaul communication link(s) 120-a may be examples of the backhaul communication links 120 described with reference to FIG. 1. One or more of the gNBs 255 or ng-eNBs 260 may communicate with one or more UEs 115-a over one or more communication links 125-a (e.g., the Uu interface). The communication link(s) 125-a may be examples of the communication links 125 described with reference to FIG. 1.

The LMF 265 may communicate with the core network 130-a to provide location functionality (e.g., to participate in one or more positioning procedures) for the UE(s) 115-a. The LMF 265 may be an example of the location or sensing server 185 described with reference to FIG. 1. The LMF 265 may be implemented as one or more devices (e.g., one or more servers, such as physically separate servers, one or more instruction sets on a single server, or instruction sets distributed across multiple physical servers, among other examples). The LMF 265 may support one or more location services for one or more UEs 115-a that may connect to the LMF 265 via the RAN 225, via the core network 130-a, or via another connection (e.g., the Internet). In some examples, the LMF 265 may communicate with a UE 115-a or another device via a C-plane connection (e.g., using one or more interfaces or protocols for signaling control information, or separate from voice or payload data). In some aspects, the LMF 265 may be integrated into a component of the core network 130-a or may be external to the core network 130-a (e.g., on an external device 230, such as an original equipment manufacturer (OEM) server or other server).

In some examples, the SLP 235 may provide location functionality (e.g., may participate in one or more positioning procedures) for the UE(s) 115-a. The SLP 235 may be an example of the location or sensing server 185 described with reference to FIG. 1. The SLP 235 may be implemented as one or more devices (e.g., one or more servers, such as physically separate servers, one or more instruction sets on a single server, or instruction sets distributed across multiple physical servers, among other examples). The SLP 235 may support one or more location services for one or more UEs 115-a that may connect to the SLP 235 via the RAN 225, via the core network 130-a, or via another connection (e.g., the Internet). In some examples, the SLP 235 may communicate with a UE 115-a or another device via a U-plane connection (e.g., using one or more interfaces or protocols for signaling voice or payload data, such as a transmission control protocol (TCP) or IP).

In some examples, the external device 230 may communicate with the LMF 265, the SLP 235, the core network 130-a (e.g., via the AMF 210 or the UPF 215), the RAN 225, or the UE 115-a to obtain location information (e.g., a location estimate) for the UE 115-a. The external device 230 may be referred to as a location services (LCS) client or an external client. The external device 230 may be implemented as one or more devices (e.g., one or more servers, such as physically separate servers, one or more instruction sets on a single server, or instruction sets distributed across multiple physical servers, among other examples). The external device 230 may support one or more location services for one or more UEs 115-a that may connect to the external device 230 via the RAN 225, via the core network 130-a, or via another connection (e.g., the Internet). In some examples,

In some approaches, the functionality of a gNB 255 may be divided between a CU 160-a, one or more DUs 165-a, or one or more RUs 170-a. The CU 160-a may be an example of the CU 160 described with reference to FIG. 1, the one or more DUs 165-a may be examples of the DU 165 described with reference to FIG. 1, or the one or more RUs 170-a may be examples of the RU 170 described with reference to FIG. 1. In some examples, the CU 160-a may provide one or more functions, such as transferring user data, mobility control, radio access network sharing, positioning, session management, or others, except for one or more functions allocated exclusively to the DU(s) 165-a. A DU 165-a may support one or more cells. The DUs 165-a may communicate with the CU 160-a via midhaul communication links 162-a (e.g., via the F1 interface). The midhaul communication links 162-a may be examples of the midhaul communication links 162 described with reference to FIG. 1. The RUs 170-a may perform one or more functions such as power amplification, signal transmission, or signal reception. The RUs 170-a may communicate with the DUs 165-a via fronthaul communication links 168-a (e.g., via the Fx interface). The fronthaul communication links 168-a may be examples of the fronthaul communication links 168 described with reference to FIG. 1. The UE 115-a may communicate with the gNB 255, RU 170-a, or ng-eNB 260 a via communication links 125-a. The communication links 125-a may be examples of the communication links 125 described with reference to FIG. 1. The UE 115-a may communicate with the CU 160-a via the RRC, SDAP, and PDCP layers, with a DU 165-a via the RLC and MAC layers, or with an RU 170-a via the PHY layer.

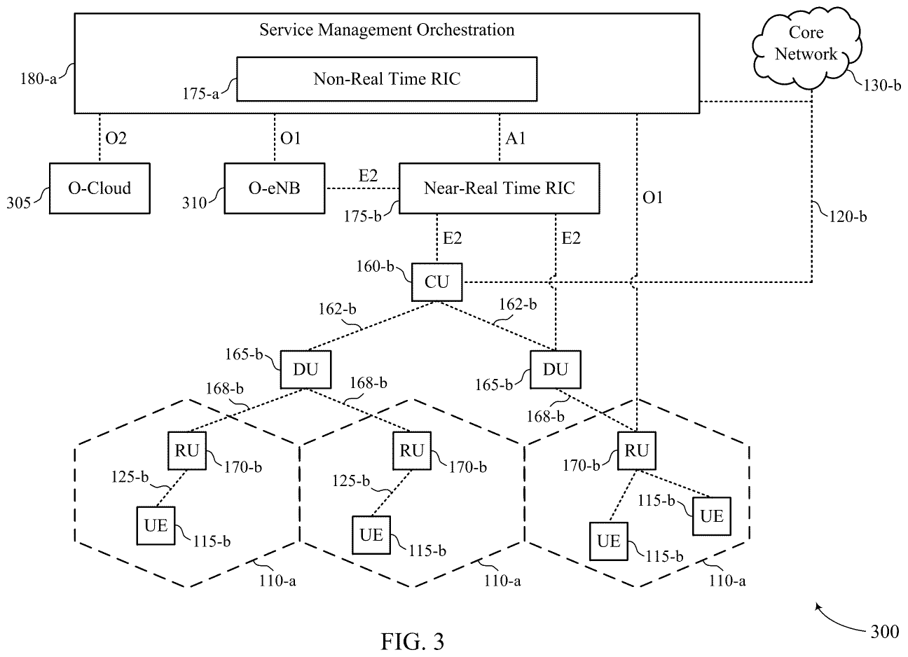

FIG. 3 shows an example of a network architecture 300 (e.g., a disaggregated base station architecture, a disaggregated RAN architecture) that supports activation conditions for sensing procedures in accordance with one or more aspects of the present disclosure. The network architecture 300 may illustrate an example for implementing one or more aspects of the wireless communications system 100. The network architecture 300 may include one or more CUs 160-b that may communicate directly with a core network 130-b via a backhaul communication link 120-b, or indirectly with the core network 130-b through one or more disaggregated network nodes 105 (e.g., a Near-RT RIC 175-b via an E2 link, or a Non-RT RIC 175-a associated with an SMO 180-a (e.g., an SMO Framework), or both). A CU 160-b may communicate with one or more DUs 165-b via respective midhaul communication links 162-b (e.g., an F1 interface). The DUs 165-b may communicate with one or more RUs 170-b via respective fronthaul communication links 168-b. The RUs 170-b may be associated with respective coverage areas 110-a and may communicate with UEs 115-b via one or more communication links 125-b. In some implementations, a UE 115-b may be simultaneously served by multiple RUs 170-b.

Each of the network nodes 105 of the network architecture 300 (e.g., CUs 160-b, DUs 165-b, RUs 170-b, Non-RT RICs 175-a, Near-RT RICs 175-b, SMOs 180-a, Open Clouds (O-Clouds) 305, Open eNBs (O-eNBs) 310) may include one or more interfaces or may be coupled with one or more interfaces configured to receive or transmit signals (e.g., data, information) via a wired or wireless transmission medium. Each network node 105, or an associated processor (e.g., controller) providing instructions to an interface of the network node 105, may be configured to communicate with one or more of the other network nodes 105 via the transmission medium. For example, the network nodes 105 may include a wired interface configured to receive or transmit signals over a wired transmission medium to one or more of the other network nodes 105. Additionally, or alternatively, the network nodes 105 may include a wireless interface, which may include a receiver, a transmitter, or transceiver (e.g., an RF transceiver) configured to receive or transmit signals, or both, over a wireless transmission medium to one or more of the other network nodes 105.

In some examples, a CU 160-b may host one or more higher layer control functions. Such control functions may include RRC, PDCP, SDAP, or the like. Each control function may be implemented with an interface configured to communicate signals with other control functions hosted by the CU 160-b. A CU 160-b may be configured to handle user plane functionality (e.g., CU-UP), control plane functionality (e.g., CU-CP), or a combination thereof. In some examples, a CU 160-b may be logically split into one or more CU-UP units and one or more CU-CP units. A CU-UP unit may communicate bidirectionally with the CU-CP unit via an interface, such as an E1 interface when implemented in an O-RAN configuration. A CU 160-b may be implemented to communicate with a DU 165-b, as necessary, for network control and signaling.

A DU 165-b may correspond to a logical unit that includes one or more functions (e.g., base station functions, RAN functions) to control the operation of one or more RUs 170-b. In some examples, a DU 165-b may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-b may further host one or more low PHY layers. Each layer may be implemented with an interface configured to communicate signals with other layers hosted by the DU 165-b, or with control functions hosted by a CU 160-b.

In some examples, lower-layer functionality may be implemented by one or more RUs 170-b. For example, an RU 170-b, controlled by a DU 165-b, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-b may be implemented to handle over the air (OTA) communication with one or more UEs 115-b. In some implementations, real-time and non-real-time aspects of control and user plane communication with the RU(s) 170-b may be controlled by the corresponding DU 165-b. In some examples, such a configuration may enable a DU 165-b and a CU 160-b to be implemented in a cloud-based RAN architecture, such as a vRAN architecture.

The SMO 180-a may be configured to support RAN deployment and provisioning of non-virtualized and virtualized network nodes 105. For non-virtualized network nodes 105, the SMO 180-a may be configured to support the deployment of dedicated physical resources for RAN coverage requirements which may be managed via an operations and maintenance interface (e.g., an O1 interface). For virtualized network nodes 105, the SMO 180-a may be configured to interact with a cloud computing platform (e.g., an O-Cloud 305) to perform network node life cycle management (e.g., to instantiate virtualized network nodes 105) via a cloud computing platform interface (e.g., an O2 interface). Such virtualized network nodes 105 can include, but are not limited to, CUs 160-b, DUs 165-b, RUs 170-b, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-b via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, artificial intelligence (AI) or machine learning (ML) workflows including model training and updates, or policy-based guidance of applications/features in the Near-RT RIC 175-b. The Non-RT RIC 175-a may be coupled with or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-b, one or more DUs 165-b, or both, as well as an O-eNB 310, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

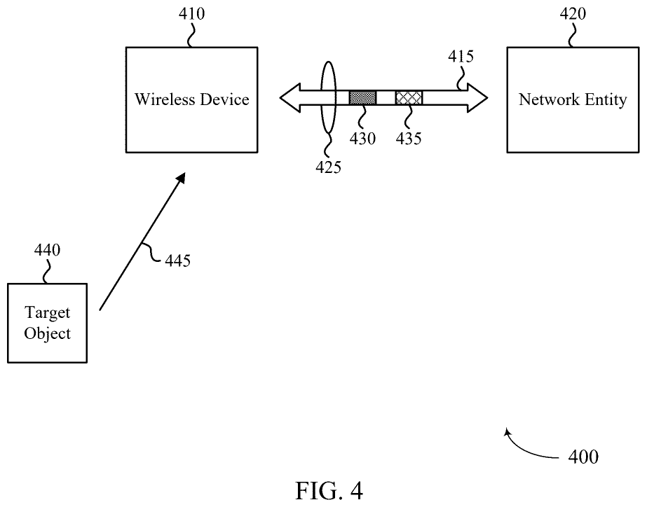

FIG. 4 shows an example of a wireless communications system 400 that supports activation conditions for sensing procedures in accordance with one or more aspects of the present disclosure. The wireless communications system 400 may implement aspects of, or may be implemented by aspects of, the wireless communications system 100. For example, the wireless communications system 400 includes a wireless device 410, which may be an example of a UE 115, network node 105, RU 170, DU 165, or CU 160 described with reference to FIG. 1, a UE 115-a, gNB 255, RU 170-a, DU 165-a, CU 160-a, or ng-eNB 260 described with reference to FIG. 2, a UE 115-b, RU 170-b, DU 165-b, or CU 160-b described with reference to FIG. 3, a TRP, or other wireless device. The wireless communications system 400 also includes a network entity 420, which may be an example of a network node 105, location or sensing server 185, RU 170, DU 165, or CU 160 described with reference to FIG. 1, an LMF 265, external device 230, SLP 235, AMF 210, SMF 220, UPF 215, gNB 255, RU 170-a, DU 165-a, CU 160-a, or ng-eNB 260 described with reference to FIG. 2, an RU 170-b, DU 165-b, or CU 160-b described with reference to FIG. 3, or other device. In some examples, the network entity 420 may be an example of a NWDAF, over-the-top (OTT) server, SnMF, or an operations, administration, and maintenance (OAM) entity, among other examples.

The wireless device 410 may communicate with the network entity 420 using one or more links 425, one or more of which may be an example of a communication link 125, a backhaul communication link 120, or a communication link 155 described with reference to FIG. 1, a communication link 125-a, a backhaul communication link 120-a, a C-plane interface 245, or a U-plane interface 250 described with reference to FIG. 2, a communication link 125-b or a backhaul communication link 120-b described with reference to FIG. 3, or another link. The link(s) 425 may include one or more uni-directional or bi-directional links, one or more of which may enable uplink, downlink, or other communications. For example, the wireless device 410 may communicate (e.g., transmit or receive) one or more signals 415, such as control signals or data signals, to or from the network entity 420 using the link(s) 425, or the network entity 420 may communicate (e.g., transmit or receive) one or more signals 415, such as control signals or data signals, to or from the wireless device 410 using the link 425(s). The signal(s) 415 may include one or more uplink transmissions, downlink transmissions, or other transmissions.

In some approaches, the wireless device 410 (e.g., a UE or network entity) or the network entity 420 may be capable of performing one or more sensing procedures to generate position or sensing information. A sensing procedure may be one or more operations for estimating a position of a target object 440 or sensing a target object 440 (e.g., a device such as a wireless device, a UE, a vehicle, a person, a road, a sign, a building, or other object(s)). While some of the examples herein are described in terms of a target object 440, it should be noted that some examples of the techniques described may be performed for one or more target objects. As used herein, a “sensing procedure” may include one or more operations for sensing an object or a “sensing session” may include an event or time period in which one or more operations for sensing an object are performed. For instance, a sensing procedure may be performed to estimate one or more attributes of the target object 440, such as position, speed, velocity, object type, or other information.

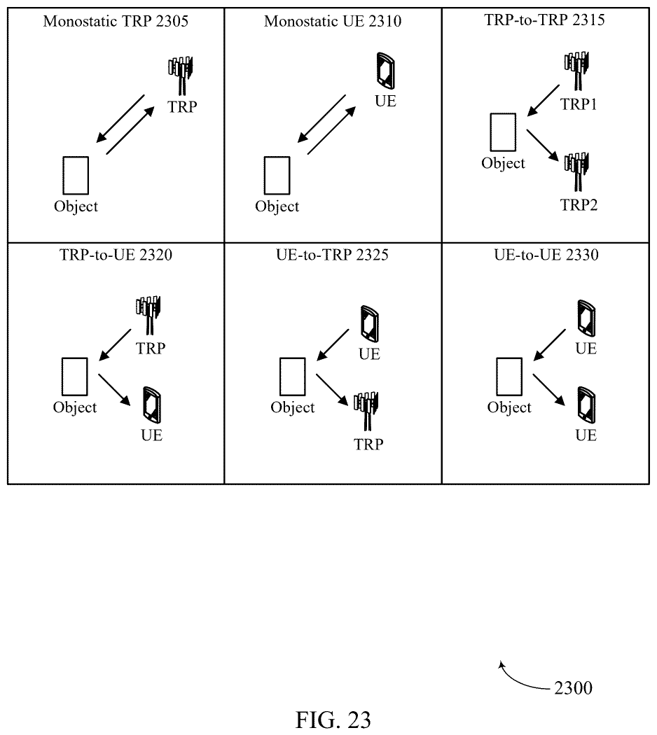

In some examples, a sensing procedure may include one or more operations of sensor-based positioning (e.g., monostatic mode(s), bi-static mode(s), or multi-static mode(s)), RF-based sensing, WLAN-based sensing, Bluetooth-based sensing, or TBS-based sensing, among other examples. A sensing procedure may produce sensing information. Position information may be an example of sensing information that includes an estimated position (e.g., estimated location) or one or more measurements associated with a position of a target object 440. For instance, position information may include a position or measurement determined based on one or more sensing procedures, such as sensor-based positioning (e.g., monostatic mode(s), bi-static mode(s), or multi-static mode(s), among other examples). Examples of sensing procedures are described with reference to FIG. 23.

In some approaches, a sensing procedure may be based on channel modeling. Channel modeling may be utilized to support target object 440 detection or tracking. In some aspects, a sensing procedure may be performed to detect or track one or more target objects 440 (or the distinguish one or more target objects 440 from one or more non-target objects). Examples of target objects may include unmanned aerial vehicles (UAVs), humans (in an indoor or outdoor environment), automotive vehicles (in an indoor or outdoor environment), automated guided vehicles (AGVs) (in an indoor or outdoor environment), or an object creating a hazard on a road or railway (which may have a minimum size that may depend on frequency, for example). Some examples of the techniques described herein may be applicable to one or more of six sensing modes, which may include TRP-TRP bistatic sensing, TRP monostatic sensing, TRP-UE bistatic sensing, UE-TRP bistatic sensing, UE-UE bistatic sensing, or UE monostatic sensing.

A sensing procedure may include transmitting a signal, receiving a signal, measuring a signal to generate measurement information, communicating measurement information, or determining one or more attributes of a target object 440 (based on measurement information, for instance). Measurement information may include or indicate one or more measurements. A measurement may be measured, sensed, generated, calculated, inferred, or predicted based on one or more samples, sensor data, information, or characteristics of a signal. Examples of measurements may include signal strength, reference signal received power (RSRP), reference signal received path power (RSRPP), received signal strength indicator (RSSI), reference signal received quality (RSRQ), signal-to-interference plus noise ratio (SINR), SNR, channel frequency response (CFR), channel impulse response (CIR), power delay profile (PDP), delay profile (DP), channel quality indicator (CQI), CSI, LOS indicator, time of arrival (TOA), angle of arrival (AOA), angle of departure (AOD), round-trip time (RTT), reference signal time difference (RSTD), time difference of arrival (TDOA), reference signal carrier phase (RSCP), reference signal carrier phase difference (RSCPD), reception-to-transmission (Rx-Tx) time difference, range, distance, image data, temperature data, motion data, Doppler data, velocity data, or speed data, among other examples. In some examples, a measurement may be data or an indicator that indicates one or more of the aforementioned values.

One example of an attribute that may be determined in accordance with a sensing procedure is a position. A position may be information or data indicating a point, area, or region where a target object 440 is located. A position may be expressed as coordinates (e.g., latitude, longitude, or altitude of a geographic coordinate system (GCS), universal transverse mercator (UTM) coordinates, state plane coordinate system (SPCS) coordinates, or Earth-centered Earth-fixed (ECEF) coordinates, among other examples), an address, or a location relative to another location, among other examples.

In some examples, a network entity 420 may output (e.g., transmit), or the wireless device 410 may obtain (e.g., receive), an indication 430 of an activation condition to participate in a sensing procedure for a target object 440. An activation condition may be a condition for activating (e.g., triggering) measurement of a signal 445, storage of measurement information, or reporting of measurement information. The activation condition may be based on a location of a transmission node or a reception node for the sensing procedure, or may be based on a signal characteristic for the sensing procedure.

A transmission node may be a device that transmits a signal (e.g., an RF signal, a reference signal, or another signal that may be utilized for sensing). A reception node may be a device that receives a signal (e.g., a reference signal or a signal that may be utilized for sensing). In some approaches, the wireless device 410 may be a transmission node, a reception node, or a combination thereof. In a case (e.g., sensing mode) where the wireless device 410 is the transmission node and the reception node, for instance, the wireless device 410 may output (e.g., transmit) a signal, where the signal 445 may be reflected from the target object 440 and received by the wireless device 410. In another case (e.g., sensing mode) where the wireless device 410 is the reception node (and is not the transmission node), the transmission node may output (e.g., transmit) a signal, where the signal 445 may be reflected from the target object 440 and received by the wireless device 410.

In some examples, the signal 445 may be a signal (e.g., sensing signal) in a frequency range of 0.5 to 52.6 GHz (or up to 100 GHz, for instance). The characteristics (e.g., frequency(ies), signaling pattern(s), modulation(s), or data, among other examples) of the signal 445 may be selected for one or more deployment scenarios or sensing modes. For instance, the signal 445 may be utilized for sensing one or more target objects 440 (e.g., with one or more radar cross sections) in a background environment (e.g., for spatial usage with one or more clutter or scattering patterns) in accordance with channel modeling.

In some examples, the signal 445 may be a reference signal. For example, a transmission node may output (e.g., transmit), or the wireless device 410 may obtain (e.g., receive), a reference signal. The reference signal may be a signal (e.g., electromagnetic signal, RF signal) with one or more established characteristics (e.g., signaling pattern, strength, amplitude, magnitude, frequency, timing, modulation, phase, or data, among other examples). For instance, the wireless device 410 may store information indicating one or more of the characteristics of the reference signal, which may allow for comparison of one or more stored characteristics and one or more characteristics of the received reference signal. The reference signal (e.g., the comparison) may enable channel estimation (e.g., channel attenuation, phase, frequency shift, or Doppler effects, among other examples), positioning, or tracking. Examples of the reference signal may include a reference signal of a synchronization signal block (SSB), a CSI-RS, a PRS, an SRS, a demodulation reference signal (DMRS), or a tracking reference signal (TRS), among other examples.

In some examples, the wireless device 410 may obtain, receive, sense, capture, or generate one or more measurements. For instance, the wireless device 410 may include, may communicate with, or may be coupled with one or more sensors to obtain one or more measurements. Examples of a sensor may include an image sensor(s), infrared (IR) sensor(s), light sensor(s), depth sensor(s) (e.g., light detection and ranging (LIDAR), stereoscopic camera(s), or time-of-flight (TOF) sensor(s)), microphone(s), or RF sensor(s), among other examples. Examples of one or more measurements may include a range map (e.g., depth map), Doppler map, space map, angle map, light spectrum data, pixel(s), image(s) (e.g., red-green-blue-depth (RGBD) image(s)), audio signal(s), temperature map, TOF measurement(s), RF measurement(s), or other information (e.g., information regarding one or more objects). The signal 445 may be utilized to obtain one or more measurements, or may be utilized to determine one or more attributes of the target object 440.

The location of the transmission node or the reception node may be a relative location, an absolute location, or a quantity that is based on a relative location or absolute location of the transmission node, of the reception node, or a combination thereof. For example, the location of the transmission node or the reception node may be a position of the transmission node, a position of the reception node, a distance between the transmission node and the reception node, a distance between the transmission node or the reception node and the target object 440, an angle (e.g., bistatic angle), a relative elevation between the transmission node and the reception node, an absolute elevation of the transmission node or the reception node, another quantity based on the location, or a combination thereof. The activation condition may be satisfied if the location (e.g., a quantity based on the location) satisfies a threshold or meets a condition based on the location.

A signal characteristic of the sensing procedure may be a characteristic of the signal 445 that is reflected from the target object 440 or of another signal. For instance, the signal characteristic may be an RSRP of the signal 445, an RSSI of the signal 445, or an expected power based on a radar cross section. The activation condition may be satisfied if the signal characteristic (e.g., a quantity based on a signal or a measurement thereof) satisfies a threshold or meets a condition based on the signal.

In some approaches, the network entity 420 may output (e.g., transmit), or the wireless device 410 may obtain (e.g., receive) an indication of one or more activation conditions. For instance, the network entity 420 (e.g., a sensing server) may configure the wireless device 410 (e.g., a sensing UE) with one or more activation conditions (e.g., trigger(s)), where the wireless device 410 may participate in the sensing procedure (e.g., sensing session) when the activation condition(s) is satisfied (e.g., only when the activation conditions are validated).

In some approaches, the indication of the activation condition may be signaled via a sensing request message, via assistance data, via unicast signaling, or via broadcast signaling. For example, one or more of the activation conditions or triggers described herein may be signaled to the wireless device 410 via (e.g., as part of) a sensing request message, sensing assistance data, a unicast transmission, or a broadcast transmission (e.g., via a sense system information block (SIB) or a positioning SIB).

In some approaches, the network entity 420 may output (e.g., transmit), or the wireless device 410 may obtain (e.g., receive), configuration information that is indicative of a resource for communication of the signal 445, that is indicative of a type of the one or more measurements, or a combination thereof. For instance, the wireless device 410 (e.g., reception node or sensing node) may be configured with one or more sensing session parameters (e.g., reference signals) or sensing measurements to be performed (e.g., Range-Doppler map), such that, if the configured activation condition(s) (e.g., trigger condition(s)) is met, the wireless device 410 (e.g., UE) may participate in the sensing procedure (e.g., sensing session), may derive the sensing measurement, or may reports the sensing measurements.

In some aspects, the configuration information may be communicated (e.g., output, transmitted, obtained, or received) previous to the satisfaction of the activation condition, or may be communicated in response to a transmission indicative of the satisfaction of the activation condition to the network entity 420. For instance, the wireless device 410 (e.g., a sensing UE) may be configured with one or more activation conditions. Upon satisfaction of the activation condition(s), the wireless device 410 may indicate, to the network entity 420 (e.g., sensing server), the satisfaction of the activation condition(s) (e.g., validity of the activation condition(s)). The network entity 420 (e.g., in response to the indication of the satisfaction of the activation condition(s)) may provide the configuration information (e.g., configuration for sensing, reference signal time resource(s), reference signal frequency resource(s), or sensing measurements to be performed, among other examples) to the wireless device 410. Additionally, or alternatively, one or more activation conditions may be specified or previously established at the wireless device 410.

The wireless device 410 may obtain (e.g., receive), based on a satisfaction of the activation condition, a signal 445 reflected from the target object 440. For instance, in a case that the activation condition is satisfied, the wireless device 410 may receive the signal 445, obtain (e.g., measure or calculate) measurement(s) based on the signal 445, or may store a measurement(s) of the signal 445.

The wireless device 410 may output (e.g., transmit), or the network entity 420 may obtain (e.g., receive) measurement information 435 indicative of one or more measurements of the signal 445 reflected from the target object 440. For instance, the wireless device 410 may report the measurement information 435 to the network entity 420.

In some examples, the activation condition may be based on whether a relative distance between the transmission node and the reception node satisfies a threshold. For instance, the activation (e.g., trigger) condition(s) may include a threshold (e.g., minimum distance) between the transmission node (e.g., Tx UE) and the reception node (e.g., Rx UE). The threshold may be denoted d_{min,bi-sensing}. The relative distance between the transmission node (e.g., Tx UE) and the reception node (e.g., Rx UE) may be denoted d_{Tx-UE,Rx-UE}. The wireless device 410 (e.g., reception node) may participate in the sensing procedure if d_{Tx-UE,Rx-UE}≥d_{min,bi-sensing} (e.g., only if the relative distance is greater than the threshold).

In some approaches, the threshold (e.g., d_{min,bi-sensing}) may be signaled to the wireless device 410 from (e.g., configured by) the network entity 420 (e.g., sensing server). In some aspects, the determination of the relative distance (e.g., d_{Tx-UE,Rx-UE}) may be based on one or more technologies (e.g., non-cellular RAT technologies), such as via GPS, Wi-Fi RTT, Bluetooth Low Energy (BLE), or BLE beacon control system (BCS). For instance, the wireless device 410 or another device may determine a position of the transmission node, a position of the reception node, a relative distance based on the positions of the transmission node and the reception node, or may receive an indication of the position of the transmission node, an indication of the position of the reception node, or an indication of the relative distance between the transmission node and the reception node. The wireless device 410 may utilize the determination(s) of the position(s) or the received indication(s) to obtain the relative distance between the transmission node and the reception node. Additionally, or alternatively, the wireless device 410 may determine the relative distance based on resources allocated by the network (e.g., the network entity 420) to the transmission node or the reception node (e.g., UEs) to determine a corresponding range (prior to the sensing procedure or session, for example). For instance, the transmission node or the reception node may perform a positioning procedure to determine position information or the relative distance. Examples of positioning procedures may include A-GNSS positioning, OTDOA positioning, E-CID positioning, sensor-based positioning, WLAN-based positioning, Bluetooth-based positioning, TBS positioning, DL-TDOA positioning, DL-AOD positioning, Multi-RTT positioning, NR E-CID positioning, UL-TDOA positioning, UL-AOA positioning, or other positioning.

In some approaches, the activation condition may be based on whether a relative distance between the transmission node and the reception node satisfies a threshold, where the threshold is based on a first distance between the transmission node and the target object 440, or based on a second distance between the reception node and the target object 440. For instance, the activation condition (e.g., trigger condition(s)) that is based on the relative distance between the transmission node and the reception node (e.g., d_{Tx-UE,Rx-UE}) may be a function of a first distance between the transmission node and the target object 440 (which may be denoted d_{Tx-Target}) or may be a function of a second distance between the reception node and the target object 440 (which may be denoted d_{Rx-Target}). For instance, the wireless device 410 (e.g., sensing UE) may participate (e.g., may only participate) in the sensing procedure or session if at least one of the first distance or second distance satisfies a threshold. The threshold (e.g., a lower threshold or minimum threshold) may be the relative distance between the transmission node and the reception node. For example, d_{Tx-UE,Rx-UE}≥min(d_{Tx-Target}, d_{Rx-Target}). In some approaches, another threshold (e.g., second threshold, upper threshold, or maximum threshold) may be utilized. For example, another threshold may be utilized for d_{Tx-UE,Rx-UE}, which may be denoted d_{Tx-UE,Rx-UE},max. The activation condition may be further based on a satisfaction of the other threshold (e.g., d_{Tx-UE,Rx-UE}; d_{Tx-UE,Rx-UE,max}). The other threshold (e.g., d_{Tx-UE,Rx-UE},max may be signaled by (e.g., configured by) the network entity 420.

In some examples, the network entity 420 may output (e.g., transmit), or the wireless device 410 may obtain (e.g., receive), an indication of the location of the transmission node, an indication of a location of the target object 440, or a combination thereof. In some approaches where the activation condition (e.g., trigger condition) is evaluated at the wireless device 410 (e.g., receiving node or Rx sensing UE), for example, the wireless device 410 may obtain information indicating the position or location of the transmission node (e.g., Tx UE), or the position or location of the target object 440. The information (e.g., position or location of the transmission node or the position or location of the reception node) may be communicated by the network entity 420 (e.g., sensing server). In some aspects, the information may be communicated in a tracking phase. Additionally, or alternatively, the position or location of one or more transmission nodes (e.g., transmitting sensing UEs) may be fixed or established. For instance, one or more transmission nodes may be a positioning reference unit or a roadside unit (RSU).

In some aspects, the activation condition may be based on whether a relative distance satisfies a threshold, where the relative distance may be between the transmission node and the target object 440, or may be between the reception node and the target object 440. For instance, the activation condition (e.g., trigger condition(s)) that is based on the relative distance between the transmission node and the reception node (e.g., d_{Tx-UE,Rx-UE}) may be a function of a first distance between the transmission node and the target object 440 (which may be denoted d_{Tx-Target}) or may be a function of a second distance between the reception node and the target object 440 (which may be denoted d_{Rx-Target}). In some approaches, the wireless device 410 (e.g., sensing UE) may participate (e.g., may only participate) in the sensing procedure or session if at least one of the first distance or second distance satisfies one or more thresholds. For example, d_{Tar,min}≤d_{Tx-Target}≤d_{Tar,max}, where d_{Tar,min} is a threshold (e.g., first threshold, lower threshold, or minimum threshold for distance) and d_{Tar,max} is a threshold (e.g., second threshold, upper threshold, or maximum threshold for distance). In some approaches, one or more thresholds (e.g., the first threshold or the second threshold) may be utilized. Additionally, or alternatively, one or more thresholds (e.g., the first threshold (d_{Tar,min}) or the second threshold (d_{Tar,max}) may be signaled from (e.g., configured by) the network entity 420 to the wireless device 410 (e.g., UE).

In some approaches, the activation condition (e.g., distance or range condition) can be utilized for monostatic sensing. For instance, the distance between the transmission node and the target object 440, or the distance between the reception node and the target object 440 may be utilized as a triggering condition (e.g., where the relative distance between the transmission node and the reception node may be approximately 0 or d(Tx, Rx)=0). Additionally, or alternatively, for monostatic sensing, a first threshold (e.g., lower threshold or minimum range) or a second threshold (e.g., upper threshold or maximum range) may be utilized (e.g., d_{Tar,min}≤d_{Tx-Target}≤d_{Tar,max}).

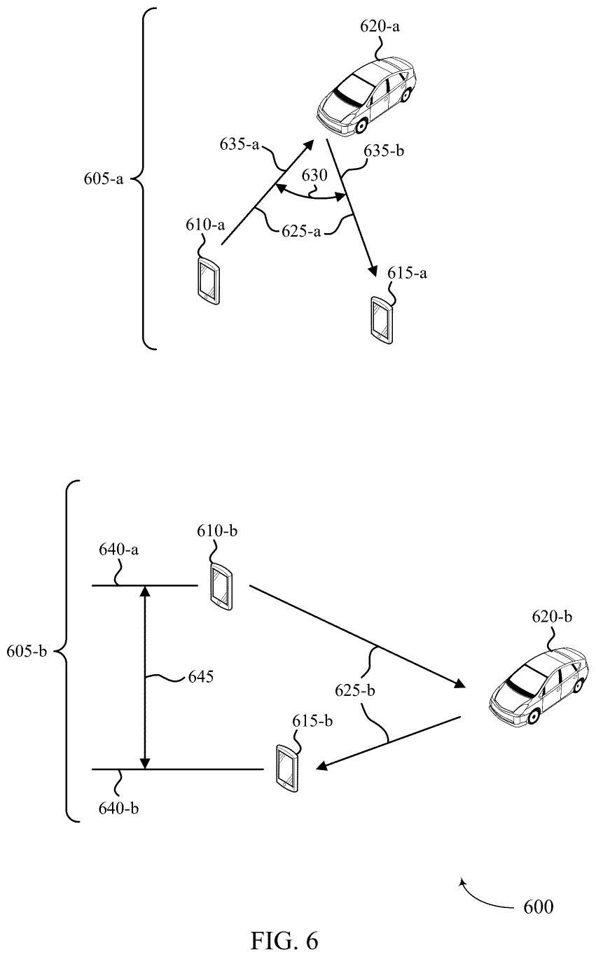

In some examples, the activation condition may be based on whether an angle satisfies a threshold. The angle (e.g., a bistatic angle) may be between a first ray that is between the transmission node and the target object 440, and a second ray that is between the reception node and the target object 440. An example of the angle is provided with reference to FIG. 6. For instance, the activation (e.g., trigger) condition may be based on a target bistatic angle. The target bistatic angle may be determined based on positions or locations of the transmission node, the reception node, and the target object 440. The angle (e.g., bistatic angle) may be denoted β. In some approaches, the wireless device 410 (e.g., sensing UE) may participate in the sensing procedure or session if (e.g., only if) the angle is within a threshold angle range (e.g., where the estimated β∈[βₘᵢₙ, βₘₐₓ], where βₘᵢₙ is a first angle (e.g., lower or minimum angle) and βₘₐₓ is a second angle (e.g., an upper or maximum angle). In some examples, the network entity 420 may signal (e.g., configure) the threshold angle range (e.g., a range interval [βₘᵢₙ, βₘₐₓ]) or a single angle of the first angle or the second angle (e.g., one the parameters βₘᵢₙ or βₘₐₓ). In some aspects, the angle (e.g., β) may be estimated based on the target object 440 position or location, the transmission node position or location, and the reception node position or location.

In some approaches, the activation condition may be based on whether an elevation satisfies a threshold. The elevation may be a relative elevation between the transmission node and the reception node. Additionally, or alternatively, the elevation may be an absolute elevation of the transmission node or of the reception node. For instance, the activation (e.g., trigger) condition may be based on a relative elevation between participating sensing nodes. In some aspects, the activation condition may be based on a first threshold (e.g., lower relative elevation or minimum relative elevation) or a second threshold (e.g., an upper relative elevation or maximum relative elevation). The activation condition based on elevation may be applicable to cases where a quantity of relative height between transmission node and reception node (e.g., sensing nodes) may help ensure a LOS condition between the transmission node and reception node and the target object 440, or may help ensure a reduction of background obstruction, noise, or clutter. In some examples, the first threshold or second threshold may be signaled to the wireless device 410 or configured by the network entity 420. Whether the activation condition is based on the first threshold (e.g., lower or minimum threshold) or a second threshold (e.g., upper or maximum threshold) of relative elevation may depend on the scenario or environment. In one environment such as an indoor factory, for example, if the relative elevation between UEs is less than 1 meter, there is significant chance that one or more blockers (e.g., machinery) in the background may cause clutter or interfere with the signal of interest, the relative elevation threshold may be at least 1 meter. In a second environment, for example, such as for sensing between vehicles on a highway, the relative elevation may be smaller than a threshold to help ensure that vehicles (e.g., only vehicles) are sensed, or to help ensure that other surrounding object environments cause reduced clutter or interference. An example of relative elevation is provided with reference to FIG. 6.

In some approaches, the activation (e.g., trigger) condition may be based on the absolute elevation of one or more participating nodes (e.g., transmission node, reception node, or sensing nodes). For instance, the activation condition may be based on one or more threshold (e.g., lower, minimum, upper, maximum, or range) of elevation for transmission node, the reception node, or a sensing node. The absolute elevation may be utilized for similar reasons as the relative elevation.

In some examples, the activation condition may be based on whether a threshold is satisfied by a power or a strength of signaling via a background channel between the transmission node and the reception node. For instance, the activation (e.g., trigger) condition may include an interval range for a power (e.g., RSRP) or a strength (e.g., RSSI) of the link between the transmission node and the reception node (e.g., Tx-Rx link). In some examples, the wireless device 410 (e.g., sensing UE) may participate in the sensing procedure or session if the power or strength is within a threshold range. For instance, the activation condition may be satisfied if RSSI∈[RSSIₘᵢₙ, RSSIₘₐₓ], or RSSI≤RSSIₘₐₓ, where RSSIₘᵢₙ is a first strength (e.g., lower or minimum strength) and RSSIₘₐₓ is a second strength (e.g., an upper or maximum strength), or may be satisfied if RSRP∈[RSRPₘᵢₙ, RSRPₘₐₓ], or RSRP≤RSRPₘₐₓ, where RSRPₘᵢₙ is a first power (e.g., lower or minimum power) and RSRPₘₐₓ is a second power (e.g., an upper or maximum power). In some examples, the network entity 420 may signal (e.g., configure) the threshold range (e.g., a range interval [RSSIₘᵢₙ, RSSIₘₐₓ] or a range interval [RSRPₘᵢₙ, RSRPₘₐₓ]) or a single value of the strength or power (e.g., one or the parameters RSSIₘᵢₙ, RSSIₘₐₓ, RSRPₘᵢₙ, or RSRPₘₐₓ).

In some aspects, utilizing the power or strength of signaling for the activation condition may help to ensure that the background channel is relatively weak compared to the channel component corresponding to the target object (or targets of interest). In some approaches, the power or strength (e.g., RSRP or RSSI) may be measured or computed based on one or more beams that are different from one or beams utilized for sensing. The power or strength of signaling (e.g., RSRP or RSSI) may be measured or computed based on resources configured by the network (e.g., indicated by the network entity 420 to the wireless device 410), or other technology (e.g., non-cellular RAT technology).

In some examples, the activation condition may be based on whether a projected power of the signal 445 reflected from the target object 440 satisfies a condition, where the projected power is based on a radar cross section of the target object 440. For example, given a radar cross section (e.g., an estimated radar cross section or a radar cross section for a type) of the target object 440, the activation condition for the wireless device 410 (e.g., UE) to participate in the sensing procedure or session may be based on projected (e.g., expected receive) power from the transmission node to the target object 440 to the reception node (e.g., wireless device or UE). In some approaches, the wireless device 410 (e.g., UE) may participate in the sensing procedure or session if the projected power satisfies a threshold (e.g., X decibel-milliwatts (dBm), where X may be signaled or configured by the network entity 420 to the wireless device 410). Additionally, or alternatively, the wireless device 410 (e.g., UE) may participate in the sensing procedure or session if the projected power satisfies a threshold (e.g., Y decibels (dB) more than a strength, RSSI, power, or RSRP of the background channel). The projected power (e.g., expected receive power) may be estimated by the wireless device 410 (e.g., UE) based on the target object 440 position or location, the transmission node position or location, or the reception node position or location. In some examples, a pathloss (for determination of the projected power, for instance) may be computed based on a free space path loss model or one or more specified path models. In some examples, the wireless device 410 or the network entity 420 may determine the projected power based on the radar cross section. In some examples, the wireless device 410 or the network entity 420 may communicate (e.g., signal) a radar cross section model for the target object 440.

In some approaches, the activation condition may include a set of conditions. The activation condition may be based on whether at least a subset of the set of conditions is satisfied. For example, the activation (e.g., trigger) condition may include one or more of the activation conditions described herein. In some approaches, the set of conditions (e.g., all of the conditions) may be satisfied for the wireless device 410 to participate in the sensing procedure or session. In some approaches, a subset of the conditions (e.g., one or more of the conditions, a quantity of the conditions, or at least a specified subset of the conditions) may be satisfied for the wireless device 410 to participate in the sensing procedure or session. For instance, the wireless device 410 (e.g., UE) may participate in the sensing procedure or session when at least one condition of the set of conditions is satisfied.

In some approaches, the wireless device 410 may output (e.g., transmit), or the network entity 420 may obtain (e.g., receive), an indication of a reason for which the wireless device 410 does not participate in a sensing procedure or session. For instance, if the wireless device 410 (e.g., UE) does not participate in the sensing procedure or session, a UE sensing report, if sent, may indicate a reason for the non-participation in the sensing procedure session. In some aspects, the reason may be that the activation condition (or one or more conditions of the activation condition) is not satisfied.

In some examples, the wireless device 410 may output (e.g., transmit), or the network entity 420 may obtain (e.g., receive), capability information indicating a capability of the wireless device 410 to utilize the activation condition. The indication of the activation condition may be communicated (e.g., output, transmitted, obtained, or received) based on the capability information. For instance, a capability indication may be communicated from the wireless device 410 (e.g., sensing node) to the network entity 420 (e.g., sensing server), where the capability indication may indicate whether the wireless device 410 may be configured with one or more activation conditions (e.g., triggers) described herein. In some aspects, the indication may be formatted as a capability flag for supporting one or more activation conditions or a capability list of supported activation conditions or triggers, among other examples.

In some aspects, a sensing procedure or session may be performed in two phases, including a scanning phase (e.g., where the target object(s) 440 is detected) and a tracking phase (e.g., where the target object(s) 440 is tracked). In the tracking phase, the position or location of the target object 440 may be established with a probability. Tracking the target object 440 may include updating the probability of the target position or location based on one or more sensing measurements. In some examples of the techniques described herein, the probability of the position or location of the target object 440 may be utilized in the selection of the transmission node or reception node for sensing (e.g., in the selection of sensing UEs, for the case of UE-UE bistatic sensing).

In some examples, the sensing procedure may include bistatic sensing, where the bistatic sensing may be limited to a tracking operation (e.g., may include the tracking phase and not the scanning phase) for the target object 440. For instance, UE-UE bistatic sensing may be utilized in the tracking phase of sensing operations (e.g., for implementation at the network entity 420 or sensing server). One or more of the techniques described herein may be performed by selecting the wireless device 410 (e.g., sensing UE) using the probability of the position or location of the target object(s) 440 (e.g., the initial probability distribution or “prior” for the target object(s) 440).

At least some of the techniques described herein may be utilized for UE-UE bistatic scenarios, TRP-UE bistatic sensing, or TRP-TRP bistatic sensing. Depending on the network entity 420 (e.g., sensing server) and the wireless device 410 (e.g., sensing node), one or more of the signals, information, indications, or other communications described herein may be signaled via a positioning protocol (e.g., NR positioning protocol A (NRPPa) or an equivalent protocol, LTE positioning protocol (LPP) or an equivalent protocol, sidelink positioning protocol (SLPP) or an equivalent protocol, or another protocol). In some approaches, one or more of the activation condition parameters (e.g., information, thresholds, quantities, or values, among other examples) described herein that are configured by the network entity 420 (e.g., sensing server), may be determined or obtained by the network entity 420 via crowdsourced data or analysis of sensing sessions data.

Some examples of the techniques described herein may be applied at the wireless device 410 (e.g., sensing node) to determine, via configuration from the network entity 420 (e.g., sensing server), whether to participate in a sensing procedure or session. For instance, some of the techniques may enable conditional sensing procedure or session activation based on one or more conditions configured by the network entity 420 (e.g., sensing server or SnMF). Determination at the wireless device 410 may be useful, for example, when the network entity 420 (e.g., sensing server) does not have the position(s) or location(s) of the transmission node or the reception node (e.g., sensing UEs), and may potentially acquire the position(s) or location(s) of the transmission node or the reception node after the transmission node or reception node has participated in the sensing procedure or session.

In some approaches, the wireless device 410 may output (e.g., transmit), or the network entity 420 may obtain (e.g., receive), an indicator of the satisfaction of the activation condition. The network entity 420 may output (e.g., transmit), or the wireless device 410 may obtain (e.g., receive), activation information indicative of an activation of the sensing procedure based on the satisfaction of the activation condition. When the activation (e.g., trigger) condition(s) is satisfied, for example, the wireless device 410 (e.g., node evaluating the activation condition(s)) may send a first message to the network entity (e.g., server), and the network entity 420 may then send a second message indicating which of a set of previously configured sensing procedures or sessions to activate based on the first message. In some aspects, the network entity 420 (e.g., sensing server) may determine to not activate the wireless device 410 (e.g., UE) for sensing. The wireless device 410 may not receive the acknowledgment, and may not activate the sensing procedure or session when the activation condition(s) is met (if the acknowledgment is not received, for example).

In addition to, or alternatively from the wireless device 410 evaluating the activation condition(s), the network entity 420 may evaluate the activation condition(s). For instance, the network entity 420 may obtain or determine (e.g., via signaling, communication, or calculation) information for evaluating the one or more activation condition(s), and may evaluate one or more of the activation (e.g., triggering) conditions described herein for selecting the one or more wireless devices 410 (e.g., UEs) for inclusion in the sensing procedure or session.

In some approaches, the network entity 420 may determine whether an activation condition is satisfied for a wireless device 410 to participate in a sensing procedure for a target object 440. As described herein, the activation condition may be based on a location of a transmission node or a reception node for the sensing procedure, or may be based on a signal characteristic for the sensing procedure. In some cases, the network entity 420 may output (e.g., transmit), or the wireless device 410 may obtain (e.g., receive), an indication that the wireless device 410 is selected to participate in the sensing procedure based on a satisfaction of the activation condition for the wireless device 410. For example, the network entity 420 (e.g., sensing server) may utilize one or more the criteria described herein (e.g., relative distance between a transmission node and a reception node, a distance between the target object 440 and the transmission node, a distance between the target object 440 and the reception node, an angle between a first ray that is between the transmission node and the target object 440 and a second ray that is between the reception node and the target object 440 or a bistatic angle, an elevation, a power or strength of signaling, a projected power, a radar cross section, one or more thresholds, or other information described herein) to select or configure the wireless device 410 (e.g., UE) for a sensing procedure or session (e.g., RF sensing procedures or sessions). For example, the network entity 420 may obtain one or more of the values, quantities, parameters, or information described herein to determine whether one or more of the activation conditions described herein is satisfied for one or more wireless devices 410, where one or more wireless devices 410 may be selected or configured by the network entity 420 for participation in a sensing procedure or session. In some approaches, the network entity 420 may output (e.g., transmit), or a wireless device 410 may obtain (e.g., receive) an indication that the wireless device 410 has been selected for the sensing procedure or session. The wireless device 410 may operate in accordance with the selection (e.g., may receive or measure the signal 445 or may output measurement information 435 to the network entity 420 in response to the indication).

Some examples of the techniques described herein may establish or utilize one or more limits on background channel interference with a target channel. The background channel may be difficult to measure directly in some scenarios. For instance, one or more of the techniques described herein may be utilized as a proxy to identify or determine potentially useful UE-UE bistatic links. In some approaches, node (e.g., wireless device 410, target object 440, network entity 420, or any combination thereof) configuration may be utilized for bistatic RF sensing.

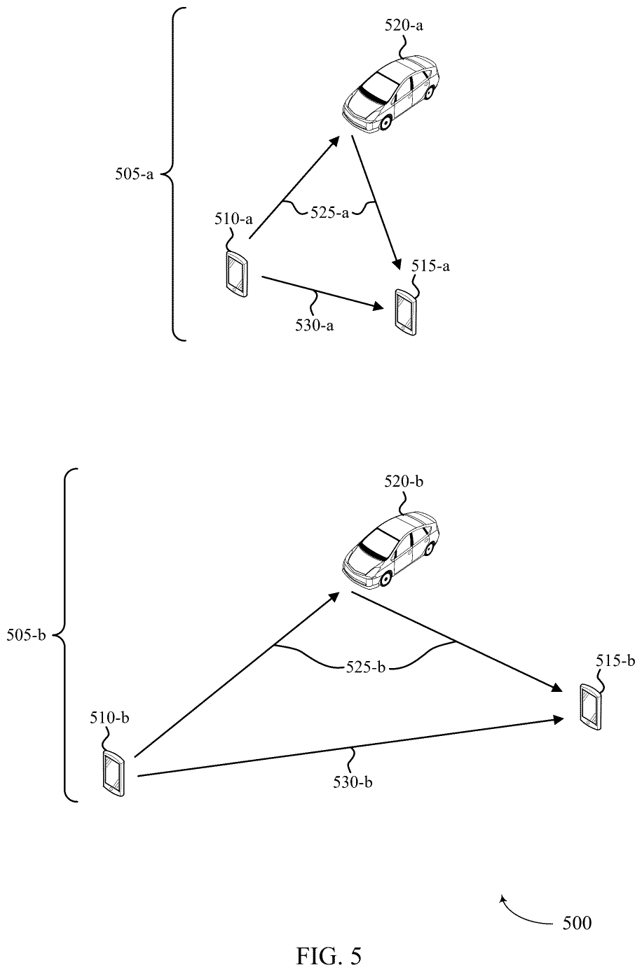

FIG. 5 shows examples of wireless communications systems 500 that support activation conditions for sensing procedures in accordance with one or more aspects of the present disclosure. A first scenario 505-a and a second scenario 505-b are illustrated in FIG. 5. The first scenario includes a first UE 510-a, a target object 520-a (e.g., a sensing target or a vehicle) and a second UE 515-a. The first UE 510-a may be an example of a transmission node as described with reference to FIG. 4. The second UE 515-a may be an example of a reception node as described with reference to FIG. 4.

The first scenario 505-a illustrates an example of a challenge in UE-UE bistatic sensing. As illustrated in the first scenario, a signal 530-a is propagating via the background channel from the first UE 510-a to the second UE 515-a. A signal 525-a (e.g., a signal for sensing or a signal of interest) is propagating to the target object 520-a, and reflecting from the target object 520-a to the second UE 515-a. In this scenario, the signal 530-a propagating via the background channel may be significantly stronger than the signal 525-a reflecting from the target object 520-a. Due to the relatively strong signal 530-a via the background channel, the measurements of the signal 525-a reflected from the target object 520-a may be masked or cluttered, or may not provide useful information for sensing the target object 520-a.

In accordance with some of the techniques described herein, the second UE 515-a (e.g., reception node) may determine that a relative distance between the first UE 510-a and the second UE 515-a does not satisfy a threshold for an activation condition, may determine that a signal strength or power of the signal 530-a does not satisfy a threshold for an activation condition, or may determine that a bistatic angle between the first UE 510-a and the second UE 515-a does not satisfy a threshold for an activation condition. Accordingly, the second UE 515-a may avoid participating in a sensing procedure or session, which may conserve resources to avoid communicating measurement information with relatively little or no information for sensing the target object 520-a.

The second scenario includes a first UE 510-b, a target object 520-b (e.g., a sensing target or a vehicle) and a second UE 515-b. The first UE 510-b may be an example of a transmission node as described with reference to FIG. 4. The second UE 515-b may be an example of a reception node as described with reference to FIG. 4.

The second scenario 505-b illustrates an example of UE-UE bistatic sensing. As illustrated in the second scenario, a signal 530-b is propagating via the background channel from the first UE 510-b to the second UE 515-b. A signal 525-b (e.g., a signal for sensing or a signal of interest) is propagating to the target object 520-b, and reflecting from the target object 520-b to the second UE 515-b. In this scenario, the signal 530-b propagating via the background channel may be similar in strength or less strong than the signal 525-b reflecting from the target object 520-b. Due to the relatively weaker signal 530-b via the background channel, the measurements of the signal 525-b reflected from the target object 520-b may provide useful information for sensing the target object 520-b. For UE-UE bistatic situations, for instance, scenarios similar to the second scenario 505-b may enable or enhance sensing performance relative to scenarios similar to the first scenario 505-a.

In accordance with some of the techniques described herein, the second UE 515-b (e.g., reception node) may determine that a relative distance between the first UE 510-b and the second UE 515-b satisfies a threshold for an activation condition, may determine that a signal strength or power of the signal 530-b satisfies a threshold for an activation condition, or may determine that a bistatic angle between the first UE 510-b and the second UE 515-b satisfies a threshold for an activation condition. Accordingly, the second UE 515-b may participate in a sensing procedure or session, which may provide measurement information with information for sensing the target object 520-b.

FIG. 6 shows examples of wireless communications systems 600 that support activation conditions for sensing procedures in accordance with one or more aspects of the present disclosure. A first scenario 605-a and a second scenario 605-b are illustrated in FIG. 6. The first scenario includes a first UE 610-a, a target object 620-a (e.g., a sensing target or a vehicle) and a second UE 615-a. The first UE 610-a may be an example of a transmission node as described with reference to FIG. 4. The second UE 615-a may be an example of a reception node as described with reference to FIG. 4.

The first scenario 605-a illustrates an example of a bistatic angle 630. As illustrated in the first scenario, a signal 625-a (e.g., a signal for sensing or a signal of interest) is propagating to the target object 620-a, and reflecting from the target object 620-a to the second UE 615-a. In accordance with the description herein, the bistatic angle 630 may be an angle between a first ray 635-a that is between the first UE 610-a and the target object 620-a, and a second ray 635-b that is between the second UE 615-a and the target object 620-a. In bistatic sensing, for instance, the directions of the transmitted signal 625-a and the received signal 625-a may be different. In some cases, a radar cross section may be based on the directions of the transmitted signal 625-a and the received signal 625-a. Different regions may exist based on the radar cross section. A forward scattering region may occur with a bistatic angle 630 greater than 140 degrees. A bistatic region may occur with a bistatic angle 630 less than 140 degrees and greater than a small angle (e.g., an angle between 0 and 5 degrees or another angle). A backscattering region may occur with a bistatic angle 630 near 0 degrees (e.g., an angle less than 5 degrees or another angle).

In accordance with some of the techniques described herein, the second UE 615-a (e.g., reception node) may determine whether the bistatic angle 630 satisfies or does not satisfy a threshold for an activation condition. Accordingly, the second UE 615-a may avoid participating in a sensing procedure or session with a bistatic angle 630 that does not satisfy a threshold (e.g., is not within a range), or may participate in a sensing procedure or session with a bistatic angle 630 that satisfies a threshold (e.g., that is within a range). The bistatic angle 630 may be utilized to obtain measurements from the signal 625-a in cases when the signal 625-a may contain useful information for sensing.

The second scenario includes a first UE 610-b, a target object 620-b (e.g., a sensing target or a vehicle) and a second UE 615-b. The first UE 610-b may be an example of a transmission node as described with reference to FIG. 4. The second UE 615-b may be an example of a reception node as described with reference to FIG. 4.

The second scenario 605-b illustrates an example of a relative elevation 645 between the first UE 610-b and the second UE 615-b. As illustrated in the second scenario, a signal 625-b (e.g., a signal for sensing or a signal of interest) is propagating to the target object 620-b, and reflecting from the target object 620-b to the second UE 615-b at different elevations. In accordance with the description herein, the relative elevation 645 may be difference between a first elevation 640-a of the first UE 610-b and a second elevation 640-b of the second UE 615-b.

In accordance with some of the techniques described herein, the second UE 615-b (e.g., reception node) may determine whether the relative elevation 645 satisfies or does not satisfy a threshold for an activation condition. Accordingly, the second UE 615-b may avoid participating in a sensing procedure or session with a relative elevation 645 that does not satisfy a threshold (e.g., is not within a range), or may participate in a sensing procedure or session with a relative elevation 645 that satisfies a threshold (e.g., that is within a range). The relative elevation 645 may be utilized to obtain measurements from the signal 625-b in cases when the signal 625-b may contain useful information for sensing.

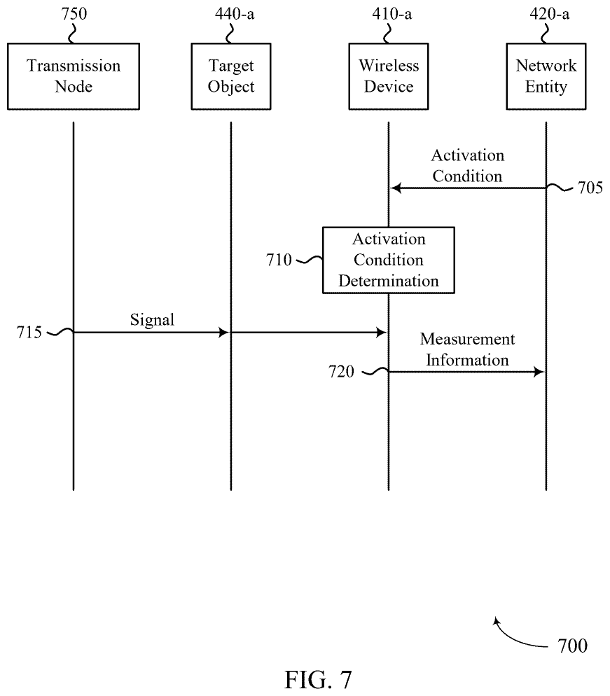

FIG. 7 shows an example of a process flow 700 that supports activation conditions for sensing procedures in accordance with one or more aspects of the present disclosure. The process flow 700 may include a transmission node 750, which may be an example of a UE 115, UE 115-a, UE 115-b, network node 105, gNB 255, CU 160-a, DU 165-a, RU 170-a, CU 160-b, DU 165-b, RU 170-b, TRP, PRU, or the wireless device 410, as described herein, among other examples. The process flow 700 may include a target object 440-a, which may be an example of the target object 440, among other examples. The process flow 700 may also include a wireless device 410-a, which may be an example of a UE 115, UE 115-a, UE 115-b, network node 105, gNB 255, CU 160-a, DU 165-a, RU 170-a, CU 160-b, DU 165-b, RU 170-b, TRP, PRU, or the wireless device 410, as described herein, among other examples. The process flow 700 may additionally include a network entity 420-a, which may be an example of a network entity, location or sensing server 185, LMF 265, external device 230, SLP 235, NWDAF, OTT server, OAM entity, SnMF, gNB 255, CU 160-a, DU 165-a, RU 170-a, CU 160-b, DU 165-b, RU 170-b, TRP, PRU, or network entity 420 as described herein, among other examples. In some approaches, network entity 420-a may communicate with the wireless device 410-a via one or more network nodes (e.g., base station(s), TRP(s), CU(s), DU(s), or RU(s), among other examples).

In the following description of the process flow 700, the communications between the wireless device 410-a, the network entity 420-a, the transmission node 750, or the target object 440-a may be transmitted in the same order or in a different order than the example order shown, or the operations performed by the wireless device 410-a, the network entity 420-a, the transmission node 750, or the target object 440-a may be performed in different orders or at different times. One or more operations may be omitted from the process flow 700, or one or more other operations may be added to the process flow 700. Although some operations or signaling may be shown to occur at different times for discussion purposes, these operations may actually occur at the same time or in overlapping time periods in some examples.

In some examples, the wireless device 410-a and the network entity 420-a may communicate information (e.g., capability information, configuration information, measurement information, indication(s), metric(s), parameter(s), activation condition information, or request(s), among other examples) via a network node or independent of a network node. In some examples, the wireless device 410-a and a network node may communicate information (e.g., capability information, configuration information, measurement information, indication(s), metric(s), parameter(s), activation condition information, or request(s), among other examples), where the information may be relayed transparently via the network node, may be processed by the network node before communication to the network entity 420-a or the wireless device 410-a, or may not be transmitted to the network entity 420-a or the wireless device 410-a.

At 705, the network entity 420-a may output (e.g., transmit), or the wireless device 410-a may obtain (e.g., receive), an indication of an activation condition (e.g., sensing activation conditions). For instance, the indication of the activation condition may be communicated to the wireless device 410-a as described with reference to FIG. 4. In some examples, the indication of the activation condition may include assistance data, such as a target object 440-a prior (e.g., probability of position) or a location of the transmission node 750.

At 710, the wireless device 410-a may perform an activation condition determination. For instance, the wireless device 410-a may determine (e.g., evaluate) whether one or more activation conditions are satisfied as described with reference to FIG. 4. In some examples, the network entity 420-a may output (e.g., transmit), or the wireless device 410-a may obtain (e.g., receive), configuration information before or after the activation condition is determined. The configuration information (e.g., sensing configuration) may include an indication of reference signal resources or sensing measurement types for measurement or reporting.

At 715, the transmission node 750 may output (e.g., transmit), or the wireless device 410-a may obtain (e.g., receive), a signal that is reflected via the target object 440-a. For instance, the signal may be communicated as described with reference to FIG. 4. The signal may be received or measured by the wireless device 410-a based on the satisfaction of the activation condition. The wireless device 410-a may be a reception node (e.g., sensing node). For instance, the wireless device 410-a may monitor for one or more reference signals (e.g., sensing reference signals) and may derive one or more measurements from the reference signal(s). The monitoring or measurement may be conditioned on the activation condition determination.

At 720, the wireless device 410-a may output (e.g., transmit), or the network entity 420-a may obtain (e.g., receive), measurement information. For instance, the measurement information may be communicated to the network entity 420-a as described with reference to FIG. 4. In some aspects, the wireless device 410-a may output (e.g., transmit) a sensing report, which may include an indication of one or more measurements.

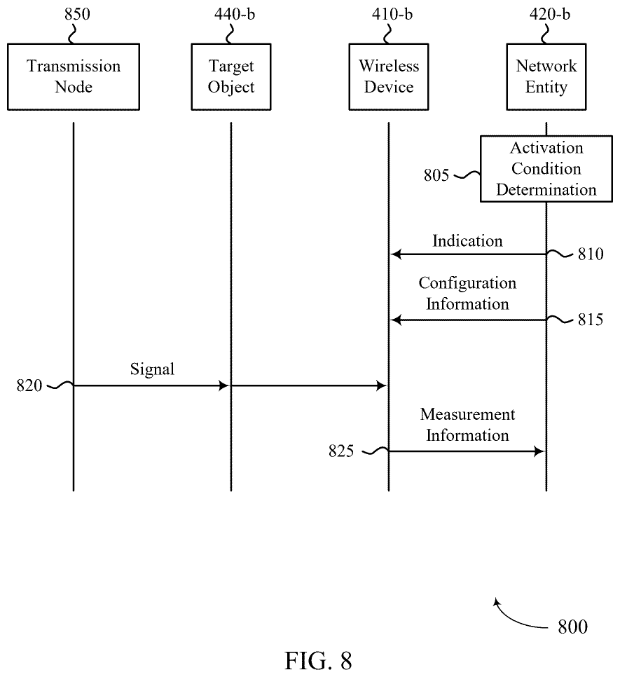

FIG. 8 shows an example of a process flow 800 that supports activation conditions for sensing procedures in accordance with one or more aspects of the present disclosure. The process flow 800 may include a transmission node 850, which may be an example of a UE 115, UE 115-a, UE 115-b, network node 105, gNB 255, CU 160-a, DU 165-a, RU 170-a, CU 160-b, DU 165-b, RU 170-b, TRP, PRU, or the wireless device 410, as described herein, among other examples. The process flow 800 may include a target object 440-b, which may be an example of the target object 440, among other examples. The process flow 800 may also include a wireless device 410-b, which may be an example of a UE 115, UE 115-a, UE 115-b, network node 105, gNB 255, CU 160-a, DU 165-a, RU 170-a, CU 160-b, DU 165-b, RU 170-b, TRP, PRU, or the wireless device 410, as described herein, among other examples. The process flow 800 may additionally include a network entity 420-b, which may be an example of a network entity, location or sensing server 185, LMF 265, external device 230, SLP 235, NWDAF, OTT server, OAM entity, SnMF, gNB 255, CU 160-a, DU 165-a, RU 170-a, CU 160-b, DU 165-b, RU 170-b, TRP, PRU, or network entity 420 as described herein, among other examples. In some approaches, network entity 420-b may communicate with the wireless device 410-b via one or more network nodes (e.g., base station(s), TRP(s), CU(s), DU(s), or RU(s), among other examples).

In the following description of the process flow 800, the communications between the wireless device 410-b, the network entity 420-b, the transmission node 850, or the target object 440-b may be transmitted in the same order or in a different order than the example order shown, or the operations performed by the wireless device 410-b, the network entity 420-b, the transmission node 850, or the target object 440-b may be performed in different orders or at different times. One or more operations may be omitted from the process flow 800, or one or more other operations may be added to the process flow 800. Although some operations or signaling may be shown to occur at different times for discussion purposes, these operations may actually occur at the same time or in overlapping time periods in some examples.

In some examples, the wireless device 410-b and the network entity 420-b may communicate information (e.g., capability information, configuration information, measurement information, indication(s), metric(s), parameter(s), activation condition information, or request(s), among other examples) via a network node or independent of a network node. In some examples, the wireless device 410-b and a network node may communicate information (e.g., capability information, configuration information, measurement information, indication(s), metric(s), parameter(s), activation condition information, or request(s), among other examples), where the information may be relayed transparently via the network node, may be processed by the network node before communication to the network entity 420-b or the wireless device 410-b, or may not be transmitted to the network entity 420-b or the wireless device 410-b.

At 805, the network entity 420-b may perform an activation condition determination. For instance, the network entity 420-b may determine whether an activation condition is satisfied as described with reference to FIG. 4.

At 810, the network entity 420-b may output (e.g., transmit), or the wireless device 410-b may obtain (e.g., receive), an indication that the wireless device 410-b is selected to participate in a sensing procedure or session. For instance, the indication of the selection may be communicated to the wireless device 410-b as described with reference to FIG. 4.

At 815, the network entity 420-b may output (e.g., transmit), or the wireless device 410-b may obtain (e.g., receive), configuration information. For instance, the configuration information may be communicated to the wireless device 410-b as described with reference to FIG. 4. The configuration information may indicate one or more resources for the communication of a signal (e.g., sensing signal from the transmission node 850).

At 820, the transmission node 850 may output (e.g., transmit), or the wireless device 410-b may obtain (e.g., receive), a signal that is reflected via the target object 440-b. For instance, the signal may be communicated as described with reference to FIG. 4. The signal may be received or measured by the wireless device 410-b based on the satisfaction of the activation condition.

At 825, the wireless device 410-b may output (e.g., transmit), or the network entity 420-b may obtain (e.g., receive), measurement information. For instance, the measurement information may be communicated to the network entity 420-b as described with reference to FIG. 4.

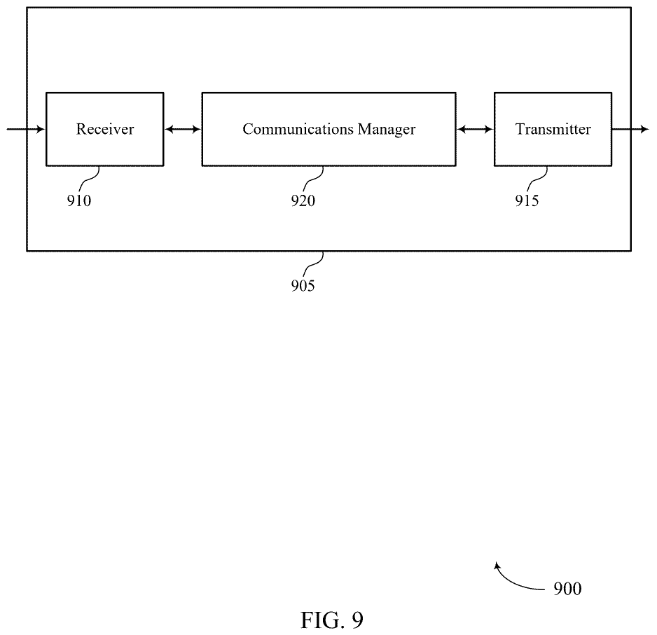

FIG. 9 shows a block diagram 900 of a device 905 that supports activation conditions for sensing procedures in accordance with one or more aspects of the present disclosure. The device 905 may be an example of aspects of a wireless device as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to activation conditions for sensing procedures). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to activation conditions for sensing procedures). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of activation conditions for sensing procedures as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

For example, the communications manager 920 is capable of, configured to, or operable to support a means for obtaining, from a network entity, an indication of an activation condition to participate in a sensing procedure for a target object, where the activation condition is based on a location of a transmission node or a reception node for the sensing procedure, or is based on a signal characteristic for the sensing procedure. The communications manager 920 is capable of, configured to, or operable to support a means for receiving, based on a satisfaction of the activation condition, a signal reflected from the target object. The communications manager 920 is capable of, configured to, or operable to support a means for transmitting, to the network entity, measurement information indicative of one or more measurements of the signal reflected from the target object.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, or more efficient utilization of communication resources.

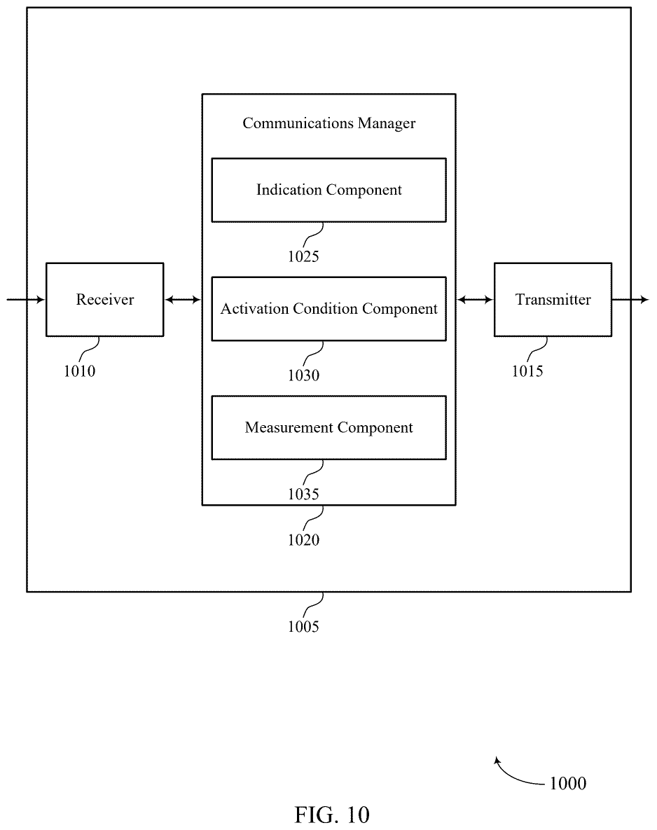

FIG. 10 shows a block diagram 1000 of a device 1005 that supports activation conditions for sensing procedures in accordance with one or more aspects of the present disclosure. The device 1005 may be an example of aspects of a device 905 or a wireless device as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to activation conditions for sensing procedures). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to activation conditions for sensing procedures). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of activation conditions for sensing procedures as described herein. For example, the communications manager 1020 may include an indication component 1025, an activation condition component 1030, a measurement component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The indication component 1025 is capable of, configured to, or operable to support a means for obtaining, from a network entity, an indication of an activation condition to participate in a sensing procedure for a target object, where the activation condition is based on a location of a transmission node or a reception node for the sensing procedure, or is based on a signal characteristic for the sensing procedure. The activation condition component 1030 is capable of, configured to, or operable to support a means for receiving, based on a satisfaction of the activation condition, a signal reflected from the target object. The measurement component 1035 is capable of, configured to, or operable to support a means for transmitting, to the network entity, measurement information indicative of one or more measurements of the signal reflected from the target object.

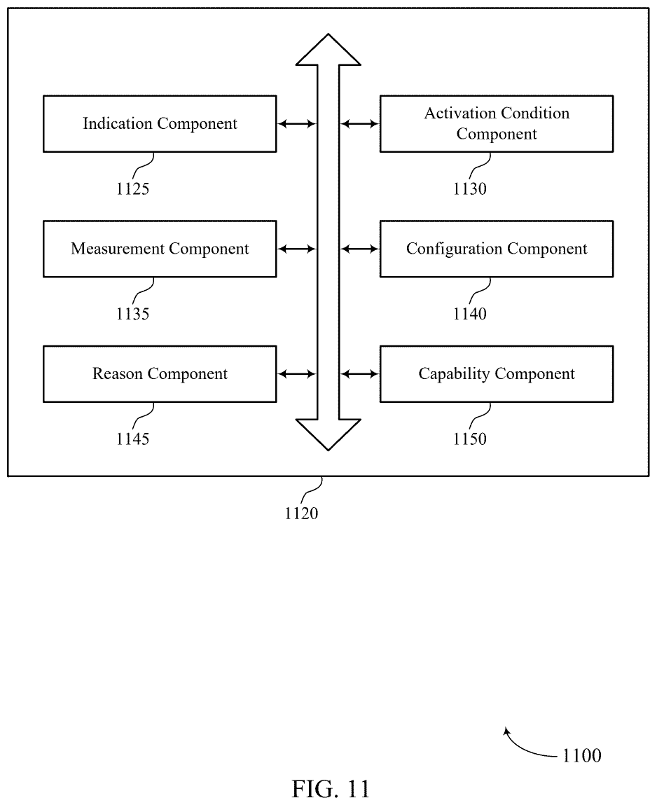

FIG. 11 shows a block diagram 1100 of a communications manager 1120 that supports activation conditions for sensing procedures in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of activation conditions for sensing procedures as described herein. For example, the communications manager 1120 may include an indication component 1125, an activation condition component 1130, a measurement component 1135, a configuration component 1140, a reason component 1145, a capability component 1150, or any combination thereof. Each of these components, or components or subcomponents thereof (e.g., one or more processors, one or more memories), may communicate, directly or indirectly, with one another (e.g., via one or more buses).

The indication component 1125 is capable of, configured to, or operable to support a means for obtaining, from a network entity, an indication of an activation condition to participate in a sensing procedure for a target object, where the activation condition is based on a location of a transmission node or a reception node for the sensing procedure, or is based on a signal characteristic for the sensing procedure. The activation condition component 1130 is capable of, configured to, or operable to support a means for receiving, based on a satisfaction of the activation condition, a signal reflected from the target object. The measurement component 1135 is capable of, configured to, or operable to support a means for transmitting, to the network entity, measurement information indicative of one or more measurements of the signal reflected from the target object.

In some examples, the configuration component 1140 is capable of, configured to, or operable to support a means for obtaining, from the network entity, configuration information that is indicative of a resource for communication of the signal, that is indicative of a type of the one or more measurements, or a combination thereof.

In some examples, the configuration information is obtained previous to the satisfaction of the activation condition, or is obtained in response to a transmission indicative of the satisfaction of the activation condition to the network entity.

In some examples, the activation condition is based on whether a relative distance between the transmission node and the reception node satisfies a threshold.

In some examples, the sensing procedure includes bistatic sensing, the bistatic sensing limited to a tracking operation for the target object.

In some examples, the activation condition is based on whether a relative distance between the transmission node and the reception node satisfies a threshold. In some examples, the threshold is based on a first distance between the transmission node and the target object, or a second distance between the reception node and the target object.

In some examples, the indication component 1125 is capable of, configured to, or operable to support a means for obtaining, from the network entity, an indication of the location of the transmission node, an indication of a location of the target object, or a combination thereof.

In some examples, the activation condition is based on whether a relative distance satisfies a threshold. In some examples, the relative distance is between the transmission node and the target object, or is between the reception node and the target object.

In some examples, the activation condition is based on whether an angle satisfies a threshold. In some examples, the angle is between a first ray that is between the transmission node and the target object, and a second ray that is between the reception node and the target object.

In some examples, the activation condition is based on whether an elevation satisfies a threshold. In some examples, the elevation is a relative elevation between the transmission node and the reception node, or is an absolute elevation of the transmission node or of the reception node.

In some examples, the activation condition is based on whether a threshold is satisfied by a power or a strength of signaling via a background channel between the transmission node and the reception node.

In some examples, the activation condition is based on whether a projected power of the signal reflected from the target object satisfies a condition, the projected power being based on a radar cross section of the target object.

In some examples, the activation condition includes a set of conditions. In some examples, the activation condition is based on whether at least a subset of the set of conditions is satisfied.

In some examples, the reason component 1145 is capable of, configured to, or operable to support a means for transmitting, to the network entity, an indication of a reason for which the wireless device does not participate in a sensing session.

In some examples, the capability component 1150 is capable of, configured to, or operable to support a means for transmitting, to the network entity, capability information indicating a capability of the wireless device to utilize the activation condition, where the indication of the activation condition is obtained based on the capability information.

In some examples, the indication of the activation condition is signaled via a sensing request message, via assistance data, via unicast signaling, or via broadcast signaling.

In some examples, the activation condition component 1130 is capable of, configured to, or operable to support a means for transmitting, to the network entity, an indicator of the satisfaction of the activation condition. In some examples, the activation condition component 1130 is capable of, configured to, or operable to support a means for obtaining, from the network entity, activation information indicative of an activation of the sensing procedure based on the satisfaction of the activation condition.

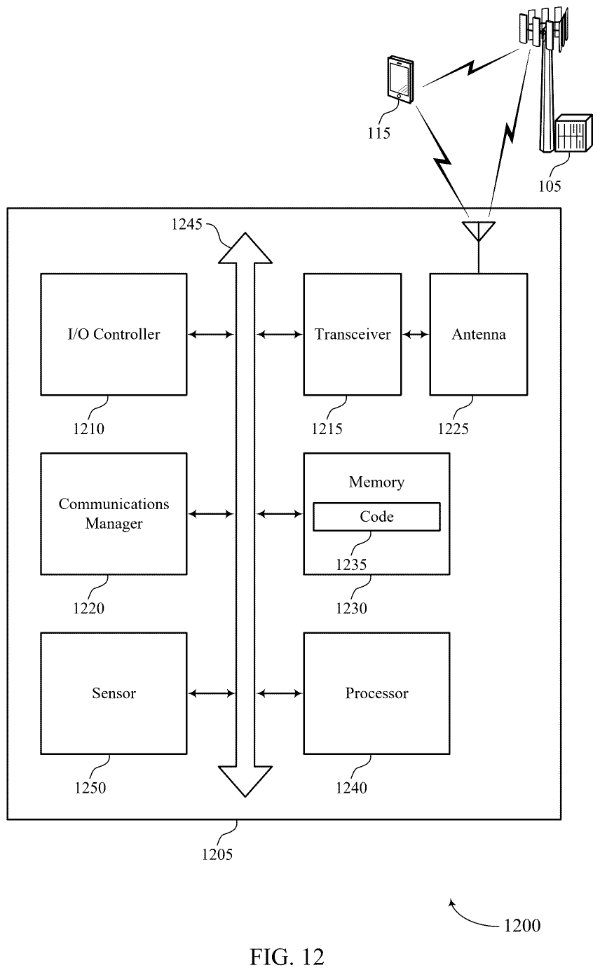

FIG. 12 shows a diagram of a system 1200 including a device 1205 that supports activation conditions for sensing procedures in accordance with one or more aspects of the present disclosure. The device 1205 may be an example of or include components of a device 905, a device 1005, or a wireless device 410 as described herein. The device 1205 may include components for bi-directional voice and data communications including components for transmitting and receiving communications, such as a communications manager 1220, an I/O controller, such as an I/O controller 1210, one or more transceivers 1215, one or more antennas 1225, at least one memory 1230, code 1235, and at least one processor 1240. The device 1205 may include one or more sensors 1250. These components may be in electronic communication or otherwise coupled (e.g., operatively, communicatively, functionally, electronically, electrically) via one or more buses (e.g., a bus 1245). The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver(s) 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The one or more transceivers 1215 may include one or more wireless wide area network (WWAN) transceivers, one or more short-range wireless transceivers, or one or more satellite transceivers. The WWAN transceiver(s) may communicate with (e.g., transmit one or more signals to, or receive one or more signals from) one or more wireless communication networks, such as an NR network, an LTE network, or a GSM network, among other examples. The WWAN transceiver(s) may be connected to one or more of the antenna(s) 1225 for communicating with other devices, such as one or more UEs 115, network nodes 105, access points, base stations (e.g., eNBs, gNBs), or another device(s), via at least one RAT (e.g., NR, LTE, or GSM, among other examples) over a wireless communication medium (e.g., time or frequency resources of a frequency spectrum). The WWAN transceiver(s) may be configured for transmitting and encoding signals (e.g., messages, indications, or information, among other examples) or for receiving and decoding signals (e.g., messages, indications, information, or pilots, among other examples), in accordance with the RAT. For instance, the WWAN transceiver(s) may include one or more transmitters for transmitting and encoding signals, or one or more receivers for receiving and decoding signals.

The short-range wireless transceivers may be connected to one or more of the antenna(s) 1225 to communicate with (e.g., transmit one or more signals to, or receive one or more signals from) one or more network entities, such as one or more UEs 115, network nodes 105, access points, base stations, or another device(s), via at least one RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), or ultra-wideband (UWB), among other examples) over a wireless communication medium. The short-range wireless transceiver(s) may be configured for transmitting and encoding signals (e.g., messages, indications, or information, among other examples), or for receiving and decoding signals (e.g., messages, indications, information, or pilots, among other examples), in accordance with the RAT. For instance, the short-range wireless transceiver(s) may include one or more transmitters for transmitting and encoding signals, or one or more receivers for receiving and decoding signals. In some examples, the short-range wireless transceiver(s) may be one or more Wi-Fi transceivers, BLUETOOTH® transceivers, ZIGBEE® transceivers, Z-WAVE® transceivers, NFC transceivers, UWB transceivers, vehicle-to-vehicle (V2V) transceivers, or vehicle-to-everything (V2X) transceivers, among other examples.

The satellite transceiver(s) may include one or more satellite signal receivers, or one or more satellite signal transmitters. In some cases, the device 1205 may be a terrestrial device that may communicate one or more satellites via the satellite transceiver(s). In other cases, device 1205 may be a satellite (or other non-terrestrial entity) that uses the satellite transceiver(s) to communicate with one or more terrestrial networks or other satellites.

The satellite signal receiver(s) may be connected to one or more of the antenna(s) 1225 for receiving or measuring satellite positioning or communication signals. In some examples, the satellite signal receiver(s) may include one or more satellite positioning system receivers, where the satellite positioning or communication signals may be GPS signals, GLONASS signals, Galileo signals, BeiDou signals, Indian Regional Navigation Satellite System (NAVIC), or Quasi-Zenith Satellite System (QZSS) signals, among other examples. In some examples, the satellite signal receiver(s) may include one or more NTN receivers, where the satellite positioning or communication signals may be communication signals (e.g., carrying control or user data) originating from a device or network. The satellite signal receiver(s) may include hardware or a combination of hardware and instructions for receiving and processing satellite positioning or communication signals. The satellite signal receiver(s) or the processor 1240 may perform calculations to determine a location of the device 1205, the UE 115, the network node 105, or another device using measurements obtained from one or more satellite signals.

The one or more satellite signal transmitters may be connected to one or more of the antennas 1225 for transmitting satellite positioning communication signals. In some examples, the satellite signal transmitter(s) may be satellite positioning system transmitters, and the satellite positioning or communication signals may be GPS signals, GLONASS® signals, Galileo signals, BeiDou signals, NAVIC, or QZSS signals, among other examples. In some examples, the satellite signal transmitter(s) include one or more NTN transmitters, and the satellite positioning or communication signals may be communication signals (e.g., carrying control or user data). The satellite signal transmitter(s) may comprise hardware or a combination of hardware and instructions for transmitting satellite positioning or communication signals.

The device 1205 may include one or more sensors 1250 coupled with the one or more processors 1240 for obtaining sensor data (e.g., image data, RF data, motion data, orientation data, or audio data, among other examples). For example, the one or more sensors 1250 may sense or detect movement or orientation information. In some aspects, the movement or orientation information may be independent from motion data derived from signals received by the one or more WWAN transceivers, the one or more short-range wireless transceivers, or the satellite signal interface. In some examples, the sensor(s) 1250 may include an accelerometer (e.g., a micro-electrical mechanical systems (MEMS) device), a gyroscope, a geomagnetic sensor (e.g., a compass), an altimeter (e.g., a barometric pressure altimeter), or any other type of movement detection sensor. Additionally, or alternatively, the one or more sensors 1250 may include an image sensor, camera, microphone, light detector, or pressure sensor, among other examples. In some aspects, the sensor(s) 1250 may include a plurality of different types of devices, and the device 1205 (e.g., sensor(s) or 1250 processor(s) 1240) may combine the outputs of the different types of devices to provide motion information. For example, the sensor(s) 1250 may use a combination of a multi-axis accelerometer sensors, orientation sensors, or image sensors to provide the ability to compute positions in two-dimensional (2D) or three-dimensional (3D) coordinate systems.

The at least one memory 1230 may include RAM and ROM. The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a BIOS which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting activation conditions for sensing procedures). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

For example, the communications manager 1220 is capable of, configured to, or operable to support a means for obtaining, from a network entity, an indication of an activation condition to participate in a sensing procedure for a target object, where the activation condition is based on a location of a transmission node or a reception node for the sensing procedure, or is based on a signal characteristic for the sensing procedure. The communications manager 1220 is capable of, configured to, or operable to support a means for receiving, based on a satisfaction of the activation condition, a signal reflected from the target object. The communications manager 1220 is capable of, configured to, or operable to support a means for transmitting, to the network entity, measurement information indicative of one or more measurements of the signal reflected from the target object.

By including or configuring the communications manager 1220 in accordance with examples as described herein, the device 1205 may support techniques for enhanced positioning accuracy, improved communication reliability, reduced latency, reduced power consumption, more efficient utilization of communication resources, improved coordination between devices, longer battery life, or improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of activation conditions for sensing procedures as described herein, or the at least one processor 1240 and the at least one memory 1230 may be otherwise configured to, individually or collectively, perform or support such operations.

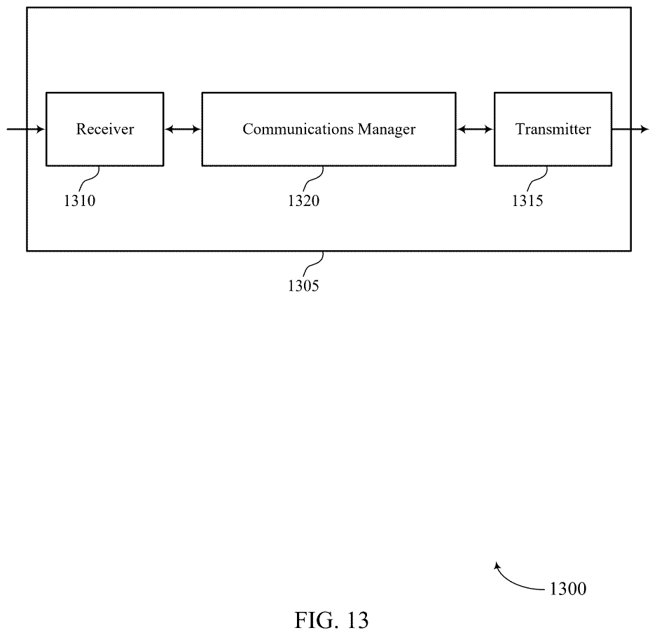

FIG. 13 shows a block diagram 1300 of a device 1305 that supports activation conditions for sensing procedures in accordance with one or more aspects of the present disclosure. The device 1305 may be an example of aspects of a network entity as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of activation conditions for sensing procedures as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

For example, the communications manager 1320 is capable of, configured to, or operable to support a means for transmitting, to a wireless device, an indication of an activation condition to participate in a sensing procedure for a target object, where the activation condition is based on a location of a transmission node or a reception node for the sensing procedure, or is based on a signal characteristic for the sensing procedure. The communications manager 1320 is capable of, configured to, or operable to support a means for obtaining, from the wireless device, measurement information indicative of one or more measurements of a signal reflected from the target object.

For example, the communications manager 1320 is capable of, configured to, or operable to support a means for determining whether an activation condition is satisfied for a wireless device to participate in a sensing procedure for a target object, where the activation condition is based on a location of a transmission node or a reception node for the sensing procedure, or is based on a signal characteristic for the sensing procedure. The communications manager 1320 is capable of, configured to, or operable to support a means for transmitting, to the wireless device, an indication that the wireless device is selected to participate in the sensing procedure based on a satisfaction of the activation condition for the wireless device.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for reduced processing, reduced power consumption, or more efficient utilization of communication resources.

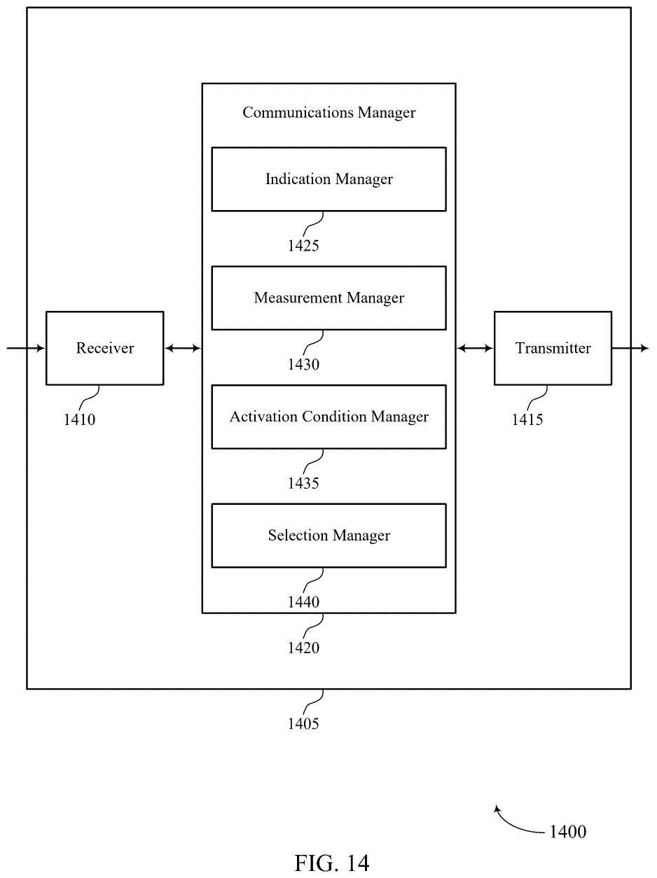

FIG. 14 shows a block diagram 1400 of a device 1405 that supports activation conditions for sensing procedures in accordance with one or more aspects of the present disclosure. The device 1405 may be an example of aspects of a device 1305 or a network entity as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of activation conditions for sensing procedures as described herein. For example, the communications manager 1420 may include an indication manager 1425, a measurement manager 1430, an activation condition manager 1435, a selection manager 1440, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The indication manager 1425 is capable of, configured to, or operable to support a means for transmitting, to a wireless device, an indication of an activation condition to participate in a sensing procedure for a target object, where the activation condition is based on a location of a transmission node or a reception node for the sensing procedure, or is based on a signal characteristic for the sensing procedure. The measurement manager 1430 is capable of, configured to, or operable to support a means for obtaining, from the wireless device, measurement information indicative of one or more measurements of a signal reflected from the target object.

The activation condition manager 1435 is capable of, configured to, or operable to support a means for determining whether an activation condition is satisfied for a wireless device to participate in a sensing procedure for a target object, where the activation condition is based on a location of a transmission node or a reception node for the sensing procedure, or is based on a signal characteristic for the sensing procedure. The selection manager 1440 is capable of, configured to, or operable to support a means for transmitting, to the wireless device, an indication that the wireless device is selected to participate in the sensing procedure based on a satisfaction of the activation condition for the wireless device.

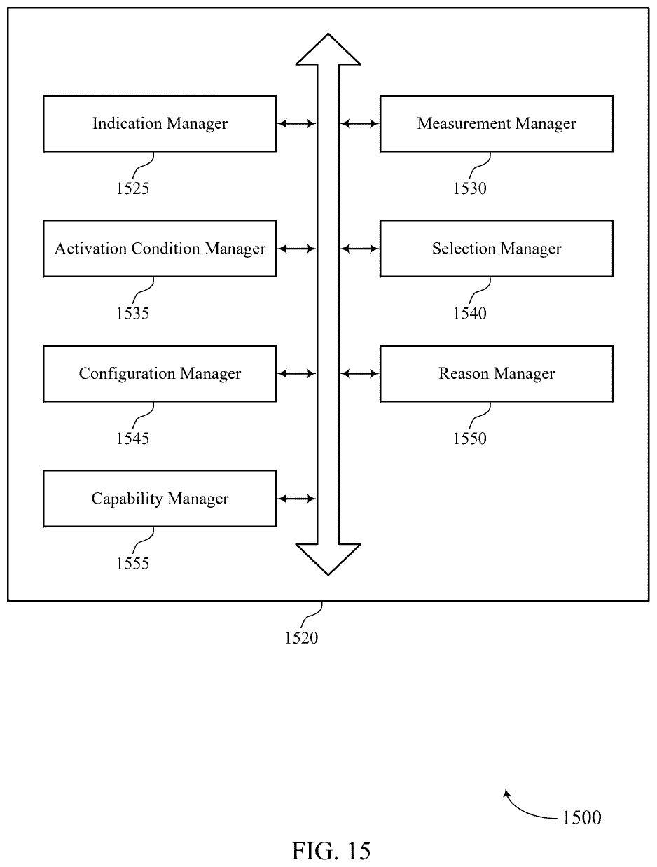

FIG. 15 shows a block diagram 1500 of a communications manager 1520 that supports activation conditions for sensing procedures in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of activation conditions for sensing procedures as described herein. For example, the communications manager 1520 may include an indication manager 1525, a measurement manager 1530, an activation condition manager 1535, a selection manager 1540, a configuration manager 1545, a reason manager 1550, a capability manager 1555, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity, between devices, components, or virtualized components associated with a network entity), or any combination thereof.

The indication manager 1525 is capable of, configured to, or operable to support a means for transmitting, to a wireless device, an indication of an activation condition to participate in a sensing procedure for a target object, where the activation condition is based on a location of a transmission node or a reception node for the sensing procedure, or is based on a signal characteristic for the sensing procedure. The measurement manager 1530 is capable of, configured to, or operable to support a means for obtaining, from the wireless device, measurement information indicative of one or more measurements of a signal reflected from the target object.

In some examples, the configuration manager 1545 is capable of, configured to, or operable to support a means for transmitting, to the wireless device, configuration information that is indicative of a resource for communication of the signal, that is indicative of a type of the one or more measurements, or a combination thereof.

In some examples, the configuration information is transmitted previous to a satisfaction of the activation condition, or is transmitted in response to a transmission indicative of a satisfaction of the activation condition from the wireless device.

In some examples, the activation condition is based on whether a relative distance between the transmission node and the reception node satisfies a threshold.

In some examples, the sensing procedure includes bistatic sensing, the bistatic sensing limited to a tracking operation for the target object.

In some examples, the activation condition is based on whether a relative distance between the transmission node and the reception node satisfies a threshold. In some examples, the threshold is based on a first distance between the transmission node and the target object, or a second distance between the reception node and the target object.

In some examples, the indication manager 1525 is capable of, configured to, or operable to support a means for transmitting, to the wireless device, an indication of the location of the transmission node, an indication of a location of the target object, or a combination thereof.

In some examples, the activation condition is based on whether a relative distance satisfies a threshold. In some examples, the relative distance is between the transmission node and the target object, or is between the reception node and the target object.

In some examples, the activation condition is based on whether an angle satisfies a threshold. In some examples, the angle is between a first ray that is between the transmission node and the target object, and a second ray that is between the reception node and the target object.

In some examples, the activation condition is based on whether an elevation satisfies a threshold. In some examples, the elevation is a relative elevation between the transmission node and the reception node, or is an absolute elevation of the transmission node or of the reception node.

In some examples, the activation condition is based on whether a threshold is satisfied by a power or a strength of signaling via a background channel between the transmission node and the reception node.

In some examples, the activation condition is based on whether a projected power of the signal reflected from the target object satisfies a condition, the projected power being based on a radar cross section of the target object.

In some examples, the activation condition includes a set of conditions. In some examples, the activation condition is based on whether at least a subset of the set of conditions is satisfied.

In some examples, the reason manager 1550 is capable of, configured to, or operable to support a means for obtaining, from the wireless device, an indication of a reason for which the wireless device does not participate in a sensing session.

In some examples, the capability manager 1555 is capable of, configured to, or operable to support a means for obtaining, from the wireless device, capability information indicating a capability of the wireless device to utilize the activation condition, where the indication of the activation condition is transmitted based on the capability information.

In some examples, the indication of the activation condition is signaled via a sensing request message, via assistance data, via unicast signaling, or via broadcast signaling.

In some examples, the activation condition manager 1535 is capable of, configured to, or operable to support a means for obtaining, from the wireless device, an indicator of a satisfaction of the activation condition. In some examples, the activation condition manager 1535 is capable of, configured to, or operable to support a means for transmitting, to the wireless device, activation information indicative of an activation of the sensing procedure based on the satisfaction of the activation condition.

The activation condition manager 1535 is capable of, configured to, or operable to support a means for determining whether an activation condition is satisfied for a wireless device to participate in a sensing procedure for a target object, where the activation condition is based on a location of a transmission node or a reception node for the sensing procedure, or is based on a signal characteristic for the sensing procedure. The selection manager 1540 is capable of, configured to, or operable to support a means for transmitting, to the wireless device, an indication that the wireless device is selected to participate in the sensing procedure based on a satisfaction of the activation condition for the wireless device.

In some examples, the configuration manager 1545 is capable of, configured to, or operable to support a means for transmitting, to the wireless device, configuration information that is indicative of a resource for communication of a signal reflected from the target object to the reception node, that is indicative of a type of one or more measurements for the sensing procedure, or a combination thereof.

In some examples, the activation condition is based on whether a relative distance between the transmission node and the reception node satisfies a threshold.

In some examples, the activation condition is based on whether a relative distance between the transmission node and the reception node satisfies a threshold. In some examples, the threshold is based on a first distance between the transmission node and the target object, or a second distance between the reception node and the target object.

In some examples, the activation condition is based on whether a relative distance satisfies a threshold. In some examples, the relative distance is between the transmission node and the target object, or is between the reception node and the target object.

In some examples, the activation condition is based on whether an angle satisfies a threshold. In some examples, the angle is between a first ray that is between the transmission node and the target object, and a second ray that is between the reception node and the target object.

In some examples, the activation condition is based on whether an elevation satisfies a threshold. In some examples, the elevation is a relative elevation between the transmission node and the reception node, or is an absolute elevation of the transmission node or of the reception node.

In some examples, the activation condition is based on whether a threshold is satisfied by a power or a strength of signaling via a background channel between the transmission node and the reception node.

In some examples, the activation condition is based on whether a projected power of a signal reflected from the target object satisfies a condition, the projected power being based on a radar cross section of the target object.

In some examples, the activation condition includes a set of conditions. In some examples, the activation condition is based on whether at least a subset of the set of conditions is satisfied.

In some examples, the reason manager 1550 is capable of, configured to, or operable to support a means for obtaining, from the wireless device, an indication of a reason for which the wireless device does not participate in a sensing session.

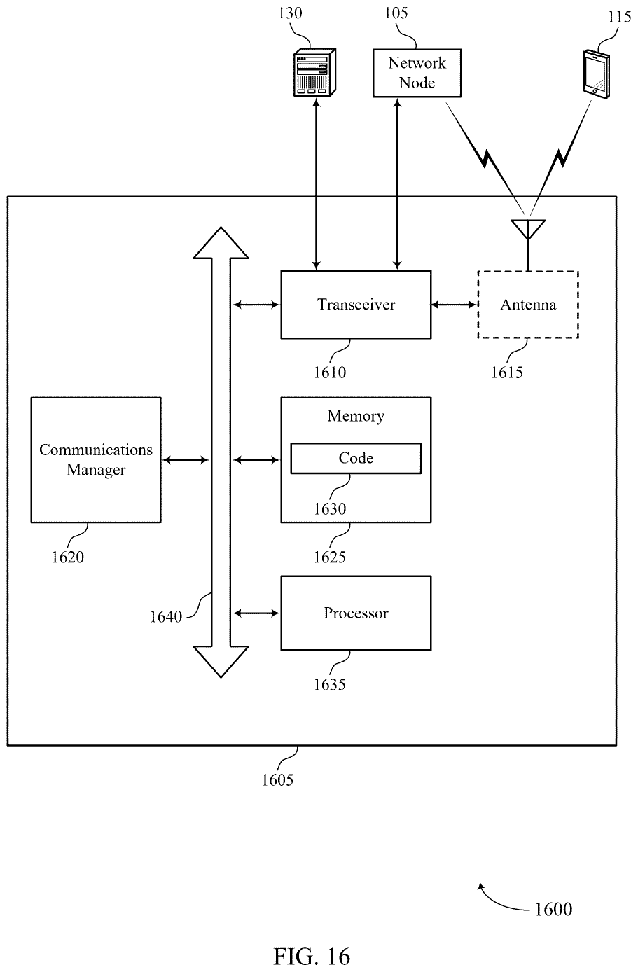

FIG. 16 shows a diagram of a system 1600 including a device 1605 that supports activation conditions for sensing procedures in accordance with one or more aspects of the present disclosure. The device 1605 may be an example of or include components of a device 1305, a device 1405, or network entity 420 as described herein. The device 1605 may include components for bi-directional voice and data communications including components for transmitting and receiving communications, such as a communications manager 1620, one or more transceivers 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The one or more transceivers 1610 may include one or more WWAN transceivers, one or more short-range wireless transceivers, or one or more satellite transceivers. The WWAN transceiver(s) may communicate with (e.g., transmit one or more signals to, or receive one or more signals from) one or more wireless devices, such as the network node 105 or the UE 115, among other examples. The WWAN transceiver(s) may be connected to one or more of the antenna(s) 1615 for communicating with other devices, such as one or more UEs 115, network nodes 105, access points, base stations (e.g., eNBs, gNBs), or another device(s), via at least one RAT (e.g., NR, LTE, or GSM, among other examples) over a wireless communication medium (e.g., time or frequency resources of a frequency spectrum). The WWAN transceiver(s) may be configured for transmitting and encoding signals (e.g., messages, indications, or information, among other examples) or for receiving and decoding signals (e.g., messages, indications, information, or pilots, among other examples), in accordance with the RAT. For instance, the WWAN transceiver(s) may include one or more transmitters for transmitting and encoding signals, or one or more receivers for receiving and decoding signals.

The short-range wireless transceivers may be connected to one or more of the antenna(s) 1615 to communicate with (e.g., transmit one or more signals to, or receive one or more signals from) one or more network entities, such as one or more UEs 115, network nodes 105, access points, base stations, or another device(s), via at least one RAT (e.g., Wi-Fi, LTE Direct, BLUETOOTH®, ZIGBEE®, Z-WAVE®, PC5, DSRC, WAVE, NFC, or UWB, among other examples) over a wireless communication medium. The short-range wireless transceiver(s) may be configured for transmitting and encoding signals (e.g., messages, indications, or information, among other examples), or for receiving and decoding signals (e.g., messages, indications, information, or pilots, among other examples), in accordance with the RAT. For instance, the short-range wireless transceiver(s) may include one or more transmitters for transmitting and encoding signals, or one or more receivers for receiving and decoding signals. In some examples, the short-range wireless transceiver(s) may be one or more Wi-Fi transceivers, BLUETOOTH® transceivers, ZIGBEE® transceivers, Z-WAVE® transceivers, NFC transceivers, UWB transceivers, V2V transceivers, or V2X transceivers, among other examples.

The satellite transceiver(s) may include one or more satellite signal receivers, or one or more satellite signal transmitters. In some cases, the device 1605 may be a terrestrial device that may communicate one or more satellites via the satellite transceiver(s). In other cases, device 1605 may be a satellite (or other non-terrestrial entity) that uses the satellite transceiver(s) to communicate with one or more terrestrial networks or other satellites.

The satellite signal receiver(s) may be connected to one or more of the antenna(s) 1615 for receiving or measuring satellite positioning or communication signals. In some examples, the satellite signal receiver(s) may include one or more satellite positioning system receivers, where the satellite positioning or communication signals may be GPS signals, GLONASS signals, Galileo signals, BeiDou signals, NAVIC, or QZSS signals, among other examples. In some examples, the satellite signal receiver(s) may include one or more NTN receivers, where the satellite positioning or communication signals may be communication signals (e.g., carrying control or user data) originating from a device or network. The satellite signal receiver(s) may include hardware or a combination of hardware and instructions for receiving and processing satellite positioning or communication signals. The satellite signal receiver(s) or the processor 1635 may perform calculations to determine a location of the device 1605, the UE 115, the network node 105, or another device using measurements obtained from one or more satellite signals.

The one or more satellite signal transmitters may be connected to one or more of the antennas 1615 for transmitting satellite positioning communication signals. In some examples, the satellite signal transmitter(s) may be satellite positioning system transmitters, and the satellite positioning or communication signals may be GPS signals, GLONASS® signals, Galileo signals, BeiDou signals, NAVIC, or QZSS signals, among other examples. In some examples, the satellite signal transmitter(s) include one or more NTN transmitters, and the satellite positioning or communication signals may be communication signals (e.g., carrying control or user data). The satellite signal transmitter(s) may comprise hardware or a combination of hardware and instructions for transmitting satellite positioning or communication signals.

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting activation conditions for sensing procedures). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network nodes 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network nodes 105.

For example, the communications manager 1620 is capable of, configured to, or operable to support a means for transmitting, to a wireless device, an indication of an activation condition to participate in a sensing procedure for a target object, where the activation condition is based on a location of a transmission node or a reception node for the sensing procedure, or is based on a signal characteristic for the sensing procedure. The communications manager 1620 is capable of, configured to, or operable to support a means for obtaining, from the wireless device, measurement information indicative of one or more measurements of a signal reflected from the target object.

For example, the communications manager 1620 is capable of, configured to, or operable to support a means for determining whether an activation condition is satisfied for a wireless device to participate in a sensing procedure for a target object, where the activation condition is based on a location of a transmission node or a reception node for the sensing procedure, or is based on a signal characteristic for the sensing procedure. The communications manager 1620 is capable of, configured to, or operable to support a means for transmitting, to the wireless device, an indication that the wireless device is selected to participate in the sensing procedure based on a satisfaction of the activation condition for the wireless device.

By including or configuring the communications manager 1620 in accordance with examples as described herein, the device 1605 may support techniques for increased positioning accuracy, improved communication reliability, reduced latency, improved user experience related to reduced processing, reduced power consumption, more efficient utilization of communication resources, improved coordination between devices, longer battery life, improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of activation conditions for sensing procedures as described herein, or the at least one processor 1635 and the at least one memory 1625 may be otherwise configured to, individually or collectively, perform or support such operations.

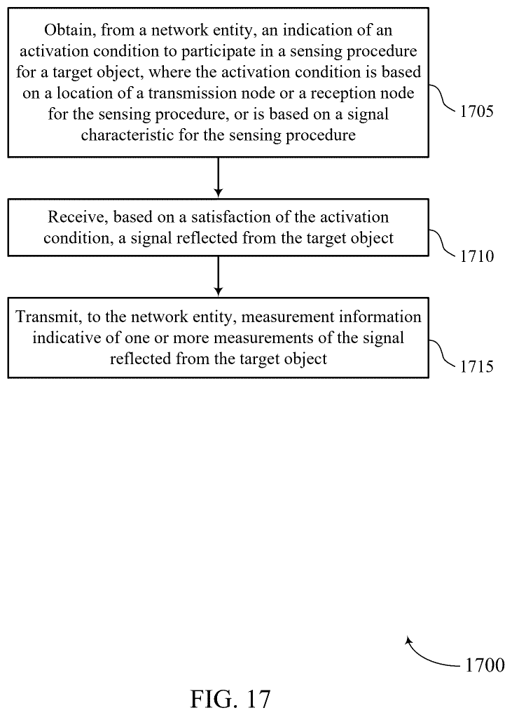

FIG. 17 shows a flowchart illustrating a method 1700 that supports activation conditions for sensing procedures in accordance with one or more aspects of the present disclosure. The operations of the method 1700 may be implemented by a wireless device or its components as described herein. For example, the operations of the method 1700 may be performed by a wireless device as described with reference to FIGS. 1 through 12. In some examples, a wireless device may execute a set of instructions to control the functional elements of the wireless device to perform the described functions. Additionally, or alternatively, the wireless device may perform aspects of the described functions using special-purpose hardware.

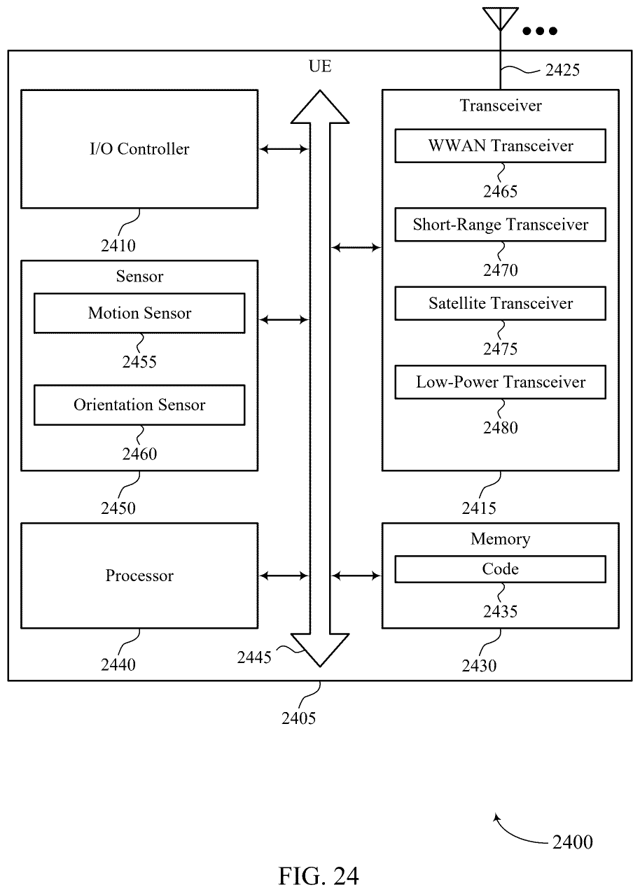

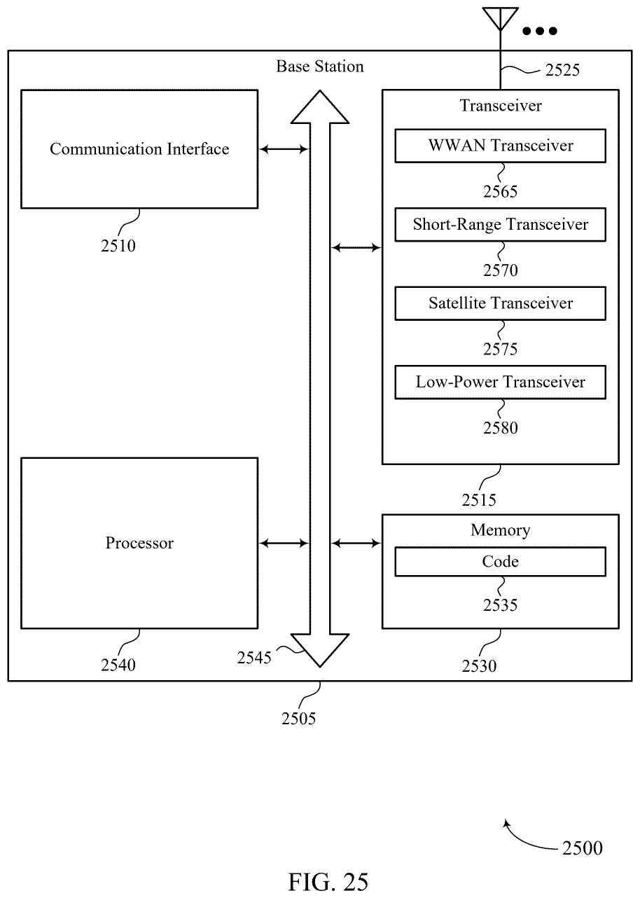

At 1705, the method may include obtaining, from a network entity, an indication of an activation condition to participate in a sensing procedure for a target object, where the activation condition is based on a location of a transmission node or a reception node for the sensing procedure, or is based on a signal characteristic for the sensing procedure. The operations of 1705 may be performed in accordance with examples as disclosed herein. In some examples, aspects of the operations of 1705 may be performed by an indication component 1125 as described with reference to FIG. 11. In some examples, one or more means for obtaining (e.g., receiving) the indication of the activation condition may include a transceiver 1215, an antenna 1225, a processor 1240, or a memory 1230 (e.g., code 1235) as described with reference to FIG. 12, a transceiver 2415 (e.g., a WWAN transceiver 2465, a short-range transceiver 2470, or a satellite transceiver 2475), a processor 2440, or a memory 2430 (e.g., code 2435) as described with reference to FIG. 24, or a transceiver 2515 (e.g., a WWAN transceiver 2565, a short-range transceiver 2570, or a satellite transceiver 2575), a processor 2540, or a memory 2530 (e.g., code 2535) as described with reference to FIG. 25.

At 1710, the method may include receiving, based on a satisfaction of the activation condition, a signal reflected from the target object. The operations of 1710 may be performed in accordance with examples as disclosed herein. In some examples, aspects of the operations of 1710 may be performed by an activation condition component 1130 as described with reference to FIG. 11. In some examples, one or more means for receiving the signal may include a transceiver 1215, an antenna 1225, a processor 1240, or a memory 1230 (e.g., code 1235) as described with reference to FIG. 12, a transceiver 2415 (e.g., a WWAN transceiver 2465, a short-range transceiver 2470, or a satellite transceiver 2475), a processor 2440, or a memory 2430 (e.g., code 2435) as described with reference to FIG. 24, or a transceiver 2515 (e.g., a WWAN transceiver 2565, a short-range transceiver 2570, or a satellite transceiver 2575), a processor 2540, or a memory 2530 (e.g., code 2535) as described with reference to FIG. 25.

At 1715, the method may include transmitting, to the network entity, measurement information indicative of one or more measurements of the signal reflected from the target object. The operations of 1715 may be performed in accordance with examples as disclosed herein. In some examples, aspects of the operations of 1715 may be performed by a measurement component 1135 as described with reference to FIG. 11. In some examples, one or more means for transmitting the measurement information may include a transceiver 1215, an antenna 1225, a processor 1240, or a memory 1230 (e.g., code 1235) as described with reference to FIG. 12, a transceiver 2415 (e.g., a WWAN transceiver 2465, a short-range transceiver 2470, or a satellite transceiver 2475), a processor 2440, or a memory 2430 (e.g., code 2435) as described with reference to FIG. 24, or a transceiver 2515 (e.g., a WWAN transceiver 2565, a short-range transceiver 2570, or a satellite transceiver 2575), a processor 2540, or a memory 2530 (e.g., code 2535) as described with reference to FIG. 25.

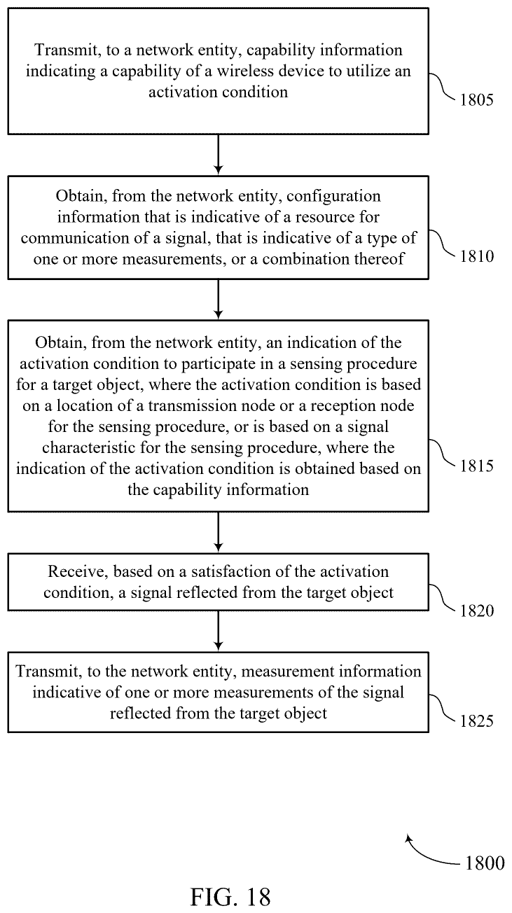

FIG. 18 shows a flowchart illustrating a method 1800 that supports activation conditions for sensing procedures in accordance with one or more aspects of the present disclosure. The operations of the method 1800 may be implemented by a wireless device or its components as described herein. For example, the operations of the method 1800 may be performed by a wireless device as described with reference to FIGS. 1 through 12. In some examples, a wireless device may execute a set of instructions to control the functional elements of the wireless device to perform the described functions. Additionally, or alternatively, the wireless device may perform aspects of the described functions using special-purpose hardware.

At 1805, the method may include transmitting, to a network entity, capability information indicating a capability of the wireless device to utilize the activation condition, where the indication of the activation condition is obtained based on the capability information. The operations of 1805 may be performed in accordance with examples as disclosed herein. In some examples, aspects of the operations of 1805 may be performed by a capability component 1150 as described with reference to FIG. 11. In some examples, one or more means for transmitting capability information may include a transceiver 1215, an antenna 1225, a processor 1240, or a memory 1230 (e.g., code 1235) as described with reference to FIG. 12, a transceiver 2415 (e.g., a WWAN transceiver 2465, a short-range transceiver 2470, or a satellite transceiver 2475), a processor 2440, or a memory 2430 (e.g., code 2435) as described with reference to FIG. 24, or a transceiver 2515 (e.g., a WWAN transceiver 2565, a short-range transceiver 2570, or a satellite transceiver 2575), a processor 2540, or a memory 2530 (e.g., code 2535) as described with reference to FIG. 25.

At 1810, the method may include obtaining, from the network entity, configuration information that is indicative of a resource for communication of the signal, that is indicative of a type of the one or more measurements, or a combination thereof. The operations of 1810 may be performed in accordance with examples as disclosed herein. In some examples, aspects of the operations of 1810 may be performed by a configuration component 1140 as described with reference to FIG. 11. In some examples, one or more means for obtaining (e.g., receiving) the configuration information may include a transceiver 1215, an antenna 1225, a processor 1240, or a memory 1230 (e.g., code 1235) as described with reference to FIG. 12, a transceiver 2415 (e.g., a WWAN transceiver 2465, a short-range transceiver 2470, or a satellite transceiver 2475), a processor 2440, or a memory 2430 (e.g., code 2435) as described with reference to FIG. 24, or a transceiver 2515 (e.g., a WWAN transceiver 2565, a short-range transceiver 2570, or a satellite transceiver 2575), a processor 2540, or a memory 2530 (e.g., code 2535) as described with reference to FIG. 25.

At 1815, the method may include obtaining, from a network entity, an indication of an activation condition to participate in a sensing procedure for a target object, where the activation condition is based on a location of a transmission node or a reception node for the sensing procedure, or is based on a signal characteristic for the sensing procedure. The operations of 1815 may be performed in accordance with examples as disclosed herein. In some examples, aspects of the operations of 1815 may be performed by an indication component 1125 as described with reference to FIG. 11. In some examples, one or more means for obtaining (e.g., receiving) the indication of the activation condition may include a transceiver 1215, an antenna 1225, a processor 1240, or a memory 1230 (e.g., code 1235) as described with reference to FIG. 12, a transceiver 2415 (e.g., a WWAN transceiver 2465, a short-range transceiver 2470, or a satellite transceiver 2475), a processor 2440, or a memory 2430 (e.g., code 2435) as described with reference to FIG. 24, or a transceiver 2515 (e.g., a WWAN transceiver 2565, a short-range transceiver 2570, or a satellite transceiver 2575), a processor 2540, or a memory 2530 (e.g., code 2535) as described with reference to FIG. 25.

At 1820, the method may include receiving, based on a satisfaction of the activation condition, a signal reflected from the target object. The operations of 1820 may be performed in accordance with examples as disclosed herein. In some examples, aspects of the operations of 1820 may be performed by an activation condition component 1130 as described with reference to FIG. 11. In some examples, one or more means for receiving the signal may include a transceiver 1215, an antenna 1225, a processor 1240, or a memory 1230 (e.g., code 1235) as described with reference to FIG. 12, a transceiver 2415 (e.g., a WWAN transceiver 2465, a short-range transceiver 2470, or a satellite transceiver 2475), a processor 2440, or a memory 2430 (e.g., code 2435) as described with reference to FIG. 24, or a transceiver 2515 (e.g., a WWAN transceiver 2565, a short-range transceiver 2570, or a satellite transceiver 2575), a processor 2540, or a memory 2530 (e.g., code 2535) as described with reference to FIG. 25.

At 1825, the method may include transmitting, to the network entity, measurement information indicative of one or more measurements of the signal reflected from the target object. The operations of 1825 may be performed in accordance with examples as disclosed herein. In some examples, aspects of the operations of 1825 may be performed by a measurement component 1135 as described with reference to FIG. 11. In some examples, one or more means for transmitting the measurement information may include a transceiver 1215, an antenna 1225, a processor 1240, or a memory 1230 (e.g., code 1235) as described with reference to FIG. 12, a transceiver 2415 (e.g., a WWAN transceiver 2465, a short-range transceiver 2470, or a satellite transceiver 2475), a processor 2440, or a memory 2430 (e.g., code 2435) as described with reference to FIG. 24, or a transceiver 2515 (e.g., a WWAN transceiver 2565, a short-range transceiver 2570, or a satellite transceiver 2575), a processor 2540, or a memory 2530 (e.g., code 2535) as described with reference to FIG. 25.

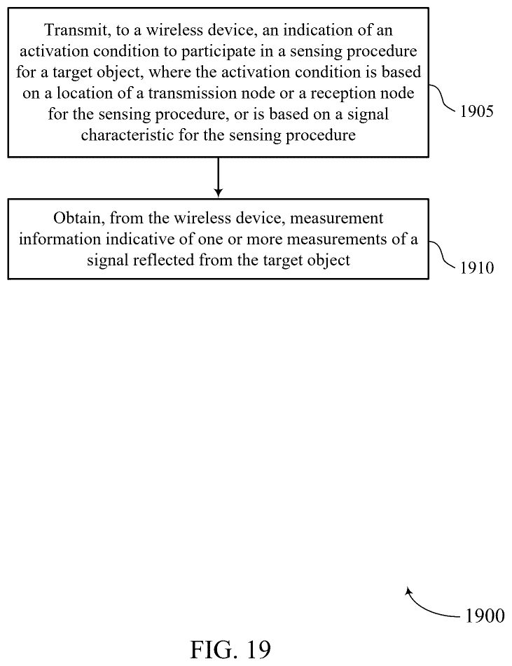

FIG. 19 shows a flowchart illustrating a method 1900 that supports activation conditions for sensing procedures in accordance with one or more aspects of the present disclosure. The operations of the method 1900 may be implemented by a network entity or its components as described herein. For example, the operations of the method 1900 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

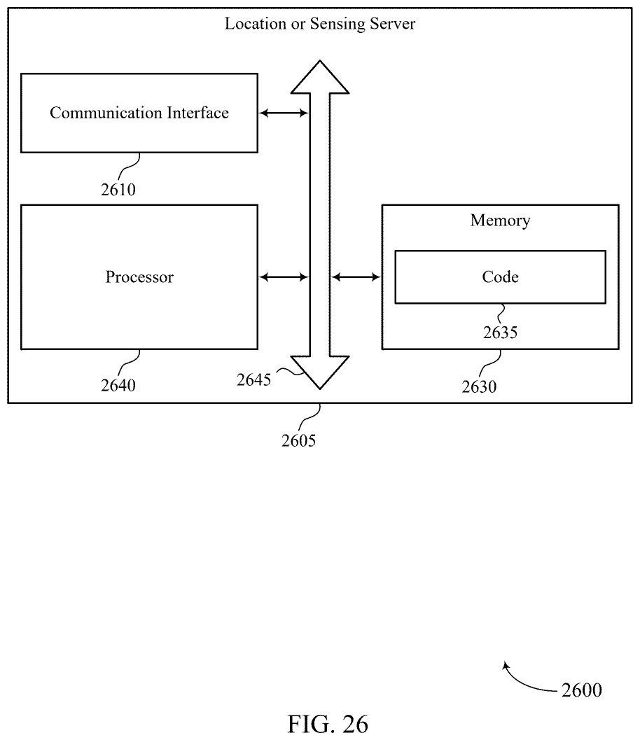

At 1905, the method may include transmitting, to a wireless device, an indication of an activation condition to participate in a sensing procedure for a target object, where the activation condition is based on a location of a transmission node or a reception node for the sensing procedure, or is based on a signal characteristic for the sensing procedure. The operations of 1905 may be performed in accordance with examples as disclosed herein. In some examples, aspects of the operations of 1905 may be performed by an indication manager 1525 as described with reference to FIG. 15. In some examples, one or more means for transmitting the indication may include a transceiver 1610, an antenna 1615, a processor 1635, or memory 1625 (e.g., code 1630) as described with reference to FIG. 16, may include a transceiver 2515 (e.g., a WWAN transceiver 2565, a short-range transceiver 2570, a satellite transceiver 2575, a low-power transceiver 2580), a processor 2540, or a memory 2530 (e.g., code 2535) as described with reference to FIG. 25, or may include a communication interface 2610, a processor 2640, or memory 2630 (e.g., code 2635) as described with reference to FIG. 26.

At 1910, the method may include obtaining, from the wireless device, measurement information indicative of one or more measurements of a signal reflected from the target object. The operations of 1910 may be performed in accordance with examples as disclosed herein. In some examples, aspects of the operations of 1910 may be performed by a measurement manager 1530 as described with reference to FIG. 15. In some examples, one or more means for obtaining the measurement information may include a transceiver 1610, an antenna 1615, a processor 1635, or memory 1625 (e.g., code 1630) as described with reference to FIG. 16, may include a transceiver 2515 (e.g., a WWAN transceiver 2565, a short-range transceiver 2570, a satellite transceiver 2575, a low-power transceiver 2580), a processor 2540, or a memory 2530 (e.g., code 2535) as described with reference to FIG. 25, or may include a communication interface 2610, a processor 2640, or memory 2630 (e.g., code 2635) as described with reference to FIG. 26.

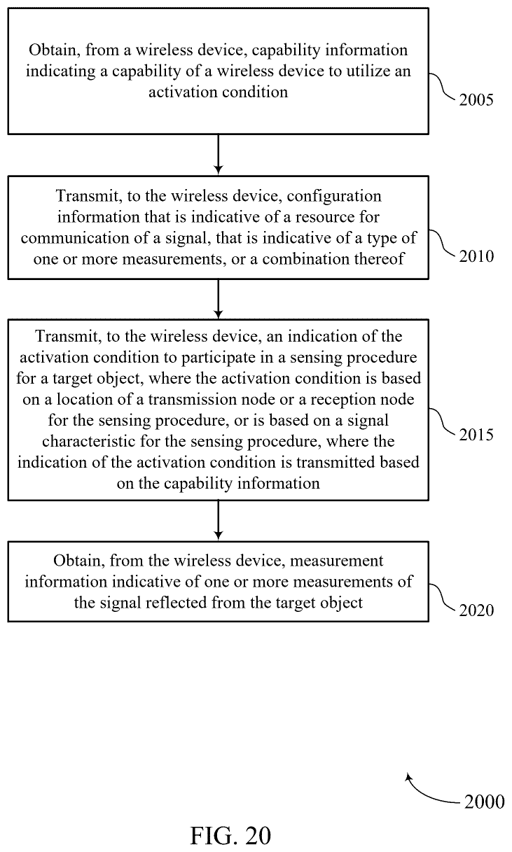

FIG. 20 shows a flowchart illustrating a method 2000 that supports activation conditions for sensing procedures in accordance with one or more aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include obtaining, from the wireless device, capability information indicating a capability of the wireless device to utilize an activation condition. The operations of 2005 may be performed in accordance with examples as disclosed herein. In some examples, aspects of the operations of 2005 may be performed by a capability manager 1555 as described with reference to FIG. 15. In some examples, one or more means for obtaining the capability information may include a transceiver 1610, an antenna 1615, a processor 1635, or memory 1625 (e.g., code 1630) as described with reference to FIG. 16, may include a transceiver 2515 (e.g., a WWAN transceiver 2565, a short-range transceiver 2570, a satellite transceiver 2575, a low-power transceiver 2580), a processor 2540, or a memory 2530 (e.g., code 2535) as described with reference to FIG. 25, or may include a communication interface 2610, a processor 2640, or memory 2630 (e.g., code 2635) as described with reference to FIG. 26.

At 2010, the method may include transmitting, to the wireless device, configuration information that is indicative of a resource for communication of a signal, that is indicative of a type of one or more measurements, or a combination thereof. The operations of 2010 may be performed in accordance with examples as disclosed herein. In some examples, aspects of the operations of 2010 may be performed by a configuration manager 1545 as described with reference to FIG. 15. In some examples, one or more means for transmitting the configuration information may include a transceiver 1610, an antenna 1615, a processor 1635, or memory 1625 (e.g., code 1630) as described with reference to FIG. 16, may include a transceiver 2515 (e.g., a WWAN transceiver 2565, a short-range transceiver 2570, a satellite transceiver 2575, a low-power transceiver 2580), a processor 2540, or a memory 2530 (e.g., code 2535) as described with reference to FIG. 25, or may include a communication interface 2610, a processor 2640, or memory 2630 (e.g., code 2635) as described with reference to FIG. 26.

At 2015, the method may include transmitting, to the wireless device, an indication of the activation condition to participate in a sensing procedure for a target object, where the activation condition is based on a location of a transmission node or a reception node for the sensing procedure, or is based on a signal characteristic for the sensing procedure, where the indication of the activation condition is transmitted based on the capability information. The operations of 2015 may be performed in accordance with examples as disclosed herein. In some examples, aspects of the operations of 2015 may be performed by an indication manager 1525 as described with reference to FIG. 15. In some examples, one or more means for transmitting the indication may include a transceiver 1610, an antenna 1615, a processor 1635, or memory 1625 (e.g., code 1630) as described with reference to FIG. 16, may include a transceiver 2515 (e.g., a WWAN transceiver 2565, a short-range transceiver 2570, a satellite transceiver 2575, a low-power transceiver 2580), a processor 2540, or a memory 2530 (e.g., code 2535) as described with reference to FIG. 25, or may include a communication interface 2610, a processor 2640, or memory 2630 (e.g., code 2635) as described with reference to FIG. 26.

At 2020, the method may include obtaining, from the wireless device, measurement information indicative of one or more measurements of the signal reflected from the target object. The operations of 2020 may be performed in accordance with examples as disclosed herein. In some examples, aspects of the operations of 2020 may be performed by a measurement manager 1530 as described with reference to FIG. 15. In some examples, one or more means for obtaining the measurement information may include a transceiver 1610, an antenna 1615, a processor 1635, or memory 1625 (e.g., code 1630) as described with reference to FIG. 16, may include a transceiver 2515 (e.g., a WWAN transceiver 2565, a short-range transceiver 2570, a satellite transceiver 2575, a low-power transceiver 2580), a processor 2540, or a memory 2530 (e.g., code 2535) as described with reference to FIG. 25, or may include a communication interface 2610, a processor 2640, or memory 2630 (e.g., code 2635) as described with reference to FIG. 26.

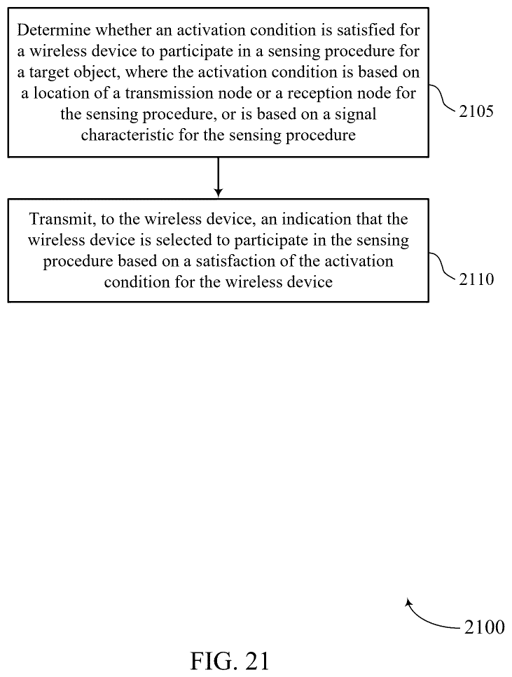

FIG. 21 shows a flowchart illustrating a method 2100 that supports activation conditions for sensing procedures in accordance with one or more aspects of the present disclosure. The operations of the method 2100 may be implemented by a network entity or its components as described herein. For example, the operations of the method 2100 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2105, the method may include determining whether an activation condition is satisfied for a wireless device to participate in a sensing procedure for a target object, where the activation condition is based on a location of a transmission node or a reception node for the sensing procedure, or is based on a signal characteristic for the sensing procedure. The operations of 2105 may be performed in accordance with examples as disclosed herein. In some examples, aspects of the operations of 2105 may be performed by an activation condition manager 1535 as described with reference to FIG. 15. In some examples, one or more means for determining whether an activation condition is satisfied may include a transceiver 1610, an antenna 1615, a processor 1635, or memory 1625 (e.g., code 1630) as described with reference to FIG. 16, may include a transceiver 2515 (e.g., a WWAN transceiver 2565, a short-range transceiver 2570, a satellite transceiver 2575, a low-power transceiver 2580), a processor 2540, or a memory 2530 (e.g., code 2535) as described with reference to FIG. 25, or may include a communication interface 2610, a processor 2640, or memory 2630 (e.g., code 2635) as described with reference to FIG. 26.

At 2110, the method may include transmitting, to the wireless device, an indication that the wireless device is selected to participate in the sensing procedure based on a satisfaction of the activation condition for the wireless device. The operations of 2110 may be performed in accordance with examples as disclosed herein. In some examples, aspects of the operations of 2110 may be performed by a selection manager 1540 as described with reference to FIG. 15. In some examples, one or more means for transmitting the indication may include a transceiver 1610, an antenna 1615, a processor 1635, or memory 1625 (e.g., code 1630) as described with reference to FIG. 16, may include a transceiver 2515 (e.g., a WWAN transceiver 2565, a short-range transceiver 2570, a satellite transceiver 2575, a low-power transceiver 2580), a processor 2540, or a memory 2530 (e.g., code 2535) as described with reference to FIG. 25, or may include a communication interface 2610, a processor 2640, or memory 2630 (e.g., code 2635) as described with reference to FIG. 26.

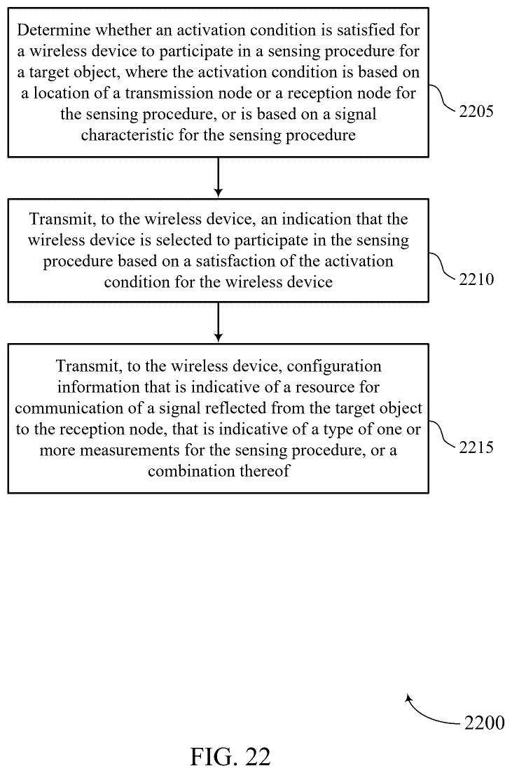

FIG. 22 shows a flowchart illustrating a method 2200 that supports activation conditions for sensing procedures in accordance with one or more aspects of the present disclosure. The operations of the method 2200 may be implemented by a network entity or its components as described herein. For example, the operations of the method 2200 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2205, the method may include determining whether an activation condition is satisfied for a wireless device to participate in a sensing procedure for a target object, where the activation condition is based on a location of a transmission node or a reception node for the sensing procedure, or is based on a signal characteristic for the sensing procedure. The operations of 2205 may be performed in accordance with examples as disclosed herein. In some examples, aspects of the operations of 2205 may be performed by an activation condition manager 1535 as described with reference to FIG. 15. In some examples, one or more means for determining whether the activation condition is satisfied may include a transceiver 1610, an antenna 1615, a processor 1635, or memory 1625 (e.g., code 1630) as described with reference to FIG. 16, may include a transceiver 2515 (e.g., a WWAN transceiver 2565, a short-range transceiver 2570, a satellite transceiver 2575, a low-power transceiver 2580), a processor 2540, or a memory 2530 (e.g., code 2535) as described with reference to FIG. 25, or may include a communication interface 2610, a processor 2640, or memory 2630 (e.g., code 2635) as described with reference to FIG. 26.

At 2210, the method may include transmitting, to the wireless device, an indication that the wireless device is selected to participate in the sensing procedure based on a satisfaction of the activation condition for the wireless device. The operations of 2210 may be performed in accordance with examples as disclosed herein. In some examples, aspects of the operations of 2210 may be performed by a selection manager 1540 as described with reference to FIG. 15. In some examples, one or more means for transmitting the indication may include a transceiver 1610, an antenna 1615, a processor 1635, or memory 1625 (e.g., code 1630) as described with reference to FIG. 16, may include a transceiver 2515 (e.g., a WWAN transceiver 2565, a short-range transceiver 2570, a satellite transceiver 2575, a low-power transceiver 2580), a processor 2540, or a memory 2530 (e.g., code 2535) as described with reference to FIG. 25, or may include a communication interface 2610, a processor 2640, or memory 2630 (e.g., code 2635) as described with reference to FIG. 26.

At 2215, the method may include transmitting, to the wireless device, configuration information that is indicative of a resource for communication of a signal reflected from the target object to the reception node, that is indicative of a type of one or more measurements for the sensing procedure, or a combination thereof. The operations of 2215 may be performed in accordance with examples as disclosed herein. In some examples, aspects of the operations of 2215 may be performed by a configuration manager 1545 as described with reference to FIG. 15. In some examples, one or more means for transmitting the configuration information may include a transceiver 1610, an antenna 1615, a processor 1635, or memory 1625 (e.g., code 1630) as described with reference to FIG. 16, may include a transceiver 2515 (e.g., a WWAN transceiver 2565, a short-range transceiver 2570, a satellite transceiver 2575, a low-power transceiver 2580), a processor 2540, or a memory 2530 (e.g., code 2535) as described with reference to FIG. 25, or may include a communication interface 2610, a processor 2640, or memory 2630 (e.g., code 2635) as described with reference to FIG. 26.

FIG. 23 shows examples of sensing nodes 2300 that support activation conditions for sensing procedures in accordance with one or more aspects of the present disclosure. Various sensing modes are illustrated in the context of one or more devices (e.g., TRPs and UEs). While TRPs are illustrated in FIG. 23, a TRP may instead be a base station (e.g., gNB) in some examples. The objects illustrated in FIG. 23 may be devices (e.g., UEs, AGVs, or vehicles, among other examples) or passive objects (e.g., roads, signs, barriers, or rocks, among other examples).

One or more sensing operations may be performed in accordance with one or more of the techniques described herein. Sensing operations may include monostatic sensing (e.g., radar-like sensing, where a sensing transmitter and a sensing receiver may be co-located in the same entity) or bistatic sensing (e.g., where a sensing receiver and sensing transmitter are located in different entities). Multi-static sensing may be performed in some examples, where multiple sensing transmitters or receivers may be utilized.

In some approaches, one or more reflections of a sensing signal sent from a sensing transmitter may be received by a sensing receiver and processed to determine one or more characteristics of the sensed object or an environment (e.g., location). In sensing operations, one or more sensing signal reflections may be received. The sensing signal reflections may be processed locally (e.g., in a device that received the sensing signal reflections) or may be communicated to another device for processing. For instance, a device may execute one or more AI/ML models to determine a position of the object based on the sensing signal reflections.

An example of monostatic TRP sensing 2305 is given in FIG. 23. For example, a TRP (e.g., gNB) may transmit a signal and receive a signal reflection from the object.

An example of monostatic UE sensing 2310 is given in FIG. 23. For example, a UE may transmit a signal and receive a signal reflection from the object.

An example of bistatic TRP-to-TRP sensing 2315 is given in FIG. 23. For example, a first TRP (e.g., a first gNB) may transmit a signal, and a second TRP may receive a signal reflection from the object.

An example of bistatic TRP-to-UE sensing 2320 is given in FIG. 23. For example, a TRP (e.g., a gNB) may transmit a signal, and a UE may receive a signal reflection from the object.

An example of bistatic UE-to-TRP sensing 2325 is given in FIG. 23. For example, a UE may transmit a signal, and a TRP may receive a signal reflection from the object.

An example of bistatic UE-to-UE sensing 2330 is given in FIG. 23. For example, a first UE may transmit a signal, and a second UE may receive a signal reflection from the object.

In some aspects, one or more of the AI/ML-based positioning or sensing procedures or communications (e.g., capability information, request information, indications, or meaning information, among other examples) described herein may be utilized for one or more sensing use cases. For instance, sensing may be performed to determine a position or motion of an object (e.g., a wireless device or other object). Examples of sensing use cases may include one or more of transportation, unmanned aerial vehicles (UAVs), smart cities, smart homes, smart factories, or health monitoring. For instance, a transportation use case may include intrusion detection on a highway, sensing assisted automotive maneuvering or navigation, smart parking, or other assistance, among other examples. A UAV use case may include UAV flight trajectory tracing or sensing for UAV intrusion detection, among other examples. A smart city use case may include rainfall monitoring, tourist spot traffic management, flooding awareness, weather forecasting, or public safety search and rescue, among other examples. A smart home use case may include intruder detection in a smart home, gesture recognition, or extended reality (XR) streaming, among other examples. A smart factory use case may include automated guided vehicle (AGV) detection and tracking in factories or inventory tracking, among other examples. A health monitoring use case may include monitoring vital signs and health related measures, sleep monitoring, or health monitoring, among other examples. Examples of sensing modes that may be employed in some examples of the techniques may be implemented in the wireless communications system described with reference to FIG. 4.

In some examples, one or more of the AI/ML models described herein may correspond to one or more sensing key performance indicators (KPIs) (with equivalent A-AI/ML sensing or D-AI/ML sensing). Some examples of sensing KPIs may include an accuracy of positioning (e.g., horizontal or vertical), an accuracy of range or cross-range of target, an accuracy of AOA of a target (e.g., azimuth or elevation), an accuracy of velocity (e.g., horizontal or vertical), a sensing range or cross-range resolutions, a sensing velocity resolution, a sensing angle resolution, a sensing latency, a sensing refreshing rate, a receiver operating characteristics (ROC) (e.g., misdetection or false alarm probabilities), a confidence interval or level of sensing, or target discrimination.

Some examples of the techniques described herein may utilize one or more terms relating to sensing. Sensing data may include data derived from one or more radio signals impacted (e.g., reflected, refracted, diffracted) by an object or environment of interest for sensing purposes, and optionally processed. 5G Wireless sensing (5GS) may be a feature providing one or more capabilities to obtain information about characteristics of the environment or objects within the environment (e.g., shape, size, orientation, speed, location, distances or relative motion between objects, among other examples) using radio frequency signals. Non-3GPP sensing data may be data provided by non-3GPP sensors (e.g., video, LIDAR, sonar) about an object or environment of interest for sensing purposes. Sensing assistance information may be information that is provided to a wireless system from a third-party and may be used to support the derivation of a sensing result. Examples of sensing assistance information may include map information, area information, a UE ID attached to or in the proximity of the sensing target, UE position information, or UE velocity information, among other examples.

Sensing contextual information may be information that is exposed with the sensing results by a wireless system to a third-party which provides context to the conditions under which the sensing results were derived. Examples may include map information, area information, time of capture, UE location, or an identifier. This contextual information may be demanded in scenarios where the sensing result is to be combined with data from other sources outside the 5GS. A sensing group may be a set of sensing transmitters and sensing receivers whose location is known and whose sensing data can be collected synchronously. A sensing receiver may be an entity that receives a sensing signal which a sensing service may use in operation. A sensing receiver may be part of a RAN node or a UE. A sensing receiver may be located in the same or different entity as the sensing transmitter. A sensing result may be processed sensing data requested by a service consumer. Sensing signals may be transmissions on a radio interface that can be used for sensing purposes. Some approaches may refer to NR radio frequency signals which, in some cases.

A sensing transmitter may be an entity that sends out a sensing signal which the sensing service will use in its operation. A sensing transmitter may be part of a RAN node or a UE. A sensing transmitter may be located in the same or different entity as the sensing receiver. A target sensing service area may be a cartesian location area to be sensed by deriving characteristics of the environment or objects within the environment with a sensing service quality from the impacted (e.g., reflected, refracted, diffracted) radio signals. This may include indoor or outdoor environments.

RF sensing may extend positioning capabilities to one or more applications. Factors affecting sensing performance may include radar cross-section (RCS), mobility, or clutter/scattering patterns. One or more channel modeling aspects may be utilized to support object detection or tracking. A modeling framework may be capable of detecting or tracking one or more objects and to enable them to be distinguished from unintended objects. Some examples of objects may include UAVs, humans (indoors or outdoors), automotive vehicles (at least outdoors), automated guided vehicles (e.g., in indoor factories), or objects creating hazards on roads/railways (e.g., with a minimum size dependent on frequency). In some examples, one or more frequencies from 0.5 to 52.6 GHz may be utilized, with scalability to 100 GHz.

For one or more use cases, sensing modes and frequencies, deployment scenarios may be identified corresponding to one or more use cases. Channel modeling may be utilized for sensing. One or more measurements may be utilized for modeling of sensing targets or a background environment, including, for example, RCS, mobility, clutter/scattering patterns, or spatial reliability.

In some examples, a sensing data signal processing flow may be performed from Analog-to-Digital Converter (ADC) samples to progressively higher-level data representations. From low levels to high levels, the data types may include raw data, a range-angle-Doppler (RAD) tensor, a point cloud, or grid map. Learning-based frameworks may be utilized, which may support the encoding and decoding of different representation types, and additional quantization can be adopted to reduced data size. For integrated sensing and communication, for instance, one or more types of data representations may be utilized, which may include data quantization, range fast Fourier transform (FFT), Doppler FFT, angle FFT, RAD tensor, point cloud, voxel grids, neural network (NN)-based representations, or parametric objects. In some examples, an ADC signal may be utilized to obtain one or more of the types of representations. In some aspects, a deep learning framework or quantization may be applied for one or more (e.g., all) types of representations. One or more types of representations may be provided to an SnMF for one or more sensing operations.

One or more of the data representations are described as follows. Data quantization: at a relatively low (e.g., lowest) level, sampling and quantization of the sensing signal may be initial operations. To reduce the volume of data that needs to be processed, various techniques may be utilized. Some approaches, such as compressed sensing, may exploit the sparsity of the signal to acquire the signal at a lower sampling rate. Other approaches may use relatively low-bit quantization to reduce complexity and power consumption at the TRP. In particular, the power consumption of ADCs in hybrid architectures may grow exponentially to the quantity of quantization levels, thus elevating the significance of ADC quantization. In some cases, sampling may be performed with one bit per sample, significantly reducing the data volume to be transmitted by the TRP. Data quantization may be combined with other representations, such as RAD tensors or point clouds, among other examples. Data quantization may be used as the format of data to be exchanged in a case of signal-level fusion where the sensing data is sent directly to a fusion center without performing any further local processing.

RAD tensors: range-angle and range-Doppler maps may be data representations in radar signal processing. The maps may provide a structured way to visualize or analyze spatial or velocity information of detected targets. In the context of integrated sensing and communication, the maps may be useful for tasks like target detection, localization, and tracking.

Point clouds: point clouds may be versatile data representations that may be utilized in various sensing applications, including radar, LIDAR, or computer vision. In the context of integrated sensing and communication, point clouds may provide a spatial representation of multiple targets by capturing discrete points in a three-dimensional space. Each point in the cloud may contain information about the target's range, velocity, azimuth angle, or elevation angle.

Voxel grids: voxel grids may be another form of data representation where the 3D space is divided into a grid of volumetric pixels (voxels). Each voxel can store information such as occupancy, intensity, or other attributes. Voxel grids may be useful for representing an environment in autonomous driving and robotics applications. Voxel grids may provide a structured representation that may be processed by algorithms but can be memory intensive.

Deep Learning-Based Representations: advancements in deep learning may lead to the development of various data representations. For instance, radar data may be transformed into images or tensors that are fed into convolutional neural networks (CNNs) for tasks such as object detection or classification. The representations may leverage deep learning to extract high-level features from raw data, which may improve the accuracy or robustness of sensing systems. Variational auto-encoders (VAE) may be utilized, which may project input data into a distribution over the latent space. In particular, the following forms of deep learning representations may be utilized: embeddings, feature vectors (e.g., outputs of feature extraction layers), or layer weights.

Parametric object representations: by performing object segmentation over point clouds, scene information may be conveyed with relatively less data. This operation may involve: (i) employing clustering algorithms to separate the point cloud into groups that correspond to different environment objects; and (ii) unifying the points of each group to a compact representation, therefore unveiling the shape of each object. To describe shapes of 3D objects, multiple approaches may be taken, such as polygon representations (represented as the convex hulls of each point cloud group), wireframes (interconnected sets of edges), or general parametric shapes, where each shape is represented by the set of its geometric parameters (e.g., center and radius for 3D balls). While accurately representing real objects with geometrical shapes may present challenges, such representation may be utilized such that relatively few bytes of information may be transmitted to describe a scene.

FIG. 24 shows an example of a block diagram 2400 of a UE 2405 that supports activation conditions for sensing procedures in accordance with one or more aspects of the present disclosure. The UE 2405 may be an example of or include components of a UE 115, a wireless device 410, device 905, a device 1005, a communications manager 1120, or a wireless device 1205, as described herein. The UE 2405 may include components for bi-directional voice or data communications including components for transmitting or receiving communications, such as an I/O controller 2410, one or more transceivers 2415, one or more antennas 2425, at least one memory 2430, code 2435, or at least one processor 2440. The UE 2405 may include one or more sensors 2450. These components may be in electronic communication or otherwise coupled (e.g., operatively, communicatively, functionally, electronically, electrically) via one or more buses (e.g., a bus 2445).

The I/O controller 2410 may manage input and output signals for the UE 2405. The I/O controller 2410 may also manage one or more peripheral devices not integrated into the UE 2405. In some cases, the I/O controller 2410 may represent a physical connection or port to an external peripheral. In some cases, the I/O controller 2410 may utilize an operating system such as iOS®, ANDROID®, MS-DOS®, MS-WINDOWS®, OS/2®, UNIX®, LINUX®, or another known operating system. Additionally, or alternatively, the I/O controller 2410 may represent or interact with a modem, a keyboard, a mouse, a touchscreen, or a similar device. In some cases, the I/O controller 2410 may be implemented as part of one or more processors, such as the at least one processor 2440. In some cases, a user may interact with the UE 2405 via the I/O controller 2410 or via hardware components controlled by the I/O controller 2410.

In some cases, the UE 2405 may include a single antenna 2425. However, in some other cases, the UE 2405 may have more than one antenna 2425, which may be capable of concurrently transmitting or receiving multiple wireless transmissions. The transceiver(s) 2415 may communicate bi-directionally via the one or more antennas 2425 using one or more wireless links as described herein. For example, the transceiver 2415 may represent a wireless transceiver and may communicate bi-directionally with another wireless transceiver. The transceiver 2415 may also include a modem to modulate the packets, to provide the modulated packets to one or more antennas 2425 for transmission, or to demodulate packets received from the one or more antennas 2425. The transceiver 2415, or the transceiver 2415 and one or more antennas 2425, may be an example of a transmitter 915, a transmitter 1015, a receiver 910, a receiver 1010, or any combination thereof or component thereof, as described herein.

The one or more transceivers 2415 may include one or more WWAN transceivers 2465, one or more short-range wireless transceivers 2470, one or more satellite transceivers 2475, or one or more low-power transceivers 2480. The WWAN transceiver(s) 2465 may communicate with (e.g., transmit one or more signals to, or receive one or more signals from) one or more wireless communication networks, such as an NR network, an LTE network, or a GSM network, among other examples. The WWAN transceiver(s) 2465 may be connected to one or more of the antenna(s) 2425 for communicating with other devices, such as one or more UEs 115, network entities, network nodes, access points, base stations (e.g., eNBs, gNBs), or another device(s), via at least one RAT (e.g., NR, LTE, or GSM, among other examples) over a wireless communication medium (e.g., time or frequency resources of a frequency spectrum). The WWAN transceiver(s) 2465 may be configured for encoding and transmitting signals (e.g., messages, indications, or information, among other examples) or for receiving and decoding signals (e.g., messages, indications, information, or pilots, among other examples), in accordance with the RAT. For instance, the WWAN transceiver(s) 2465 may include one or more transmitters for transmitting and encoding signals, or one or more receivers for receiving and decoding signals.

The short-range wireless transceivers 2470 may be connected to one or more of the antenna(s) 2425 to communicate with (e.g., transmit one or more signals to, or receive one or more signals from) one or more network nodes, such as one or more UEs 115, network entities, network nodes, access points, base stations, or another device(s), via at least one RAT (e.g., Wi-Fi, LTE Direct, BLUETOOTH®, ZIGBEE®, Z-WAVE®, PC5, DSRC, WAVE, NFC, or UWB, among other examples) over a wireless communication medium. The short-range wireless transceiver(s) 2470 may be configured for transmitting and encoding signals (e.g., messages, indications, or information, among other examples), or for receiving and decoding signals (e.g., messages, indications, information, or pilots, among other examples), in accordance with the RAT. For instance, the short-range wireless transceiver(s) 2470 may include one or more transmitters for transmitting and encoding signals, or one or more receivers for receiving and decoding signals. In some examples, the short-range wireless transceiver(s) 2470 may be one or more Wi-Fi transceivers, BLUETOOTH® transceivers, ZIGBEE® transceivers, Z-WAVE® transceivers, NFC transceivers, UWB transceivers, vehicle-to-vehicle (V2V) transceivers, or vehicle-to-everything (V2X) transceivers, among other examples.

The satellite transceiver(s) 2475 may include one or more satellite signal receivers, or one or more satellite signal transmitters. In some cases, the UE 2405 may be a terrestrial device that may communicate one or more satellites via the satellite transceiver(s) 2475. In other cases, UE 2405 may be a satellite (or other non-terrestrial entity) that uses the satellite transceiver(s) 2475 to communicate with one or more terrestrial networks or other satellites.

The satellite signal receiver(s) may be connected to one or more of the antenna(s) 2425 for receiving or measuring satellite positioning or communication signals. In some examples, the satellite signal receiver(s) may include one or more satellite positioning system receivers, where the satellite positioning or communication signals may be GPS signals, GLONASS signals, Galileo signals, BeiDou signals, NAVIC, or QZSS signals, among other examples. In some examples, the satellite signal receiver(s) may include one or more NTN receivers, where the satellite positioning or communication signals may be communication signals (e.g., carrying control or user data) originating from a device or network. The satellite signal receiver(s) (e.g., GPS receiver(s) or GNSS receiver(s)) may include hardware or a combination of hardware and instructions for receiving and processing satellite positioning or communication signals. The satellite signal receiver(s) or the processor 2440 may perform calculations to determine a location of the UE 2405, the UE 115, the network node 105, or another device using measurements obtained from one or more satellite signals.

The one or more satellite signal transmitters may be connected to one or more of the antennas 2425 for transmitting satellite positioning communication signals. In some examples, the satellite signal transmitter(s) may be satellite positioning system transmitters, and the satellite positioning or communication signals may be GPS signals, GLONASS® signals, Galileo signals, BeiDou signals, NAVIC, or QZSS signals, among other examples. In some examples, the satellite signal transmitter(s) include one or more NTN transmitters, and the satellite positioning or communication signals may be communication signals (e.g., carrying control or user data). The satellite signal transmitter(s) may comprise hardware or a combination of hardware and instructions for transmitting satellite positioning or communication signals.

The low-power transceiver(s) 2480 may be connected to one or more of the antenna(s) 2425 to communicate with (e.g., transmit one or more signals to, or receive one or more signals from) one or more network nodes, such as one or more UEs 115, network entities, network nodes, access points, base stations, or another device(s) over a wireless communication medium. The low-power transceiver(s) 2480 may consume less operating power than one or more of the other transceivers (e.g., WWAN transceiver 2465, short-range transceiver 2470, or satellite transceiver 2475). The low-power transceiver(s) 2480 may be less complex than one or more of the other transceivers (e.g., WWAN transceiver 2465, short-range transceiver 2470, or satellite transceiver 2475). The lower-power transceiver(s) 2480 may be an example of a LP-WUR, or may be included in a LP-WUR. The low-power transceiver(s) 2480 may be configured for transmitting signals (e.g., messages, indications, or information, among other examples), or for receiving signals (e.g., messages, indications, information, WUSs, or LP-WUSs, among other examples). For instance, the low-power transceiver(s) 2480 may include a sequence detector, an OOK demodulator, or other circuitry for receiving information or detecting an LP-WUS for activating one or more other transceivers (e.g., WWAN transceiver 2465, short-range transceiver 2470, or satellite transceiver 2475) or other component(s).

The UE 2405 may include one or more sensors 2450 coupled with the one or more processors 2440 for obtaining sensor data (e.g., image data, RF data, motion data, orientation data, or audio data, among other examples). For example, the one or more sensors 2450 may sense or detect movement or orientation information. In some examples, the sensor(s) 2450 may include one or more motion sensors 2455 for sensing movement information, or one or more orientation sensors 2460 for sensing orientation information, among other examples. In some aspects, the movement or orientation information may be independent from motion data derived from signals received by the one or more WWAN transceivers 2465, the one or more short-range wireless transceivers 2470, or the satellite signal interface. In some examples, the motion sensor(s) 2455 may include an accelerometer (e.g., a MEMS device), a gyroscope, a geomagnetic sensor (e.g., a compass), an altimeter (e.g., a barometric pressure altimeter), or any other type of movement detection sensor. Additionally, or alternatively, the one or more sensors 2450 may include an image sensor, camera, microphone, light detector, or pressure sensor, among other examples. In some aspects, the sensor(s) 2450 may include a plurality of different types of devices, and the UE 2405 (e.g., sensor(s) 2450 or processor(s) 2440) may combine the outputs of the different types of devices to provide motion information. For example, the sensor(s) 2450 may use a combination of a multi-axis accelerometer sensors, orientation sensors 2460, or image sensors to provide the ability to compute positions in 2D or 3D coordinate systems.

The at least one memory 2430 may include RAM or ROM. The at least one memory 2430 may store computer-readable, computer-executable, or processor-executable code, such as the code 2435. The code 2435 may include instructions that, when executed by the at least one processor 2440, cause the UE 2405 to perform various functions described herein. The code 2435 may be stored in a non-transitory computer-readable medium such as system memory or another type of memory. In some cases, the code 2435 may not be directly executable by the at least one processor 2440 but may cause a computer (e.g., when compiled and executed) to perform functions described herein. In some cases, the at least one memory 2430 may include, among other things, a BIOS which may control basic hardware or software operation such as the interaction with peripheral components or devices.

The at least one processor 2440 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 2440 may be configured to operate a memory array using a memory controller. In some other cases, a memory controller may be integrated into the at least one processor 2440. The at least one processor 2440 may be configured to execute computer-readable instructions stored in a memory (e.g., the at least one memory 2430) to cause the UE 2405 to perform various functions (e.g., functions or tasks supporting activation conditions for sensing procedures). For example, the UE 2405 or a component of the UE 2405 may include at least one processor 2440 and at least one memory 2430 coupled with or to the at least one processor 2440, the at least one processor 2440 and the at least one memory 2430 configured to perform various functions described herein.

In some examples, the at least one processor 2440 may include multiple processors and the at least one memory 2430 may include multiple memories. One or more of the multiple processors may be coupled with one or more of the multiple memories, which may, individually or collectively, be configured to perform various functions described herein. In some examples, the at least one processor 2440 may be a component of a processing system, which may refer to a system (such as a series) of machines, circuitry (including, for example, one or both of processor circuitry (which may include the at least one processor 2440) and memory circuitry (which may include the at least one memory 2430)), or components, that receives or obtains inputs and processes the inputs to produce, generate, or obtain a set of outputs. The processing system may be configured to perform one or more of the functions described herein. For example, the at least one processor 2440 or a processing system including the at least one processor 2440 may be configured to, configurable to, or operable to cause the UE 2405 to perform one or more of the functions described herein. Further, as described herein, being “configured to,” being “configurable to,” and being “operable to” may be used interchangeably and may be associated with a capability, when executing code 2435 (e.g., processor-executable code or instructions) stored in the at least one memory 2430 or otherwise, to perform one or more of the functions described herein.

FIG. 25 shows an example of a block diagram 2500 of a base station 2505 that supports activation conditions for sensing procedures in accordance with one or more aspects of the present disclosure. The base station 2505 may be an example of or include components of a network node 105, RU 170, DU 165, CU 160, gNB 255, RU 170-a, DU 165-a, CU 160-a, ng-eNB 260, RU 170-b, DU 165-b, CU 160-b, network node, network entity, device 1305, device 1405, or a device 1605, as described herein. The base station 2505 may include components for bi-directional voice or data communications including components for transmitting or receiving communications, such as a communication interface 2510, one or more transceivers 2515, one or more antennas 2525, at least one memory 2530, code 2535, or at least one processor 2540. These components may be in electronic communication or otherwise coupled (e.g., operatively, communicatively, functionally, electronically, electrically) via one or more buses (e.g., a bus 2545).

The communication interface 2510 may include hardware (e.g., circuitry, port(s), modem(s), or transceiver(s), among other examples) to enable wired or wireless communications, which may be in addition to, or alternatively from, the transceiver(s) 2515. For example, the communication interface 2510 may include an Ethernet interface, coaxial interface, fiber optic interface, optical wireless communication (OWC) interface, universal serial bus (USB) interface, public switched telephone network (PSTN) interface, or other interface. In some cases, the communication interface 2510 may be implemented as part of one or more processors, such as the at least one processor 2540. In some cases, one or more devices (e.g., one or more other base stations, network nodes, location servers, or other devices) may communicate with the base station 2505 via the communication interface 2510 or via hardware components controlled by the communication interface 2510.

In some cases, the base station 2505 may include a single antenna 2525. However, in some other cases, the base station 2505 may have more than one antenna 2525, which may be capable of concurrently transmitting or receiving multiple wireless transmissions. The transceiver(s) 2515 may communicate bi-directionally via the one or more antennas 2525 using one or more wireless links as described herein. For example, the transceiver 2515 may represent a wireless transceiver and may communicate bi-directionally with another wireless transceiver. The transceiver 2515 may also include a modem to modulate the packets, to provide the modulated packets to one or more antennas 2525 for transmission, or to demodulate packets received from the one or more antennas 2525. The transceiver 2515, or the transceiver 2515 and one or more antennas 2525, may be an example of a transmitter 1315, a transmitter 1415, a receiver 1310, a receiver 1410, or any combination thereof or component thereof, as described herein.

The one or more transceivers 2515 may include one or more WWAN transceivers 2565, one or more short-range wireless transceivers 2570, one or more satellite transceivers 2575, or one or more low-power transceivers 2580. The WWAN transceiver(s) 2565 may communicate with (e.g., transmit one or more signals to, or receive one or more signals from) one or more wireless communication networks, such as an NR network, an LTE network, or a GSM network, among other examples. The WWAN transceiver(s) 2565 may be connected to one or more of the antenna(s) 2525 for communicating with other devices, such as one or more UEs 115, network entities, network nodes, access points, base stations (e.g., eNBs, gNBs), or another device(s). In some examples, the communications may be performed via at least one RAT (e.g., NR, LTE, or GSM, among other examples) over a wireless communication medium (e.g., time or frequency resources of a frequency spectrum). The WWAN transceiver(s) 2565 may be configured for encoding and transmitting signals (e.g., messages, indications, or information, among other examples) or for receiving and decoding signals (e.g., messages, indications, information, or pilots, among other examples). For instance, the WWAN transceiver(s) 2565 may include one or more transmitters for transmitting and encoding signals, or one or more receivers for receiving and decoding signals (in accordance with the RAT, for example).

The short-range wireless transceivers 2570 may be connected to one or more of the antenna(s) 2525 to communicate with (e.g., transmit one or more signals to, or receive one or more signals from) one or more network nodes, such as one or more UEs 115, network entities, network nodes, access points, base stations, or another device(s). The communications may be performed via at least one RAT (e.g., Wi-Fi, LTE Direct, BLUETOOTH®, ZIGBEE®, Z-WAVE®, PC5, DSRC, WAVE, NFC, or UWB, among other examples) over a wireless communication medium. The short-range wireless transceiver(s) 2570 may be configured for transmitting and encoding signals (e.g., messages, indications, or information, among other examples), or for receiving and decoding signals (e.g., messages, indications, information, or pilots, among other examples). For instance, the short-range wireless transceiver(s) 2570 may include one or more transmitters for transmitting and encoding signals, or one or more receivers for receiving and decoding signals (in accordance with the RAT, for instance). In some examples, the short-range wireless transceiver(s) 2570 may be one or more Wi-Fi transceivers, BLUETOOTH® transceivers, ZIGBEE® transceivers, Z-WAVE® transceivers, NFC transceivers, UWB transceivers, V2V transceivers, or V2X transceivers, among other examples.

The satellite transceiver(s) 2575 may include one or more satellite signal receivers, or one or more satellite signal transmitters. In some cases, the base station 2505 may be a terrestrial device that may communicate one or more satellites via the satellite transceiver(s) 2575. In other cases, base station 2505 may be a satellite (or other non-terrestrial entity) that uses the satellite transceiver(s) 2575 to communicate with one or more terrestrial networks or other satellites.

The satellite signal receiver(s) may be connected to one or more of the antenna(s) 2525 for receiving or measuring satellite positioning or communication signals. In some examples, the satellite signal receiver(s) may include one or more satellite positioning system receivers, where the satellite positioning or communication signals may be GPS signals, GLONASS signals, Galileo signals, BeiDou signals, NAVIC, or QZSS signals, among other examples. In some examples, the satellite signal receiver(s) may include one or more NTN receivers, where the satellite positioning or communication signals may be communication signals (e.g., carrying control or user data) originating from a device or network. The satellite signal receiver(s) (e.g., GPS receiver(s) or GNSS receiver(s)) may include hardware or a combination of hardware and instructions for receiving and processing satellite positioning or communication signals. The satellite signal receiver(s) or the processor 2540 may perform calculations to determine a location of the base station 2505, the UE 115, the network node 105, or another device using measurements obtained from one or more satellite signals.

The one or more satellite signal transmitters may be connected to one or more of the antennas 2525 for transmitting satellite positioning communication signals. In some examples, the satellite signal transmitter(s) may be satellite positioning system transmitters, and the satellite positioning or communication signals may be GPS signals, GLONASS® signals, Galileo signals, BeiDou signals, NAVIC, or QZSS signals, among other examples. In some examples, the satellite signal transmitter(s) include one or more NTN transmitters, and the satellite positioning or communication signals may be communication signals (e.g., carrying control or user data). The satellite signal transmitter(s) may comprise hardware or a combination of hardware and instructions for transmitting satellite positioning or communication signals.

The low-power transceiver(s) 2580 may be connected to one or more of the antenna(s) 2525 to communicate with (e.g., transmit one or more signals to, or receive one or more signals from) one or more network nodes, such as one or more UEs 115, network entities, network nodes, access points, base stations, or another device(s) over a wireless communication medium. The low-power transceiver(s) 2580 may consume less operating power than one or more of the other transceivers (e.g., WWAN transceiver 2565, short-range transceiver 2570, or satellite transceiver 2575). The low-power transceiver(s) 2580 may be less complex than one or more of the other transceivers (e.g., WWAN transceiver 2565, short-range transceiver 2570, or satellite transceiver 2575). The lower-power transceiver(s) 2580 may be an example of a LP-WUR, or may be included in a LP-WUR. The low-power transceiver(s) 2580 may be configured for transmitting signals (e.g., messages, indications, information, WUSs, or LP-WUSs, among other examples), or for receiving signals (e.g., messages, indications, information, WUSs, or LP-WUSs, among other examples). For instance, the low-power transceiver(s) 2580 may include a sequence generator, an OOK modulator, or other circuitry for transmitting information or outputting an LP-WUS for activating one or more other transceivers or other component(s) of another device.

The at least one memory 2530 may include RAM or ROM. The at least one memory 2530 may store computer-readable, computer-executable, or processor-executable code, such as the code 2535. The code 2535 may include instructions that, when executed by the at least one processor 2540, cause the base station 2505 to perform various functions described herein. The code 2535 may be stored in a non-transitory computer-readable medium such as system memory or another type of memory. In some cases, the code 2535 may not be directly executable by the at least one processor 2540 but may cause a computer (e.g., when compiled and executed) to perform functions described herein. In some cases, the at least one memory 2530 may include, among other things, a BIOS which may control basic hardware or software operation such as the interaction with peripheral components or devices.

The at least one processor 2540 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 2540 may be configured to operate a memory array using a memory controller. In some other cases, a memory controller may be integrated into the at least one processor 2540. The at least one processor 2540 may be configured to execute computer-readable instructions stored in a memory (e.g., the at least one memory 2530) to cause the base station 2505 to perform various functions (e.g., functions or tasks supporting activation conditions for sensing procedures). For example, the base station 2505 or a component of the base station 2505 may include at least one processor 2540 and at least one memory 2530 coupled with or to the at least one processor 2540, the at least one processor 2540 and the at least one memory 2530 configured to perform various functions described herein.

In some examples, the at least one processor 2540 may include multiple processors and the at least one memory 2530 may include multiple memories. One or more of the multiple processors may be coupled with one or more of the multiple memories, which may, individually or collectively, be configured to perform various functions described herein. In some examples, the at least one processor 2540 may be a component of a processing system, which may refer to a system (such as a series) of machines, circuitry (including, for example, one or both of processor circuitry (which may include the at least one processor 2540) and memory circuitry (which may include the at least one memory 2530)), or components, that receives or obtains inputs and processes the inputs to produce, generate, or obtain a set of outputs. The processing system may be configured to perform one or more of the functions described herein. For example, the at least one processor 2540 or a processing system including the at least one processor 2540 may be configured to, configurable to, or operable to cause the base station 2505 to perform one or more of the functions described herein. Further, as described herein, being “configured to,” being “configurable to,” and being “operable to” may be used interchangeably and may be associated with a capability, when executing code 2535 (e.g., processor-executable code or instructions) stored in the at least one memory 2530 or otherwise, to perform one or more of the functions described herein.

FIG. 26 shows an example of a block diagram 2600 of a location or sensing server 2605 that supports activation conditions for sensing procedures in accordance with one or more aspects of the present disclosure. The location or sensing server 2605 may be an example of or include components of a location or sensing server 185, LMF 265, external device 230, SLP 235, location or sensing server 185, device 1305, device 1405, or a device 1605, as described herein. The location or sensing server 2605 may include components for bi-directional data communications including components for transmitting or receiving communications, such as a communication interface 2610, at least one memory 2630, code 2635, or at least one processor 2640. These components may be in electronic communication or otherwise coupled (e.g., operatively, communicatively, functionally, electronically, electrically) via one or more buses (e.g., a bus 2645).

The communication interface 2610 may include hardware (e.g., circuitry, port(s), modem(s), or transceiver(s), among other examples) to enable wired or wireless communications. For example, the communication interface 2610 may include an Ethernet interface, coaxial interface, fiber optic interface, OWC interface, USB interface, PSTN interface, WWAN transceiver, short-range transceiver, satellite transceiver, or other interface. In some aspects, the communication interface 2610 may be an example of a transmitter 1315, a transmitter 1415, a receiver 1310, a receiver 1410, or any combination thereof or component thereof, as described herein. In some cases, the communication interface 2610 may be implemented as part of one or more processors, such as the at least one processor 2640. In some cases, one or more devices (e.g., one or more base stations, network nodes, or other devices) may communicate with the location or sensing server 2605 via the communication interface 2610 or via hardware components controlled by the communication interface 2610.

The at least one memory 2630 may include RAM or ROM. The at least one memory 2630 may store computer-readable, computer-executable, or processor-executable code, such as the code 2635. The code 2635 may include instructions that, when executed by the at least one processor 2640, cause the location or sensing server 2605 to perform various functions described herein. For example, the code 2635 may include instructions for performing one or more positioning procedures or one or more aspects of a positioning procedure(s). The code 2635 may be stored in a non-transitory computer-readable medium such as system memory or another type of memory. In some cases, the code 2635 may not be directly executable by the at least one processor 2640 but may cause a computer (e.g., when compiled and executed) to perform functions described herein. In some cases, the at least one memory 2630 may include, among other things, a BIOS which may control basic hardware or software operation such as the interaction with peripheral components or devices.

The at least one processor 2640 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 2640 may be configured to operate a memory array using a memory controller. In some other cases, a memory controller may be integrated into the at least one processor 2640. The at least one processor 2640 may be configured to execute computer-readable instructions stored in a memory (e.g., the at least one memory 2630) to cause the location or sensing server 2605 to perform various functions (e.g., functions or tasks supporting activation conditions for sensing procedures). For example, the location or sensing server 2605 or a component of the location or sensing server 2605 may include at least one processor 2640 and at least one memory 2630 coupled with or to the at least one processor 2640, the at least one processor 2640 and the at least one memory 2630 configured to perform various functions described herein.

In some examples, the at least one processor 2640 may include multiple processors and the at least one memory 2630 may include multiple memories. One or more of the multiple processors may be coupled with one or more of the multiple memories, which may, individually or collectively, be configured to perform various functions described herein. In some examples, the at least one processor 2640 may be a component of a processing system, which may refer to a system (such as a series) of machines, circuitry (including, for example, one or both of processor circuitry (which may include the at least one processor 2640) and memory circuitry (which may include the at least one memory 2630)), or components, that receives or obtains inputs and processes the inputs to produce, generate, or obtain a set of outputs. The processing system may be configured to perform one or more of the functions described herein. For example, the at least one processor 2640 or a processing system including the at least one processor 2640 may be configured to, configurable to, or operable to cause the location or sensing server 2605 to perform one or more of the functions described herein. Further, as described herein, being “configured to,” being “configurable to,” and being “operable to” may be used interchangeably and may be associated with a capability, when executing code 2635 (e.g., processor-executable code or instructions) stored in the at least one memory 2630 or otherwise, to perform one or more of the functions described herein.

The following provides an overview of aspects of the present disclosure:

Aspect 1: A method for wireless communications by a wireless device, comprising: obtaining, from a network entity, an indication of an activation condition to participate in a sensing procedure for a target object, wherein the activation condition is based at least in part on a location of a transmission node or a reception node for the sensing procedure, or is based at least in part on a signal characteristic for the sensing procedure; receiving, based at least in part on a satisfaction of the activation condition, a signal reflected from the target object; and transmitting, to the network entity, measurement information indicative of one or more measurements of the signal reflected from the target object.

Aspect 2: The method of aspect 1, further comprising: obtaining, from the network entity, configuration information that is indicative of a resource for communication of the signal, that is indicative of a type of the one or more measurements, or a combination thereof.

Aspect 3: The method of aspect 2, wherein the configuration information is obtained previous to the satisfaction of the activation condition, or is obtained in response to a transmission indicative of the satisfaction of the activation condition to the network entity.

Aspect 4: The method of any of aspects 1 through 3, wherein the activation condition is based at least in part on whether a relative distance between the transmission node and the reception node satisfies a threshold.

Aspect 5: The method of any of aspects 1 through 4, wherein the sensing procedure comprises bistatic sensing, the bistatic sensing limited to a tracking operation for the target object.

Aspect 6: The method of any of aspects 1 through 5, wherein the activation condition is based at least in part on whether a relative distance between the transmission node and the reception node satisfies a threshold, wherein the threshold is based at least in part on a first distance between the transmission node and the target object, or a second distance between the reception node and the target object.

Aspect 7: The method of aspect 6, further comprising: obtaining, from the network entity, an indication of the location of the transmission node, an indication of a location of the target object, or a combination thereof.

Aspect 8: The method of any of aspects 1 through 7, wherein the activation condition is based at least in part on whether a relative distance satisfies a threshold, wherein the relative distance is between the transmission node and the target object, or is between the reception node and the target object.

Aspect 9: The method of any of aspects 1 through 8, wherein the activation condition is based at least in part on whether an angle satisfies a threshold, wherein the angle is between a first ray that is between the transmission node and the target object, and a second ray that is between the reception node and the target object.

Aspect 10: The method of any of aspects 1 through 9, wherein the activation condition is based at least in part on whether an elevation satisfies a threshold, wherein the elevation is a relative elevation between the transmission node and the reception node, or is an absolute elevation of the transmission node or of the reception node.

Aspect 11: The method of any of aspects 1 through 10, wherein the activation condition is based at least in part on whether a threshold is satisfied by a power or a strength of signaling via a background channel between the transmission node and the reception node.

Aspect 12: The method of any of aspects 1 through 11, wherein the activation condition is based at least in part on whether a projected power of the signal reflected from the target object satisfies a condition, the projected power being based at least in part on a radar cross section of the target object.

Aspect 13: The method of any of aspects 1 through 12, wherein the activation condition comprises a set of conditions, wherein the activation condition is based at least in part on whether at least a subset of the set of conditions is satisfied.

Aspect 14: The method of any of aspects 1 through 13, further comprising: transmitting, to the network entity, an indication of a reason for which the wireless device does not participate in a sensing session.

Aspect 15: The method of any of aspects 1 through 14, further comprising: transmitting, to the network entity, capability information indicating a capability of the wireless device to utilize the activation condition, wherein the indication of the activation condition is obtained based at least in part on the capability information.

Aspect 16: The method of any of aspects 1 through 15, wherein the indication of the activation condition is signaled via a sensing request message, via assistance data, via unicast signaling, or via broadcast signaling.

Aspect 17: The method of any of aspects 1 through 16, further comprising: transmitting, to the network entity, an indicator of the satisfaction of the activation condition; and obtaining, from the network entity, activation information indicative of an activation of the sensing procedure based at least in part on the satisfaction of the activation condition.

Aspect 18: A method for wireless communications by a network entity, comprising: transmitting, to a wireless device, an indication of an activation condition to participate in a sensing procedure for a target object, wherein the activation condition is based at least in part on a location of a transmission node or a reception node for the sensing procedure, or is based at least in part on a signal characteristic for the sensing procedure; and obtaining, from the wireless device, measurement information indicative of one or more measurements of a signal reflected from the target object.

Aspect 19: The method of aspect 18, further comprising: transmitting, to the wireless device, configuration information that is indicative of a resource for communication of the signal, that is indicative of a type of the one or more measurements, or a combination thereof.

Aspect 20: The method of aspect 19, wherein the configuration information is transmitted previous to a satisfaction of the activation condition, or is transmitted in response to a transmission indicative of a satisfaction of the activation condition from the wireless device.

Aspect 21: The method of any of aspects 18 through 20, wherein the activation condition is based at least in part on whether a relative distance between the transmission node and the reception node satisfies a threshold.

Aspect 22: The method of any of aspects 18 through 21, wherein the sensing procedure comprises bistatic sensing, the bistatic sensing limited to a tracking operation for the target object.

Aspect 23: The method of any of aspects 18 through 22, wherein the activation condition is based at least in part on whether a relative distance between the transmission node and the reception node satisfies a threshold, wherein the threshold is based at least in part on a first distance between the transmission node and the target object, or a second distance between the reception node and the target object.

Aspect 24: The method of aspect 23, further comprising: transmitting, to the wireless device, an indication of the location of the transmission node, an indication of a location of the target object, or a combination thereof.

Aspect 25: The method of any of aspects 18 through 24, wherein the activation condition is based at least in part on whether a relative distance satisfies a threshold, wherein the relative distance is between the transmission node and the target object, or is between the reception node and the target object.

Aspect 26: The method of any of aspects 18 through 25, wherein the activation condition is based at least in part on whether an angle satisfies a threshold, wherein the angle is between a first ray that is between the transmission node and the target object, and a second ray that is between the reception node and the target object.

Aspect 27: The method of any of aspects 18 through 26, wherein the activation condition is based at least in part on whether an elevation satisfies a threshold, wherein the elevation is a relative elevation between the transmission node and the reception node, or is an absolute elevation of the transmission node or of the reception node.

Aspect 28: The method of any of aspects 18 through 27, wherein the activation condition is based at least in part on whether a threshold is satisfied by a power or a strength of signaling via a background channel between the transmission node and the reception node.

Aspect 29: The method of any of aspects 18 through 28, wherein the activation condition is based at least in part on whether a projected power of the signal reflected from the target object satisfies a condition, the projected power being based at least in part on a radar cross section of the target object.

Aspect 30: The method of any of aspects 18 through 29, wherein the activation condition comprises a set of conditions, wherein the activation condition is based at least in part on whether at least a subset of the set of conditions is satisfied.

Aspect 31: The method of any of aspects 18 through 30, further comprising: obtaining, from the wireless device, an indication of a reason for which the wireless device does not participate in a sensing session.

Aspect 32: The method of any of aspects 18 through 31, further comprising: obtaining, from the wireless device, capability information indicating a capability of the wireless device to utilize the activation condition, wherein the indication of the activation condition is transmitted based at least in part on the capability information.

Aspect 33: The method of any of aspects 18 through 32, wherein the indication of the activation condition is signaled via a sensing request message, via assistance data, via unicast signaling, or via broadcast signaling.

Aspect 34: The method of any of aspects 18 through 33, further comprising: obtaining, from the wireless device, an indicator of a satisfaction of the activation condition; and transmitting, to the wireless device, activation information indicative of an activation of the sensing procedure based at least in part on the satisfaction of the activation condition.

Aspect 35: A method for wireless communications by a network entity, comprising: determining whether an activation condition is satisfied for a wireless device to participate in a sensing procedure for a target object, wherein the activation condition is based at least in part on a location of a transmission node or a reception node for the sensing procedure, or is based at least in part on a signal characteristic for the sensing procedure; and transmitting, to the wireless device, an indication that the wireless device is selected to participate in the sensing procedure based at least in part on a satisfaction of the activation condition for the wireless device.

Aspect 36: The method of aspect 35, further comprising: transmitting, to the wireless device, configuration information that is indicative of a resource for communication of a signal reflected from the target object to the reception node, that is indicative of a type of one or more measurements for the sensing procedure, or a combination thereof.

Aspect 37: The method of any of aspects 35 through 36, wherein the activation condition is based at least in part on whether a relative distance between the transmission node and the reception node satisfies a threshold.

Aspect 38: The method of any of aspects 35 through 37, wherein the activation condition is based at least in part on whether a relative distance between the transmission node and the reception node satisfies a threshold, wherein the threshold is based at least in part on a first distance between the transmission node and the target object, or a second distance between the reception node and the target object.

Aspect 39: The method of any of aspects 35 through 38, wherein the activation condition is based at least in part on whether a relative distance satisfies a threshold, wherein the relative distance is between the transmission node and the target object, or is between the reception node and the target object.

Aspect 40: The method of any of aspects 35 through 39, wherein the activation condition is based at least in part on whether an angle satisfies a threshold, wherein the angle is between a first ray that is between the transmission node and the target object, and a second ray that is between the reception node and the target object.

Aspect 41: The method of any of aspects 35 through 40, wherein the activation condition is based at least in part on whether an elevation satisfies a threshold, wherein the elevation is a relative elevation between the transmission node and the reception node, or is an absolute elevation of the transmission node or of the reception node.

Aspect 42: The method of any of aspects 35 through 41, wherein the activation condition is based at least in part on whether a threshold is satisfied by a power or a strength of signaling via a background channel between the transmission node and the reception node.

Aspect 43: The method of any of aspects 35 through 42, wherein the activation condition is based at least in part on whether a projected power of a signal reflected from the target object satisfies a condition, the projected power being based at least in part on a radar cross section of the target object.

Aspect 44: The method of any of aspects 35 through 43, wherein the activation condition comprises a set of conditions, wherein the activation condition is based at least in part on whether at least a subset of the set of conditions is satisfied.

Aspect 45: The method of any of aspects 35 through 44, further comprising: obtaining, from the wireless device, an indication of a reason for which the wireless device does not participate in a sensing session.

Aspect 46: A wireless device comprising one or more transceivers, one or more memories storing processor-executable code, and one or more processors coupled with the one or more transceivers and the one or more memories, the one or more processors, individually or collectively, are configured to perform a method of any of aspects 1 through 17.

Aspect 47: A wireless device comprising at least one means for performing a method of any of aspects 1 through 17.

Aspect 48: A non-transitory computer-readable medium storing code the code comprising instructions executable by one or more processors to perform a method of any of aspects 1 through 17.

Aspect 49: A network entity comprising one or more transceivers, one or more memories storing processor-executable code, and one or more processors coupled with the one or more transceivers and the one or more memories, the one or more processors, individually or collectively, are configured to perform a method of any of aspects 18 through 34.

Aspect 50: A network entity comprising at least one means for performing a method of any of aspects 18 through 34.

Aspect 51: A non-transitory computer-readable medium storing code the code comprising instructions executable by one or more processors to perform a method of any of aspects 18 through 34.

Aspect 52: A network entity comprising one or more transceivers, one or more memories storing processor-executable code, and one or more processors coupled with the one or more transceivers and the one or more memories, the one or more processors, individually or collectively, are configured to perform a method of any of aspects 35 through 45.

Aspect 53: A network entity comprising at least one means for performing a method of any of aspects 35 through 45.

Aspect 54: A non-transitory computer-readable medium storing code the code comprising instructions executable by one or more processors to perform a method of any of aspects 35 through 45.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more transceivers;
one or more memories storing processor-executable code; and
one or more processors coupled with the one or more transceivers and the one or more memories, the one or more processors, individually or collectively, are configured to:
obtain, from a network entity, an indication of an activation condition to participate in a sensing procedure for a target object, wherein the activation condition is based at least in part on a location of a transmission node or a reception node for the sensing procedure, or is based at least in part on a signal characteristic for the sensing procedure;
receive, based at least in part on a satisfaction of the activation condition, a signal reflected from the target object; and
transmit, to the network entity, measurement information indicative of one or more measurements of the signal reflected from the target object.

2. The wireless device of claim 1, wherein the one or more processors are individually or collectively further configured to:
obtain, from the network entity, configuration information that is indicative of a resource for communication of the signal, that is indicative of a type of the one or more measurements, or a combination thereof.

3. The wireless device of claim 2, wherein the configuration information is obtained previous to the satisfaction of the activation condition, or is obtained in response to a transmission indicative of the satisfaction of the activation condition to the network entity.

4. The wireless device of claim 1, wherein the activation condition is based at least in part on whether a relative distance between the transmission node and the reception node satisfies a threshold.

5. The wireless device of claim 1, wherein the sensing procedure comprises bistatic sensing, the bistatic sensing limited to a tracking operation for the target object.

6. The wireless device of claim 1, wherein the activation condition is based at least in part on whether a relative distance between the transmission node and the reception node satisfies a threshold, wherein the threshold is based at least in part on a first distance between the transmission node and the target object, or a second distance between the reception node and the target object.

7. The wireless device of claim 1, wherein the activation condition is based at least in part on whether a relative distance satisfies a threshold, wherein the relative distance is between the transmission node and the target object, or is between the reception node and the target object.

8. The wireless device of claim 1, wherein the one or more processors are individually or collectively further configured to:
transmit, to the network entity, an indicator of the satisfaction of the activation condition; and
obtain, from the network entity, activation information indicative of an activation of the sensing procedure based at least in part on the satisfaction of the activation condition.

9. A network entity, comprising:
one or more transceivers;
one or more memories storing processor-executable code; and
one or more processors coupled with the one or more transceivers and the one or more memories, the one or more processors, individually or collectively, are configured to:
transmit, to a wireless device, an indication of an activation condition to participate in a sensing procedure for a target object, wherein the activation condition is based at least in part on a location of a transmission node or a reception node for the sensing procedure, or is based at least in part on a signal characteristic for the sensing procedure; and
obtain, from the wireless device, measurement information indicative of one or more measurements of a signal reflected from the target object.

10. The network entity of claim 9, wherein the activation condition is based at least in part on whether an angle satisfies a threshold, wherein the angle is between a first ray that is between the transmission node and the target object, and a second ray that is between the reception node and the target object.

11. The network entity of claim 9, wherein the activation condition is based at least in part on whether an elevation satisfies a threshold, wherein the elevation is a relative elevation between the transmission node and the reception node, or is an absolute elevation of the transmission node or of the reception node.

12. The network entity of claim 9, wherein the activation condition is based at least in part on whether a threshold is satisfied by a power or a strength of signaling via a background channel between the transmission node and the reception node.

13. The network entity of claim 9, wherein the activation condition is based at least in part on whether a projected power of the signal reflected from the target object satisfies a condition, the projected power being based at least in part on a radar cross section of the target object.

14. The network entity of claim 9, wherein the activation condition comprises a set of conditions, wherein the activation condition is based at least in part on whether at least a subset of the set of conditions is satisfied.

15. The network entity of claim 9, wherein the one or more processors are individually or collectively further configured to:
obtain, from the wireless device, an indication of a reason for which the wireless device does not participate in a sensing session.

16. The network entity of claim 9, wherein the one or more processors are individually or collectively further configured to:
obtain, from the wireless device, capability information indicating a capability of the wireless device to utilize the activation condition, wherein the indication of the activation condition is transmitted based at least in part on the capability information.

17. A network entity, comprising:
one or more transceivers;
one or more memories storing processor-executable code; and
one or more processors coupled with the one or more transceivers and the one or more memories, the one or more processors, individually or collectively, are configured to:
determine whether an activation condition is satisfied for a wireless device to participate in a sensing procedure for a target object, wherein the activation condition is based at least in part on a location of a transmission node or a reception node for the sensing procedure, or is based at least in part on a signal characteristic for the sensing procedure; and
transmit, to the wireless device, an indication that the wireless device is selected to participate in the sensing procedure based at least in part on a satisfaction of the activation condition for the wireless device.

18. The network entity of claim 17, wherein the one or more processors are individually or collectively further configured to:
transmit, to the wireless device, configuration information that is indicative of a resource for communication of a signal reflected from the target object to the reception node, that is indicative of a type of one or more measurements for the sensing procedure, or a combination thereof.

19. The network entity of claim 17, wherein the activation condition is based at least in part on whether a relative distance between the transmission node and the reception node satisfies a threshold.

20. The network entity of claim 17, wherein the activation condition is based at least in part on whether a relative distance between the transmission node and the reception node satisfies a threshold, wherein the threshold is based at least in part on a first distance between the transmission node and the target object, or a second distance between the reception node and the target object.

21. The network entity of claim 17, wherein the activation condition is based at least in part on whether a relative distance satisfies a threshold, wherein the relative distance is between the transmission node and the target object, or is between the reception node and the target object.

22. The network entity of claim 17, wherein the activation condition is based at least in part on whether an angle satisfies a threshold, wherein the angle is between a first ray that is between the transmission node and the target object, and a second ray that is between the reception node and the target object.

23. The network entity of claim 17, wherein the activation condition is based at least in part on whether an elevation satisfies a threshold, wherein the elevation is a relative elevation between the transmission node and the reception node, or is an absolute elevation of the transmission node or of the reception node.

24. The network entity of claim 17, wherein the activation condition is based at least in part on whether a threshold is satisfied by a power or a strength of signaling via a background channel between the transmission node and the reception node.

25. A method for wireless communications by a wireless device, comprising:
obtaining, from a network entity, an indication of an activation condition to participate in a sensing procedure for a target object, wherein the activation condition is based at least in part on a location of a transmission node or a reception node for the sensing procedure, or is based at least in part on a signal characteristic for the sensing procedure;
receiving, based at least in part on a satisfaction of the activation condition, a signal reflected from the target object; and
transmitting, to the network entity, measurement information indicative of one or more measurements of the signal reflected from the target object.

26. The method of claim 25, further comprising:
obtaining, from the network entity, configuration information that is indicative of a resource for communication of the signal, that is indicative of a type of the one or more measurements, or a combination thereof.

27. The method of claim 26, wherein the configuration information is obtained previous to the satisfaction of the activation condition, or is obtained in response to a transmission indicative of the satisfaction of the activation condition to the network entity.

28. The method of claim 25, wherein the activation condition is based at least in part on whether a relative distance between the transmission node and the reception node satisfies a threshold.

29. The method of claim 25, wherein the sensing procedure comprises bistatic sensing, the bistatic sensing limited to a tracking operation for the target object.

30. The method of claim 25, wherein the activation condition is based at least in part on whether a relative distance between the transmission node and the reception node satisfies a threshold, wherein the threshold is based at least in part on a first distance between the transmission node and the target object, or a second distance between the reception node and the target object.
